(19) United States
(12) Patent Application Publication
(10) Pub. No.: US 2026/0230991 A1
(43) Pub. Date: Aug. 6, 2026

(54) CHO CHAIN METHODS IN NTN

(71) Applicant: TELEFONAKTIEBOLAGET LM ERICSSON (PUBL), Stockholm (SE)

(72) Inventors: Johan Rune, LIDINGÖ (SE); Emre Yavuz, STOCKHOLM (SE); Ignacio Javier Pascual Pelayo, Stockholm (SE); Claes-Göran Persson, MJÖLBY (SE)

(21) Appl. No.: 19/155,132

(22) PCT Filed: Feb. 22, 2024
(86) PCT No.: PCT/IB2024/051731

§ 371 Date: Aug. 8, 2025

Related U.S. Application Data
(60) Provisional application No. 63/486,368, filed on Feb. 22, 2023.

(51) Int. Cl. H04W 36/36; H04W 36/00; H04W 84/06

(52) U.S. Cl. CPC H04W 36/362; H04W 36/0016; H04W 36/0058; H04W 84/06

(57) ABSTRACT

Systems and methods are disclosed that related to Conditional Handover (CHO) in a manner that is particularly well-suited for a Non-Terrestrial Network (NTN). In one embodiment, a method performed by a User Equipment (UE) for conditional handover comprises receiving, from a network node, information that configures the UE with a set of conditional handover configurations. The set of conditional handover configurations comprises two or more conditional handover configurations, wherein information from at least one conditional handover configuration from the set of conditional handover configurations is reused for at least one other conditional handover configuration from the set of conditional handover configurations. The method further comprises operating in accordance with the set of conditional handover configurations. In this manner, an efficient and compact (in terms of data and message size) means for configuring multiple (e.g., sequential) time-based CHOs in a UE is provided.

### RELATED APPLICATIONS

This application claims the benefit of provisional patent application Ser. No. 63/486,368, filed Feb. 22, 2023, the disclosure of which is hereby incorporated herein by reference in its entirety.

### TECHNICAL FIELD

The present disclosure relates to a Non-Terrestrial Network (NTN) and, more specifically, to Conditional Handover (CHO) in an NTN.

### BACKGROUND

### 1 General Background on 3GPP Technology

In 3^{rd} Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and Mobile Broadband (MBB) services but has continuously evolved to broaden its functionality. Since 3GPP release 13, Narrowband Internet of Things (NB-IoT) and LTE for Machine Type Communication (MTC) (i.e., LTE-M) are part of the LTE specifications and provide connectivity to massive Machine Type Communications (mMTC) services.

In 3GPP Release 15, the first release of the 5^{th} Generation (5G) System (5GS) was specified. This is a new generation radio access technology intended to serve use cases such as enhanced Mobile Broadband (eMBB), Ultra-Reliable and Low Latency Communication (URLLC) and mMTC services. 5G includes the New Radio (NR) access stratum interface and the 5G Core Network (5GC). The NR physical and higher layers are reusing parts of the LTE specification, and additional components are introduced when motivated by the new use cases. One such component is the introduction of a sophisticated framework for beam forming and beam management to extend the support of the 3GPP technologies to a frequency range going beyond 6 Gigahertz (GHz).

In release 15, 3GPP also started the work to prepare NR for operation in a Non-Terrestrial Network (NTN). The work was performed within the Study Item “NR to support Non-Terrestrial Networks” and resulted in 3GPP Technical Report (TR) 38.811. In 3GPP release 16, the work to prepare NR for operation in a Non-Terrestrial Network continued with the Study Item “Solutions for NR to support Non-Terrestrial Network” which resulted in 3GPP TR 38.821.

The Release 16 study item resulted in a Work Item being agreed for NR in Release 17, “Solutions for NR to support non-terrestrial networks (NTN)”, which is described in the Work Item Description RP-193234.

### 2 Satellite Communications

There is an ongoing resurgence of satellite communications. Several plans for satellite networks have been announced in the past few years. The target services vary from backhaul and fixed wireless, to transportation, to outdoor mobile, to Internet of Things (IoT). Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work. In 3GPP release 15, 3GPP started the work to prepare NR for operation in a Non-Terrestrial Network (NTN). Note that, in this document, unless explicitly stated otherwise, the term Non-Terrestrial Network—NTN—refers to a NR NTN, i.e. an NTN that operates according to 3GPP NR technology adapted to satellite communication. The work was performed within the study item “NR to support Non-Terrestrial Networks” and resulted in 3GPP TR 38.811. In 3GPP release 16, the work to prepare NR for operation in an NTN network continued with the study item “Solutions for NR to support Non-Terrestrial Network”, which has been captured in 3GPP TR 38.821. In parallel the interest to adapt NB-IoT and LTE-M for operation in NTN is growing. As a consequence, 3GPP release 17 contains both a work item on NR NTN (see RP-193234) and a study item and work item on NB-IoT and LTE-M support for NTN (see RP-193235 and RP-211601).

### 2.1 Characteristics

A satellite radio access network usually includes the following components:
a satellite that refers to a space-borne platform,
an Earth-based gateway that connects the satellite to a base station or a core network, depending on the choice of architecture,
a feeder link that refers to the link between a gateway and a satellite, and
an access link, or service link, that refers to the link between a satellite and a User Equipment (UE).

Depending on the orbit altitude, a satellite may be categorized as Low Earth Orbit (LEO), Medium Earth Orbit (MEO), or Geostationary Earth Orbit (GEO) satellite.
LEO: typical heights ranging from 250-1,500 kilometers (km), with orbital periods ranging from 90-120 minutes.
MEO: typical heights ranging from 1,500-35,786 km, with orbital periods, P_{MEO}, in the range 2 hours<P_{MEO}<24 hours. MEO and LEO are also known as Non-Geo Synchronous Orbit (NGSO) type of satellite.
GEO: height at about 35,786 km, with an orbital period of 24 hours. Also known as a Geo Synchronous Orbit (GSO) type of satellite.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the NR base station (gNB) is located on the ground and the satellite forwards signals/data between the gNB and the UE
Regenerative payload. The satellite includes on-board processing to demodulate and decode the received signal and regenerate the signal before sending it back to the Earth. When applied to general 3GPP architecture and terminology, the regenerative payload architecture means that the gNB is located in the satellite.
   In the work item for NR NTN in 3GPP release 17, only the transparent payload architecture is considered.

FIG. 1 shows an example architecture of a satellite network with bent pipe transponders (i.e., the transparent payload architecture). The gNB may be integrated in the gateway or connected to the gateway via a terrestrial connection (wire, optic fiber, wireless link).

The significant orbit height means that satellite systems are characterized by a path loss that is significantly higher than what is expected in terrestrial networks. To overcome the pathloss it is often required that the access and feeder links are operated in line-of-sight conditions, and that the UE is equipped with an antenna offering high beam directivity.

A communication satellite typically generates several beams over a given area. The footprint of a beam is usually in an elliptic shape, which has been traditionally considered as a cell (but a cell consisting of multiple beams is not precluded). The footprint of a beam is also often referred to as a spotbeam. The spotbeam may move over the Earth surface with the satellite movement (and the Earth's rotation) or may be Earth fixed with some beam pointing mechanism used by the satellite to compensate for its motion. The size of a spotbeam depends on the system design and may range from tens of kilometers to a few thousands of kilometers.

The NTN beam may, in comparison to the beams observed in a terrestrial network, provide a very wide footprint and may cover an area outside of the area defined by the served cell. Beam covering adjacent cells will overlap and cause significant levels of intercell interference, resulting from the slow decrease of the signal strength in the outwards radial direction. This is due in part to the high elevation angle and long distance to the network-side (satellite-borne) transceiver, which, compared with terrestrial cells, results in a comparatively small relative difference between the distance from the cell center to the satellite and the distance from a point at the cell edge to the satellite. To overcome the large levels of interference, a typical approach in NTN is to configure different cells with different carrier frequencies and polarization modes.

Three types of beams or cells are supported in NTN:
Earth-fixed beams/cells: provisioned by beam(s) continuously covering the same geographical areas all the time (e.g., in the case of GEO satellites);
Quasi-Earth-fixed beams/cells: provisioned by beam(s) covering one geographic area for a limited period and a different geographic area during another period (e.g., in the case of NGSO satellites generating steerable beams); and
Earth-moving beams/cells: provisioned by beam(s) whose coverage area slides over the Earth's surface (e.g., in the case of NGSO satellites generating fixed or non-steerable beams).

Throughout the present disclosure, the terms “beam” and “cell” are hereinafter used interchangeably, unless explicitly noted otherwise.

Of the three above cell types, quasi-Earth-fixed cells and moving cells seem to be the ones most promising for actual deployment. In the case of moving cells, each cell (the footprint of its beam(s)) moves across the surface of the Earth as its serving satellite moves along its orbit. In the case of quasi-Earth-fixed cells, the cell area (as the name implies) remains fixed to the same geographical area, regardless of satellite movements. To enable this, a serving satellite has to have means for dynamically directing its beam(s), so that the same area of the Earth is covered despite the satellite's movement. However, since the satellites orbit around the Earth, the same satellite will only be able to cover the same area on the Earth for a limited time, unless the satellite is in a geostationary orbit (and note that LEO satellites have the most traction in the satellite communication industry). This means that different satellites will have the task of covering a certain geographical cell area at different time periods. When this task is switched from one satellite to another, this in principle means that one cell is replaced by another, although covering the same area. A similar cell replacement occurs when a satellite covering a certain geographical area switches its feeder link (because it has moved away from its old gateway (GW)/gNB and become closer to another GW/gNB). As a consequence, all UEs connected in the old cell (i.e., UEs in Radio Resource Control (RRC) connected state, i.e., RRC_CONNECTED state) have to be handed over (or otherwise moved, e.g. using RRC connection reestablishment) from the old to the new cell, and all UEs camping on the old cell (i.e., UEs in RRC idle state (RRC_IDLE) or RRC inactive state (RRC_INACTIVE)) have to perform cell reselection to the new cell.

In terms of such cell switches there are two alternative principles: (1) hard switch and (2) soft switch. With hard switch, there is an instantaneous switch from the old to the new cell, i.e., the new cell appears at the same time as the old cell disappears. This makes completely seamless (i.e., interruption free) handover in practice impossible and creates a situation which may lead to overload of the access resources in the new cell, due to potential access attempt peaks when many UEs try to access the new cell right after the cell switch. With soft switch there is a time period during which the new and the old cell coexist (i.e., overlap), covering the same geographical area. This coexistence/overlap period allows some time for connected UEs to be handed over and for camping UEs to reselect to the new cell, which facilitates distribution of the access load in the new cell and thereby also provides better conditions for handovers with shorter interruption time. Soft switch is likely to be the most prevalent cell switch principle in quasi-Earth-fixed cell deployments.

The time when a quasi-Earth-fixed cell will stop serving the current area, i.e. the time the quasi-Earth-fixed cell will cease to exist, is indicated by the t-Service-r17 IE which is broadcast in SIB19 in NR NTN (and in SIB31 in IoT NTN).

### 2.2 Ephemeris Data

Ephemeris data (sometimes referred to as just “ephemeris”) is data that allows a UE (or other entity) to determine a satellite's position and velocity, i.e., the ephemeris data contains parameters related to the satellite's orbit. There are several different formats defined for ephemeris data.

In 3GPP TR 38.821, it has been captured that ephemeris data should be provided to the UE, for example to assist with pointing a directional antenna (or an antenna beam) towards the satellite, and to calculate a correct Timing Advance (TA) (see more about this in section 3.5 of the Background below) and Doppler shift. In NR NTN and IoT NTN, ephemeris data will be broadcast in the system information (SI) in each cell, included in an NTN specific SIB, (labeled SIB19 in NR NTN and SIB31 IoT NTN).

A satellite orbit can be fully described using six parameters. Exactly which set of parameters is chosen can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis @ determine its position in space, and the epoch time t determines a reference time (e.g., the time when the satellites moves through periapsis). This set of parameters is illustrated in FIG. 2. In other words, FIG. 2 is an illustration of parameters included in one ephemeris data format.

As an example of a different parametrization, the Two-Line Elements (TLEs) use mean motion n and mean anomaly M instead of a and t. A completely different set of parameters is the position and velocity vector (x, y, z, vₓ, v_{y}, v_{z}) of a satellite. These are sometimes called orbital state vectors. They can be derived from the orbital elements and vice versa, since the information they contain is equivalent. All these formats (and many others) are possible choices for the format of ephemeris data to be used in NTN.

An aspect discussed during the 3GPP study item and captured in 3GPP TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently. For example, the update frequency depends on the satellite and its orbit and ranges from weekly to multiple times a day for satellites on very low orbits which are exposed to strong atmospheric drag and need to perform correctional maneuvers often. Even more frequent updates will be used in NR NTN (and IoT NTN) to allow the UE to determine/predict the satellite's position (and velocity) accurately enough to satisfy the requirements in NTN, e.g., to enable a UE to calculate an accurate enough UE-specific TA (see section 3.5 of the Background below).

### 2.3 GNSS

A Global Navigation Satellite System (GNSS) comprises a set of satellites orbiting the Earth in orbits crossing each other, such that the orbits are distributed around the globe. The satellites transmit signals and data that allows a receiving device on Earth to accurately determine time and frequency references and, maybe most importantly, accurately determine its position, provided that signals are received from a sufficient number of satellites (e.g., four). The position accuracy may typically be in the range of a few meters, but using averaging over multiple measurements, a stationary device may achieve much better accuracy.

A well-known example of a GNSS is the American Global Positioning System (GPS). Other examples are the Russian Global Navigation Satellite System (GLONASS), the Chinese BeiDou Navigation Satellite System, and the European Galileo.

The transmissions from GNSS satellites include signals that a receiving device uses to determine the distance to the satellite. By receiving such signals from multiple satellites, the device can determine its position. However, this requires that the device also knows the positions of the satellites. To enable this, the GNSS satellites also transmit data about their own orbits (from which position at a certain time can be derived). In GPS, such information is referred to as ephemeris data and almanac data (or sometimes lumped together under the term navigation information).

The time required to perform a GNSS measurement, e.g. GPS measurement, may vary widely, depending on the circumstances, mainly depending on the status of the ephemeris and almanac data the measuring devices has previously acquired (if any). In the worst case, a GPS measurement can take several minutes. GPS is using a bit rate of 50 bps for transmitting its navigation information. The transmission of the GPS date, time and ephemeris information takes 90 seconds. Acquiring the GPS almanac containing orbital information for all satellites in the GPS constellation takes more than 10 minutes. If a UE already possesses this information the synchronization to the GPS signal for acquiring the UE position and Coordinated Universal Time (UTC) is a significantly faster procedure.

2.4 3GPP dependence of GNSS for NR NTN and IoT NTN

To handle the timing and frequency synchronization in an NR or LTE based NTN a promising technique is to equip each device with a GNSS receiver. The GNSS receiver allows a device to estimate its geographical position. In one example, an NTN gNB carried by a satellite, or communicating via a satellite, broadcasts its ephemeris data (i.e., data that informs the UE about the satellite's position, velocity, and orbit) to a GNSS equipped UE. The UE can then determine the propagation delay, the delay variation rate, the Doppler shift, and its variation rate based on its own location (obtained through GNSS measurements) and the satellite location and movement (derived from the ephemeris data).

The GNSS receiver also allows a device to determine a time reference (e.g., in terms of UTC) and frequency reference. This can also be used to handle the timing and frequency synchronization in an NR or LTE based NTN. In a second example an NTN gNB carried by a satellite, or communicating via a satellite, broadcasts its timing (e.g., in terms of a UTC timestamp) to a GNSS equipped UE. The UE can then determine the propagation delay, the delay variation rate, the Doppler shift, and its variation rate based on its time/frequency reference (obtained through GNSS measurements) and the satellite timing and transmit frequency.

The UE may use this knowledge to compensate its uplink (UL) transmissions for the propagation delay and Doppler effect.

The 3GPP release 17 SID on NB-IoT and LTE-M for NTN (RP-193235) supports this observation:
“GNSS capability in the UE is taken as a working assumption in this study for both NB-IoT and eMTC devices. With this assumption, UE can estimate and pre-compensate timing and frequency offset with sufficient accuracy for UL transmission. Simultaneous GNSS and NTN NB-IoT/eMTC operation is not assumed.”

Furthermore, in the NR NTN work item and IoT NTN work item for 3GPP release 17, GNSS capability is assumed, i.e., it is assumed that an NR NTN capable or IoT NTN capable UE also is GNSS capable and GNSS measurements at the UEs are essential for the operation of the NTN, e.g., the UEs are expected to compensate their UL transmissions for the propagation delay and Doppler effect. In particular, the UE uses knowledge of its location and broadcast information about the satellite's position (i.e., ephemeris data) to calculate the UE-satellite Round Trip Time (RTT), which is then used in UE autonomous calculation of a Timing Advance (TA), as described in section 3.5 of the Background below. However, an IoT NTN UE is not expected to be able to perform a GNSS measurement while receiving transmissions from network at the same time.

When using GNSS measurements for purposes related to the operation and performance of an NR NTN or IoT NTN, the GNSS measurement must be fresh enough to be reliable. For this reason, the notion of a GNSS validity timer has been introduced, which governs the maximum age UE location information may have when used in such operations (e.g., for calculation of a timing advance). A suitable value for this maximum age may depend on the UE's implementation, and therefore the GNSS validity timer is a UE implementation specific mechanism. However, the standard specifications include means by which the UE can inform the network (i.e., the serving gNB in NR NTN and the serving eNB in IoT NTN) of the remaining time of the UE's currently running GNSS validity timer.

### 2.5 Consequences of Long Propagation Delay/RTT on the Timing Advance (TA)

Propagation delay is an important aspect of satellite communications and its expected impact in NTN is different from the impacts of propagation delay in a terrestrial mobile system. For a bent pipe satellite network, the UE-gNB round-trip delay may, depending on the orbit height, range from a few or tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle & seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | | One-way | Propagation |
|---|---|---|---|---|
| Orbital | Elevation | Distance | propagation | delay |
| height | angle | UE <-> satellite | delay | difference |
| 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

The long propagation delays in NTN have many consequences, one of which being that large Timing Advance (TA) values have to be used (where a TA is the time a UE has to advance its UL transmission in relation to the corresponding frame, slot and symbol in the downlink (DL) to achieve alignment between the UL and the DL frame/slot/symbol structure at an UL/DL alignment reference point, which typically is the gNB). In addition, due to the fast movement of the satellite (excluding GEO satellites), the TA will continuously change and will do so quite rapidly. 3GPP has dealt with these circumstances through a combination of new parameters and introduction of the principle of UE autonomous adaptation of the TA.

Typically, the network wants the UL and DL to be aligned at the gNB receiver, which means that the TA should be equal to the UE-gNB RTT. The UE-gNB RTT can be divided into two parts: the UE-satellite RTT (i.e., the service link RTT) and the gNB-satellite RTT (which is equal to the feeder link RTT assuming that the GW and the gNB are collocated). The satellite-gNB RTT is equal for all locations in the cell and thus the same for all UEs in the cell, whereas the UE-satellite RTT depends on the UE's location and thus is UE specific.

To take care of the part of the TA that is common for all UEs in the cell, the satellite broadcasts (in the system information, in a new System Information Block (SIB) with NTN specific data (SIB19 in NR NTN and SIB31 in IoT NTN)) so-called Common TA information, consisting of a Common TA value, the first time derivative of the Common TA value (denoted as “drift”) and the second time derivative of the Common TA value (denoted as “drift variation”). The UE specific part of the TA, i.e., the UE-satellite RTT is left to the UE to autonomously calculate. To do this, the UE has to obtain its own location and the satellite position. The UE can obtain its own location e.g., using GNSS measurements, and the satellite's position (as well as its velocity) can be derived from the ephemeris data broadcast by the gNB (in the same SIB as the Common TA parameters). The ephemeris data and the Common TA parameters are nominally valid at a so-called epoch time, which is also indicated in the same SIB. Based on the ephemeris data, the UE can predict the satellite's position a certain time into the future, and the first and second time derivatives (i.e., the drift and drift variation parameters) of the Common TA allows the UE to calculate how the Common TA value changes with time. Furthermore, the broadcast ephemeris data and Common TA parameters have a limited validity time, which is also indicated in the same SIB. The ephemeris data and Common TA parameters the UE uses when calculating the UE specific TA have to be valid, i.e. their validity time (captured in the ntn-UlSyncValidityDuration-r17IE) must not have expired. The same goes for the UE location information, typically based on a GNSS measurement, the UE uses in the TA calculation (in particular to calculate the UE-satellite RTT).

3GPP has also introduced support for the possibility to place the UL/DL alignment reference point at some other place than in the gNB. This support comes in the form of a parameter denoted as Kmac. The Kmac parameter takes care of the RTT between the gNB and the chosen UL/DL alignment reference point. Hence, Kmac=0 means that the UL/DL alignment reference point is located in the gNB, while other Kmac values will place the UL/DL alignment reference point somewhere between the gNB and the satellite. Kmac is included in the same SIB as the other above mentioned NTN specific configuration parameters. Broadcast of Kmac is optional and absence of a Kmac parameter in the concerned SIB implicitly means that Kmac=0 should be used.

When calculating the UE specific TA, the UE only uses the Common TA parameters, the ephemeris data and its own location, i.e. Kmac is not needed for this calculation. However, the UE needs to know Kmac for other purposes, so that it can adapt certain timers to the UE-gNB RTT.

For Non-Terrestrial Networks using 3GPP technology, in particular 5G/NR, the long propagation delay means that the TA the UE uses for its uplink transmissions is essential and has to be much greater than in terrestrial networks in order for the uplink and downlink to be time-aligned at the gNB (or at another point if Kmac>0), as is the case in NR and LTE. One of the purposes of the random access (RA) procedure is to provide the UE with a valid TA. However, even the random access preamble (i.e. the initial message from the UE in the random access procedure) has to be transmitted with a timing advance to allow a reasonable size of the RA preamble reception window in the gNB (and to ensure that the cyclic shift of the preamble's Zadoff-Chu sequence cannot be so large that it makes the Zadoff-Chu sequence, and thus the preamble, appear as another Zadoff Chu sequence, and thus another preamble, based on the same Zadoff-Chu root sequence), but this TA does not have to be as accurate as the TA the UE subsequently uses for other uplink transmissions, where the TA has to be accurate enough to keep the timing error smaller than the cyclic prefix (CP).

In conjunction with the random access procedure, the gNB provides the UE with an accurate (i.e., fine-adjusted) TA in the Random Access Response (RAR) message (in 4-step RA) or MsgB (in 2-step RA), based on the time of reception of the random access preamble. In terrestrial NR, the gNB can subsequently adjust the UE's TA using a Timing Advance Command MAC CE (or an Absolute Timing Advance Command MAC CE), based on the timing of receptions of uplink transmissions from the UE. A goal with such network control of the UE's timing advance is typically to keep the time error of the UE's uplink transmissions at the gNB's receiver within the cyclic prefix (which is required for correct decoding of the uplink transmissions, e.g., on the Physical Uplink Shared Channel (PUSCH) and the Physical Uplink Control Channel (PUCCH)). The timing advance control framework for terrestrial NR and LTE also includes a time alignment timer that the gNB configures the UE with. The time alignment timer is restarted every time the gNB adjusts the UE's TA and if the time alignment timer expires, the UE is not allowed to transmit in the uplink without a prior random access procedure (which serves the purpose to provide the UE with a valid timing advance). These rules associated with the time alignment timer will assumedly be the same in NTN, but the relation and/or interaction between the time alignment timer and certain NTN specific functionality, e.g. related to GNSS measurements, may impact the role of the time alignment timer in NTN. For NTN, 3GPP has also agreed that in addition to the gNB's control of the UE's TA, the UE is allowed to autonomously update its TA based on estimation of changes in the UE-gNB RTT (using the UE's location and broadcast parameters related to the satellite orbit and the feeder link RTT, as previously described).

The long propagation delays and the resulting large TA a UE has to use also impacts the scheduling of uplink transmissions. Specifically, the network has to take the large TA into account when it determines the delay to be used between an UL grant (i.e., a Downlink Control Information (DCI) on the Physical Downlink Control Channel (PDCCH) allocating uplink transmission resources for the UE to transmit on) and the uplink transmission resources the UL grant allocates. For this purpose, a new parameter denoted as “K_{offset}” (or “Koffset” or “K_offset”) is introduced, which is added to the legacy delay, e.g. added to the legacy delay parameter K₂ (or K2) contained in the UL grant in NR NTN. The K_{offset} parameter comes in two forms: the cell-specific K_{offset}, which is broadcast in the system information and which is common for all UEs in the cell, and the UE-specific K_{offset}, which the network optionally configures for each UE. Note that configuration of a UE-specific K_{offset} value is optional, and when it is absent, the cell-specific K_{offset} value applies. To facilitate for the network to determine a suitable UE-specific K_{offset} value for a certain UE, a mechanism for TA reporting is introduced in NTN, whereby the UE can report its current TA to the network (where the granularity of the reported TA value is one slot).

### 2.6 NTN-Specific Information in the System Information

Due to the special operating conditions in a Non-Terrestrial Network, the system information broadcast in an NTN cell has to include NTN-specific information. To serve this purpose, a new SIB (SIB19) is introduced in NR NTN which contains NTN-specific information. In IoT NTN, the new SIB31 more or less corresponds to SIB19 in NR NTN.

In 3GPP Technical Specification (TS) 38.331 version 17.2.0, SIB19 is defined as shown in FIGS. 18A and 18B in ASN.1 code. Furthermore, the NTN-Config-r17 IE is defined as shown in FIGS. 19A and 19B in ASN.1 code in the same specification.

### 2.7 IoT NTN

The Non-Terrestrial Network described above is based on 5G/NR technology adapted for communication via satellites. But an NTN standard for IoT, denoted as “IoT NTN”, is also being specified in release 17 of the 3GPP standards. IoT NTN is based on the LTE NB-IoT technology adapted for communication via satellites. To distinguish NTN based 5G/NR technology from IoT NTN, NTN based on 5G/NR technology is often referred to as “NR NTN”. In light of these distinctions, depending on the context, the term “NTN” is sometimes used to refer to either or both of NR NTN and IoT NTN, and sometimes the term “NTN” is used to refer only to NR NTN.

### 3 Mobility in RRC_CONNECTED State

### 3.1 “Regular” Handover/reconfiguration WithSync

In connected state (i.e., RRC_CONNECTED state), in the 3GPP specifications known as the RRC_CONNECTED state, the UE has an active connection to the network for sending and receiving of data and signaling. In connected state, mobility is controlled by the network to ensure connectivity is retained to the UE with no interruption or noticeable degradation of the provided service as the UE moves between the cells within the network.

Connected state mobility is also known as handover. During the handover the UE is moved from a source node using a source cell connection, to a target node using a target cell connection where the target cell connection is associated with a target cell controlled by the target node. In other words, during a handover, the UE moves from the source cell to a target cell. The source node and the target node may also be referred to as the source access node and the target access node or the source radio network node and the target radio network node. In the 5G system the source node and the target node are referred to as the source gNB and the target gNB.

As requested by the network, a UE in RRC_CONNECTED state is required to search and perform measurements on neighbor cells both on the current carrier frequency (intra-frequency) as well as on other carrier frequencies (inter-frequency). The UE does not take any autonomous decisions when to trigger a handover to a neighbor cell (except to some extent when the UE is configured for conditional handover, see section 4.2 of the Background below). Instead, the UE sends the measurement results from the measurements it performed on serving and neighboring cells to the network where a decision is taken whether or not to perform a handover to one of the neighbor cells. Hence, upon receiving a measurement report from the UE indicating that it may be preferable to move the UE's RRC connection to a neighbor cell (e.g. because the measurement report indicates that the radio link in the service cell is deteriorating and/or that the radio channel quality in the neighbor cell has become (significantly) better than the radio channel quality in the serving cell), the network may send a message to the UE to instruct the UE to execute a handover. This message is an RRCReconfiguration message with a reconfiguration WithSync IE. The message is often informally referred to as a “handover command” (although a HandoverCommand is really an inter-gNB RRC message which is transferred in the “Target NG-RAN node To Source NG-RAN node Transparent Container” IE in the Handover Request Acknowledge XnAP message during preparation of an Xn handover and in the “Target to Source Transparent Container” IE in the Handover Request Acknowledge NGAP message and the Handover Command NGAP message during preparation of an NG handover).

In some cases, the source node and the target node are different nodes, such as different gNBs. Such a case is referred to as an inter-node or inter-gNB handover. In other cases, the source node and the target node are one and the same node, such as the same gNB. Such a case is referred to as an intra-node or intra-gNB handover and covers the case when the source and target cells are controlled by the same node. In yet another case, handover is performed within the same cell and thus also within the same node controlling that cell. These cases are referred to as intra-cell handover and may be performed to refresh security parameters.

It should also be understood that the source node (or source access node) and the target node (target access node) refer to a role served by a given access node during a handover of a specific UE. For example, a given gNB may serve as source gNB during handover of one UE, while it also serves as the target gNB during handover of a different UE. And, in case of an intra-node or intra-cell handover of a given UE, the same gNB serves both as the source gNB and target gNB for that UE.

An inter-node handover in NR can further be classified as an Xn-based or NG-based handover depending on whether the source and target node communicate directly using the Xn interface or indirectly via the Core Network (through one or two Access and Mobility Management Functions (AMFs)) using NG interfaces.

During an inter-node handover, after the handover decision has been made in the source gNB, the actual handover execution is preceded by a handover preparation phase consisting of communication between the source gNB and the target gNB. During this preparation phase, the source gNB provides the target gNB with state information related to the UE (referred to as the UE context), e.g. information about the UE's Protocol Data Unit (PDU) session resources (e.g. Quality of Service (QoS) flow(s)) and various other configuration information, and the target gNB performs admission control (and assumedly accepts the handover) and returns indications of the admitted PDU session resources (e.g. QoS flow(s)) and the configuration the UE should apply when accessing the target cell. The UE configuration the target gNB provides is included in an inter-gNB RRC message called “HandoverCommand” and is formatted as an RRCReconfiguration message (including a reconfiguration WithSync IE). This RRCReconfiguration message (i.e., the handover command) is then forwarded by the source gNB to the UE and this triggers the UE to execute the handover (by releasing it connection in the source cell, synchronizing with the target cell, and initiating a random access procedure in the target cell to establish a connection). In the third message of the random access procedure in the target cell the UE sends an RRCReconfigurationComplete message (often referred to as a Handover Complete message) to acknowledge the RRCReconfiguration message that triggered the handover execution and to confirm the successful execution of the handover.

FIG. 3 shows a simplified signaling flow between the UE, the source gNB, and the target gNB during an Xn-based inter-gNB handover in NR. A slightly more detailed signaling flow for the same Xn-based inter-gNB handover is illustrated in FIGS. 4A and 4B.

Note that control plane data (i.e., RRC messages such as the measurement report, handover command and handover complete messages) are transmitted on Signaling Radio Bearers (SRBs), while the user plane data is transmitted on Data Radio Bearers (DRBs).

The steps of the procedure of FIG. 3 are as follows:
301-302. The UE has an active connection to the source gNB where user data is sent and received to/from the network. Due to some trigger in the source gNB, e.g. a measurement report received from the UE, the source gNB decides to handover the UE to a target (neighbor) cell controlled by the target gNB.
303. The source gNB sends the XnAP HANDOVER REQUEST message to the target gNB passing a transparent RRC container with necessary information to prepare the handover at the target side. The information includes for example the target cell id, the target security key, the current source configuration and UE capabilities.
304. The target gNB prepares the handover and responds with the XnAP HANDOVER REQUEST ACKNOWLEDGE message to the source gNB, which includes the handover command (an RRCReconfiguration message containing the reconfiguration WithSync field) to be sent to the UE. The handover command includes configuration information that the UE should apply once it connects to the target cell, e.g., random access configuration, a new Cell Radio Network Temporary Identifier (C-RNTI0 assigned by the target node, security parameters, etc.
305. The source gNB triggers the handover by sending the handover command (received from the target gNB in the previous step) to the UE.
306. Upon reception of the handover command the UE releases the connection to the old (source) cell, starts the handover supervision timer T304, and starts to synchronize to the new (target) cell.
307-309. The source gNB stops scheduling any further DL user data to the UE and sends the XnAP SN STATUS TRANSFER message to the target gNB indicating the latest PDCP SN transmitter and receiver status. The source gNB now also starts to forward DL user data received from the Core Network to the target gNB, which buffers this data for now.
310. Once the UE the has completed the random access procedure in the target cell, the UE stops the T304 timer and sends the handover complete message (i.e., an RRCReconfigurationComplete message) to the target gNB.
311. Upon receiving the handover complete message, the target gNB starts sending (and receiving) user data to/from the UE. The target gNB requests the Core Network (CN) to switch the DL user data path between the User Plane Function (UPF) and the source gNB to the target gNB (communication to the CN is not shown in FIG. 3). Once the path switch is completed, the target gNB sends the XnAP UE CONTEXT RELEASE message to the source gNB to release all resources associated to the UE.

In NR, the following principles are used for handovers (or in more general terms, mobility in RRC_CONNECTED state):
Mobility in RRC_CONNECTED state is network-controlled as the network has the best information regarding the current overall situation, such as load conditions, resources in different nodes, available frequencies, etc. The network can also take into account the situation of many UEs in the network, from a resource allocation perspective.
The network prepares a target cell before the UE accesses that cell. The source gNB provides the UE with the RRC configuration to be used in the target cell, including Signaling Radio Bearer (SRB) 1 (SRB1) configuration for sending of the handover (HO) complete message in the target cell. The source gNB in turn receives this RRC configuration from the target gNB in the form of a HandoverCommand inter-node RRC message included in the HANDOVER REQUEST ACKNOWLEDGE XnAP message (where the HandoverCommand is included in the “Target NG-RAN node To Source NG-RAN node Transparent Container” IE).
In the RRC configuration provided to the UE via the source gNB, the target gNB configures the UE with a C-RNTI to be used in the target cell. The target gNB then identifies the UE from the C-RNTI in the Medium Access Control (MAC) PDU containing the RRCReconfigurationComplete message constituting the HO complete message. Hence, there is no context fetching, unless a failure occurs, since the UE context was already transferred to the target gNB during the handover preparation (in the HANDOVER REQUEST XnAP message in the case of Xn handover).
To speed up the handover, the network provides the UE with information how to access the target cell, e.g. Random Access Channel (RACH) configuration, so the UE does not have to acquire System Information (SI) (other than the Master Information Block (MIB)) from the target cell prior to the handover. This information is included in the HandoverCommand and thus in the target cell RRC configuration sent to the UE.
The UE may be provided with Contention Free Random Access (CFRA) resources (in the above mentioned RRC configuration forwarded to the UE by the source gNB). The CFRA resources consist of one or more CFRA preamble(s) and may also contain CFRA occasions (i.e., Physical Random Access Channel (PRACH) transmission resources that are not included in the common PRACH configuration). In that case the target gNB identifies the UE from the random access preamble (Msg1). The principle is that the random access procedure can always be optimized with dedicated resources.
Security is prepared before the UE accesses the target cell, i.e., when performing an inter-gNB handover, security keys must be refreshed before sending the HO complete message (i.e., the RRCReconfigurationComplete message), so that new keys are used to encrypt and integrity protect the HO complete message, enabling verification in the target cell.
The target cell RRC configuration may be provided to the UE in two different forms: full configuration or delta configuration. In the former case, the provided RRC configuration is complete and self-contained, but a delta configuration only contains the configuration parts that are different in the target cell than in the source cell. The advantage of delta configuration is that the size of the HandoverCommand can be minimized.

### 3.2 Conditional Handover (CHO)

As previously described, handover typically occurs when the channel quality of the serving cell is degrading. The network is in control and bases the handover decision on measurement reports from the UE. In a typical case, the UE is configured to send a measurement report when an A3 event (neighbor cell quality becomes offset better than serving cell quality) is fulfilled. This will then trigger the gNB to decide to pursue a handover for the UE with the target cell being selected based on the reported neighbor cell measurements. If the target cell is controlled by another gNB (i.e., a neighbor gNB), the serving gNB initiates the handover preparation by sending a Handover Request XnAP message to the neighbor gNB. The neighbor gNB then responds with a Handover Request Acknowledge XnAP message containing, in the form of a HandoverCommand, the RRC configuration the UE should apply when connecting to the target cell. The serving (source) gNB then forwards the HandoverCommand to the UE as an RRCReconfiguration message. When the UE receives this message, it releases the source cell and starts the procedure of connecting to the target cell (i.e., synchronizing with the target cell and performing random access).

However, given the typical circumstances for handover, i.e., that the channel quality in the serving (source) cell is deteriorating when the UE is getting closer to the cell border, the handover operation is quite susceptible to errors. FIG. 5 illustrates two such error cases.

As FIG. 5 illustrates, one potential error associated with a regular handover is that the measurement report from the UE, which would trigger the gNB to initiate the handover, never reaches the gNB because of too many transmission/reception errors. Another potential error is that all handover preparations are successful, but the gNB fails to reach the UE with the RRCReconfiguration message constituting the Handover Command. Both these errors are typically caused by a serving cell channel quality degrading faster than expected.

To combat such errors, a special variant of handover called Conditional Handover (CHO) was introduced in 3GPP release 16. The CHO feature allows the serving gNB to configure a UE to autonomously trigger handover execution to a candidate target cell when a handover execution condition (or trigger condition) configured by the serving gNB is fulfilled. To realize this feature, the serving gNB includes a handover execution condition—often referred to as a CHO execution condition—together with the Handover Command (which in this case may be referred to as a Conditional Handover Command) forwarded from the candidate target gNB controlling the candidate target cell. This is configured in the condExecutionCond-r16 IE in the ASN.1 code in the RRC specification 3GPP TS 38.331 version 17.2.0. Release 16 of the 3GPP standards supports configuration of two triggering events, which in the context of CHO are referred to as conditional events (CondEvents). The supported CondEvents are CondEvent A3 and CondEvent A5 which are reused from the A3 and A5 events of the RRM framework. When used as CondEvents, A3 is defined as “Conditional reconfiguration candidate becomes amount of offset better than PCell/PSCell” and A5 is defined as “PCell/PSCell becomes worse than absolute threshold1 AND Conditional reconfiguration candidate becomes better than another absolute threshold2”. Furthermore, the specification also allows the combination of two events, whose conditions both have to be fulfilled for the duration of the configured time-to-trigger period, in order for the CHO execution to be triggered.

CHO is applicable for both intra-gNB handover and inter-gNB handover. The remainder of this CHO background description looks at the feature in the inter-gNB CHO case, since this is the most comprehensive and challenging case which best illustrates the complete concept.

When the UE receives the RRCReconfiguration message including configuration of a CHO (i.e., including a Handover Command and an associated CHO execution condition), it does not initiate execution of the handover immediately. Instead, it remains connected to the serving cell and begins to monitor the configured CHO execution condition (for the indicated candidate target cell). Note that a cell associated with a conditional handover configuration (i.e., a cell which the UE may connect to if the CHO execution condition is fulfilled) may be referred to as a candidate target cell. Similarly, a gNB controlling a cell associated with a conditional handover configuration (i.e., a candidate target cell) may be referred to as a candidate target gNB. The UE may be configured with multiple candidate target cells. For each candidate target cell, the UE is provided with an associated Handover Command (i.e., an RRCReconfiguration to be applied if/when connecting to the candidate target cell) and an associated CHO execution condition.

If/when the CHO execution condition is fulfilled for a candidate target cell, the UE releases the source cell and starts executing the handover towards the candidate target cell (which then becomes the target cell) for which the associated CHO execution condition was fulfilled. From the UE's point of view, the rest of the procedure proceeds like a regular handover procedure, except that the UE discards all CHO configurations when it has successfully connected to the target cell.

On the network side, the serving/source gNB is not aware of if or when a CHO execution condition is fulfilled for the UE, i.e., the UE will silently release the source cell without informing the source gNB. Therefore, after handover completion, i.e., after successful random access and successful reception of the RRCReconfigurationComplete message (which often is referred to as the Handover Complete message), the target gNB sends a HANDOVER SUCCESS XnAP message to the source gNB. This informs the source gNB that the UE has left the source cell and successfully completed a handover to the target cell controlled by the target gNB. If multiple candidate target gNBs were prepared for CHO for the UE, the source gNB can cancel the CHO preparations in the other (non-selected) candidate target gNBs using the HANDOVER CANCEL XnAP message, so that these gNBs can release any reserved resources.

During a regular handover, the source gNB starts to forward user plane data arriving in the source gNB to the target gNB (for further forwarding to the UE) as soon as the Handover Command is sent to the UE. In CHO, however, due to the uncertainty of if and when the UE will actually execute a handover, it may be suboptimal to start forwarding user plane data to a candidate target gNB upon transmission of the Handover Command, since this will cause unnecessary load on the Xn user plane, as well as processing load in the candidate target gNB. Therefore, the source gNB can choose not to initiate user plane forwarding until it receives the HANDOVER SUCCESS XnAP message from the target gNB. On the other hand, not initiating user plane forwarding until the HANDOVER SUCCESS XnAP message is received delays the availability of buffered downlink data in the target gNB, which increases the handover interruption time. Therefore, both options are available for CHO, referred to as early data forwarding (triggered any time after transmission of the Handover Command and before reception of the HANDOVER SUCCESS XnAP message) and late data forwarding (triggered upon reception of the HANDOVER SUCCESS XnAP message).

The conditional handover procedure is illustrated by the simplified message diagram in FIG. 6 and the more detailed message diagram in. FIG. 6 is a simplified message diagram for an inter-gNB Conditional Handover. The RRCReconfiguration* indicated with an asterisk (‘*’) is the Handover Command containing the RRC reconfiguration the UE shall apply if/when connecting to the candidate target gNB in the selected target cell.

The principle for CHO, as defined in 3GPP TS 38.300 Release 16 version 16.8.0, is described in FIGS. 7A and 7B and in the text following the figure. FIGS. 7A and 7B illustrates the inter-gNB Conditional Handover message flow in NR. The RRCReconfiguration message in step 6 is the Handover Command containing the CHO configuration(s). The message diagram is copied from 3GPP TS 38.300 version 16.8.0.

Based on, e.g., a measurement report received from the UE (in a MeasurementReport RRC message), the source node decides to configure the UE for CHO (step 2 in FIGS. 7A and 7B).

The source node prepares one or potentially more candidate target nodes by including a CHO indicator and the current UE configuration in the HANDOVER REQUEST XnAP message sent over Xn (step 3). Unlike a regular (non-CHO) handover, CHO enables the network to prepare the UE with more than one candidate target cell, each candidate target cell with its own target cell configuration (RRCReconfiguration) and its own CHO execution condition. The target cell configuration is generated by the candidate target node while the CHO execution condition is configured by the source node. For CHO in 3GPP Release 16, the CHO execution condition may consist of one or two trigger conditions—the A3 and A5 signal strength/quality-based events as defined in 3GPP TS 38.331 version 16.7.0.

As in a regular (non-CHO) handover, the handover command (RRCReconfiguration message) sent to the UE in step 6 is generated by the candidate target node but transmitted to the UE in the source cell by the source node. In case of an inter-node handover (as in FIGS. 7A and 7B), the handover command is sent from the candidate target node to the source node within the HANDOVER REQUEST ACKNOWLEDGE XnAP message (step 5) as a transparent container (specified as the HandoverCommand inter-node RRC message in 3GPP TS 38.331 version 17.2.0), meaning that the source node does not change the content of the handover command.

The target cell configuration (the RRCReconfiguration for the UE to use in the candidate target cell) and the CHO execution condition for each candidate target cell provided by the network to the UE may collectively be referred to as a CHO configuration, or, alternatively, each combination of candidate target cell, target cell configuration and CHO execution condition may be referred to as a CHO configuration (i.e., the terminology is not consistent). When received by the UE in the handover command (RRCReconfiguration message in step 6), the target cell configuration is not applied immediately as in a regular (non-CHO) handover. Instead, the UE starts to evaluate the CHO execution condition(s) configured by the network.

The network may configure the UE with one or two trigger conditions (A3 and/or A5 event) per CHO execution condition and candidate target cell. If the UE is configured with two trigger conditions, then both events need to be fulfilled to trigger the UE to execute the CHO towards the candidate target cell.

When the CHO execution condition is fulfilled for one of the candidate target cells, the UE releases its source cell connection, applies the associated target cell configuration (RRCReconfiguration) and starts the handover supervision timer T304. The UE now connects to the target node as in a regular handover (step 8). Any CHO configuration stored in the UE is released after completion of the (conditional) handover procedure.

The target node sends the HANDOVER SUCCESS XnAP message over Xn to the source node to inform the source node that the UE has successfully accessed the target cell (step 8a). Triggering of data forwarding to the target node is typically done after receiving the HANDOVER SUCCESS XnAP message in the source node—this is also known as “late data forwarding”. As an alternative, data forwarding may be triggered at an earlier stage in the handover procedure, after receiving the RRCReconfigurationComplete message from the UE (step 7). This mechanism is also known as “early data forwarding”.

If more than one candidate target cell was configured during the Handover Preparation phase, then the source node needs to cancel the CHO for the candidate target cells not selected by the UE. The source node sends the HANDOVER CANCEL XnAP message over Xn on the other signaling connection(s) and/or the other candidate target node(s) to cancel the CHO and thus to initiate a release of the reserved resources in the target node(s) (step 8c).

During a regular (non-CHO) handover, if the handover attempt fails due to, e.g., a radio link failure or expiry of timer T304, the UE will typically perform a cell selection and continue with an RRC re-establishment procedure. But when a CHO execution attempt fails and the selected cell happens to be a candidate target cell included in the CHO configuration, the UE will instead attempt a CHO execution to the selected cell. This UE behavior is however enabled/disabled by means of network configuration.

In the ASN.1 code in the RRC specification 3GPP TS 38.331 version 17.2.0, the CHO configurations are provided to a UE in the form of an add-mod-list (a ToAddModList denoted as CondReconfigToAddModList-r16). That is, a list of CHO configurations to be added to the CHO configurations the UE has previously received and stored, or to replace/modify CHO configurations the UE has previously received and stored. The UE stores the CHO configurations in the “UE variable” VarConditionalReconfig. Note that a UE is not mandated to implement a UE variable exactly as specified. A UE variable is a tool used in the specification to clearly describe the expected behavior or outcome of certain specified actions, e.g. configuration actions. The add-mod-list containing CHO configurations (i.e., CondReconfigToAddModList-r16) is included in an IE called ConditionalReconfiguration, which in turn is included in an RRCReconfiguration message. The relevant ASN.1 code from 3GPP TS 38.331 version 17.2.0 is shown in FIGS. 20A, 20B, and 20C.

As can be seen from the ASN.1 code, the condRRCReconfig-r16 IE contains an RRCReconfiguration. This is the RRCReconfiguration the UE should apply in the candidate target cell towards which the CHO is executed, if and when the CHO execution condition indicated by the condExecutionCond-r16 IE is fulfilled for the candidate target cell (i.e., this RRCReconfiguration constitutes the Conditional Handover Command).

An additional remark is that recursive CHO configurations are precluded by the release 17 3GPP standard. More precisely, a ConditionalReconfiguration-r16 IE cannot be included in an RRCReconfiguration message which contains a masterCellGroup IE for which the CellGroupConfig (which is included in the masterCellGroup IE as an OCTET STRING) contains a Reconfiguration WithSync IE. Hence, a Handover Command or a Conditional Handover Command cannot contain a ConditionalReconfiguration-r16 IE. This is clear from the following field description for the conditionalReconfiguration-r16 field in the RRCReconfiguration message (copied from 3GPP TS 38.331 version 17.2.0):
conditionalReconfiguration
Configuration of candidate target SpCell(s) and execution condition(s) for conditional handover, conditional PSCell addition or conditional PSCell change. The field is absent if any DAPS bearer is configured or if the masterCellGroup includes Reconfiguration WithSync or if the sl-L2RemoteUE-Config or sl-L2RelayUE-Config is configured. For conditional PSCell change, the field is absent if the secondaryCellGroup includes Reconfiguration WithSync. The RRCReconfiguration message contained in DLInformationTransferMRDC cannot contain the field conditionalReconfiguration for conditional PSCell change or for conditional PSCell addition.

### 4 CHO in Non-Terrestrial Networks (NTN)

Connected mode mobility challenges have been studied in the NTN study item phase for 3GPP Release 16 and are reported in the technical report 3GPP TR 38.821. Two of the challenges discussed in the Technical Report are frequent and unavoidable handovers (e.g., due to feeder link switch or cell switch in a quasi-Earth-fixed cell deployments) and handover of a large number of UEs, both of which could result in significant control plane overhead and frequent service interruptions. This issue is perhaps most pronounced in the quasi-Earth-fixed cell scenario when a geographic area is covered by a satellite (serving a cell covering the geographic area) for a limited time period while being replaced by a new satellite (serving a new cell covering the same geographic area) during the next time period, and so on. When the satellite covering the geographic area is replaced, the cell is also replaced, meaning that all the UEs connected in the old cell have to be handed over to the new cell, which potentially results in a high control signaling peak, because all the handovers have to occur in conjunction with the cell replacement (a.k.a. cell switch).

Hard and soft cell switch have been discussed in 3GPP, with preference for the soft switch case, wherein the old and the new cell both (simultaneously) cover the geographic area during a short overlap period, to simplify handovers with low interruptions.

To mitigate the expected signaling overhead at frequent handovers for a large number of UEs, 3GPP agreed to introduce support for Conditional Handover (CHO) for NTN in 3GPP release 17 with the CHO procedure and the trigger conditions as defined for NR in 3GPP release 16 as a baseline.

In terrestrial networks, a UE can typically determine that it is near a cell edge by detecting a clear difference in the received signal strength (e.g., by performing RSRP-based measurements) compared to the received signal strength at the cell center. In NTN deployments on the other hand, the difference in signal strength between the cell center and the cell edge is typically smaller. That is, the signal strength decreases slowly with the distance from the cell center (much smaller than in a typical terrestrial cell). This is often described as a “flat signal strength” or a “flat RSRP”. Thus, a UE may experience a small difference in signal strength between two beams (e.g., representing two cells) in a region of overlap. This may lead to suboptimal UE behaviors such as repetitive handovers (“ping-pong handovers”) back and forth between the two cells.

To avoid an overall reduction in handover robustness, 3GPP agreed to introduce the following trigger conditions (apart from the already existing trigger conditions, the A3 and A5 CondEvents) for CHO in NTN.
A new time-based trigger condition, defining a time period, or a time window, when the UE may execute CHO to a candidate target cell.
A new location-based trigger condition, defining a first distance threshold for the distance from the UE to a reference location in the source cell and a second distance threshold for the distance from the UE to a reference location in a candidate target cell, based on which the UE may trigger and execute CHO.
Reuse of the existing A4 event (neighbor becomes better than threshold) as defined, e.g., in 3GPP TS 38.331 version 16.7.0, i.e., an A4 CondEvent is introduced in release 17 of the 3GPP standard (specified e.g. in 3GPP TS 38.331 version 17.2.0).

The time-based trigger condition is defined by 3GPP as the time period [T1, T2] associated with each candidate target cell, where T1 is the starting point of the time period represented by a Coordinated Universal Time (UTC) and T2 is the end point of the time period represented by a time duration or a timer value, e.g., 10 seconds.

In 3GPP TS 38.331 version 17.2.0, the time-based condition (condEventT1-r17) is defined in ASN.1 in the ReportConfigNR IE as shown in FIG. 21. In the ASN.1 code, the t1-Threshold-r17 field represents T1 and its INTEGER value encodes the UTC (in terms 10 ms units elapsed since the UTC starting point). The t1-Threshold-r17 field counts the number of UTC seconds in 10 ms units since 00:00:00 on Gregorian calendar date 1 Jan. 1900 (midnight between Sunday, Dec. 31, 1899 and Monday, Jan. 1, 1900). The duration encoded by the duration-r17 field indicates steps of 100 ms (i.e., it ranges from 100 ms to 10 minutes). It should be counted as starting from T1, which means that in principle T2=T1+duration=t1-Threshold-r17+duration-r17.

3GPP further agreed that the time-based trigger condition can only be configured in the UE in combination with one of the signal strength/quality based CondEvents A3, A4 or A5. This implies that the UE may only perform CHO to the candidate target cell in the time window defined by T1 and T2 if the signal strength/quality-based event is fulfilled within this time frame. The time-based condition AND the signal strength/quality-based condition must thus be fulfilled simultaneously in order for the UE to execute the CHO.

If the CHO execution for a certain candidate target cell is not triggered during the time period [T1, T2], i.e. after T1 but before T2, or if the CHO execution is triggered during this time period, but the CHO execution fails, the UE is not allowed to use the CHO configuration after T2, even if it in the cell selection during a triggered RRC re-establishment procedure happens to select the concerned candidate target cell and even if the network configuration allows the UE (by including the attemptCondReconfig field in the ConditionalReconfiguration IE) to perform conditional reconfiguration to a candidate target cell. This rule applies also if the UE selects another cell for which the UE has a CHO configuration, i.e. if time has passed T2 for that CHO configuration, the UE is not allowed to use the CHO configuration to turn the RRC re-establishment into a CHO execution for that cell.

In addition to the time-based condition, 3GPP has also agreed to specify a location-based condition for CHO execution. The location-based condition is fulfilled if the UE's distance to a reference location of the serving (source) cell (assumedly representing the center of the serving/source cell) exceeds a first threshold while the distance to a reference location of a candidate target cell (assumedly representing the center of the candidate target cell) goes below a second threshold. Like the time-based condition, the location-based condition must be combined with one of the signal strength/quality-based CondEvents A3, A4 or A5, and both the location-based condition and the signal strength/quality-based condition have to be fulfilled for the CHO execution to be triggered.

### SUMMARY

Systems and methods are disclosed that related to Conditional Handover (CHO) in a manner that is particularly well-suited for a Non-Terrestrial Network (NTN). In one embodiment, a method performed by a User Equipment (UE) for conditional handover comprises receiving, from a network node, information that configures the UE with a set of conditional handover configurations. The set of conditional handover configurations comprises two or more conditional handover configurations, wherein information from at least one conditional handover configuration from the set of conditional handover configurations is reused for at least one other conditional handover configuration from the set of conditional handover configurations. The method further comprises operating in accordance with the set of conditional handover configurations. In this manner, an efficient and compact (in terms of data and message size) means for configuring multiple (e.g., sequential) time-based CHOs in a UE is provided.

In one embodiment, the set of conditional handover configurations is to be applied by the UE in sequence. In one embodiment, omitted information in one of the conditional handover configurations implies that corresponding information from a preceding conditional handover configuration in the set is to be reused.

In one embodiment, omitted information in one of the conditional handover configurations implies that corresponding information from one of the conditional handover configurations for a source or serving cell where the set of conditional handover configurations was configured is to be reused.

In one embodiment, for a particular configuration parameter, a value for the particular configuration parameter for at least one conditional handover configuration from the set of conditional handover configurations is implied by a value for the particular configuration parameter for another conditional handover configuration from the set of conditional handover configurations and a known periodicity.

In one embodiment, for a particular configuration parameter, a value for the particular configuration parameter for at least one conditional handover configuration from the set of conditional handover configurations is implied by a value for the particular configuration parameter for another conditional handover configuration from the set of conditional handover configurations and a known offset.

In one embodiment, for a particular configuration parameter, values for the particular configuration parameter for the set of conditional handover configurations is implied by a toggling or stepping through a predefined or configured set of values for the particular configuration.

In one embodiment, the set of conditional handover configurations is restricted to a maximum of two involved network nodes.

In one embodiment, the set of conditional handover configurations comprises multiple intra-base station conditional handover configurations but only one inter-base station conditional handover configuration.

In one embodiment, the set of conditional handover configurations comprises multiple intra-base station conditional handover configurations for a single base station.

In one embodiment, the set of conditional handover configurations is restricted to a maximum of two involved network nodes but an unlimited number of intra-base station and inter-base station conditional handover configurations involving the maximum of two involved network nodes.

In one embodiment, a number of candidate target cells that the UE can handle in the set of conditional handover configurations is based on one or more capabilities of the UE.

In one embodiment, Cell Radio Network Temporary Identifiers (C-RNTIs) indicated in the set of conditional handover configurations are assigned by the network node.

In one embodiment, C-RNTIs for the set of conditional handover configurations are assigned in such a manner as to mitigate a risk of C-RNTI collisions.

In one embodiment, C-RNTIs for the set of conditional handover configurations are assigned from a reserved pool of C-RNTIs.

In one embodiment, information comprised in a measurement object in one of the conditional handover configurations in the set of conditional handover configurations is reused for all other conditional handover configurations in the set of conditional handover configurations. In one embodiment, carrier frequency information for the set of conditional handover configurations is indicated separately from the measurement object.

In one embodiment, the method further comprises receiving an update for the set of conditional handover configurations and operating in accordance with the updated set of conditional handover configurations.

Corresponding embodiments of a UE are also disclosed. In one embodiment, a UE is adapted to receive, from a network node, information that configures the UE with a set of conditional handover configurations. The set of conditional handover configurations comprises two or more conditional handover configurations, wherein information from at least one conditional handover configuration from the set of conditional handover configurations is reused for at least one other conditional handover configuration from the set of conditional handover configurations. The UE is further adapted to operate in accordance with the set of conditional handover configurations.

In one embodiment, a UE comprises a communication interface comprising a transmitter and a receiver, and processing circuitry associated with the communication interface. The processing circuitry is configured to cause the UE to receive, from a network node, information that configures the UE with a set of conditional handover configurations. The set of conditional handover configurations comprises two or more conditional handover configurations, wherein information from at least one conditional handover configuration from the set of conditional handover configurations is reused for at least one other conditional handover configuration from the set of conditional handover configurations. The processing circuitry is further configured to cause the UE to operate in accordance with the set of conditional handover configurations.

Embodiments of a method performed by a network node in a Radio Access Network (RAN) of a cellular communications system are also disclosed. In one embodiment, a method performed by a network node comprises sending, to a UE, information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations.

Embodiments of a network node for a RAN of a cellular communications system are also disclosed. In one embodiment, a network node for a RAN of a cellular communications system is adapted to send to a UE information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations.

In one embodiment, a network node for a RAN of a cellular communications system comprises a communication interface and processing circuitry associated with the communication interface. The processing circuitry is configured to cause the network node to send to a UE information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example architecture of a satellite network with bent pipe transponders (i.e., the transparent payload architecture);

FIG. 2 is an illustration of parameters included in one ephemeris data format;

FIG. 3 and FIGS. 4A and 4B are signaling flow diagrams showing signaling between a User Equipment (UE), a source New Radio (NR) base station (gNB), and a target gNB during an Xn-based inter-gNB handover in NR;

FIG. 5 illustrates two handover error cases;

FIGS. 6 and 7 illustrate a conditional handover procedure;

FIG. 8 illustrates an example timeline with satellite switches and feeder link switches (with the disappearance of a cell as a result of a satellite switch (at the time indicated by t-Service-r17) chosen as the starting point of each period in the periodicity);

FIG. 9 illustrates an example timeline with satellite switches and feeder link switches, each with an associated time-based Conditional Handover (CHO) time window (with the disappearance of a cell as a result of a satellite switch (at the time indicated by t-Service-r17) chosen as the starting point of each period in the periodicity);

FIG. 10 is a flow chart that illustrates the operation of a UE in accordance with at least some of the embodiments of the present disclosure;

FIG. 11 is a flow chart that illustrates the operation of a network node (e.g., a base station such as, e.g., a gNB) in accordance with at least some of the embodiments of the present disclosure;

FIG. 12 shows an example of a communication system in accordance with some embodiments;

FIG. 13 shows a UE in accordance with some embodiments;

FIG. 14 shows a network node in accordance with some embodiments;

FIG. 15 is a block diagram of a host, which may be an embodiment of the host of FIG. 12, in accordance with various aspects described herein;

FIG. 16 is a block diagram illustrating a virtualization environment in which functions implemented by some embodiments may be virtualized;

FIG. 17 shows a communication diagram of a host communicating via a network node with a UE over a partially wireless connection in accordance with some embodiments;

FIGS. 18A and 18B illustrate ASN.1 code for System Information Block (SIB) 19 (SIB19) as defined in 3GPP Technical Specification (TS) 38.331 version 17.2.0;

FIGS. 19A and 19B illustrate ASN.1 code for NTN-Config-r17 IE as defined in 3GPP TS 38.331 version 17.2.0;

FIGS. 20A, 20B, and 20C illustrate other relevant ASN.1 code from 3GPP TS 38.331 version 17.2.0;

FIG. 21 illustrates ASN.1 code for time-based condition (condEventT1-r17) as defined in in 3GPP TS 38.331 version 17.2.0; and

FIGS. 22 to 35 illustrate various example embodiments of the present disclosure.

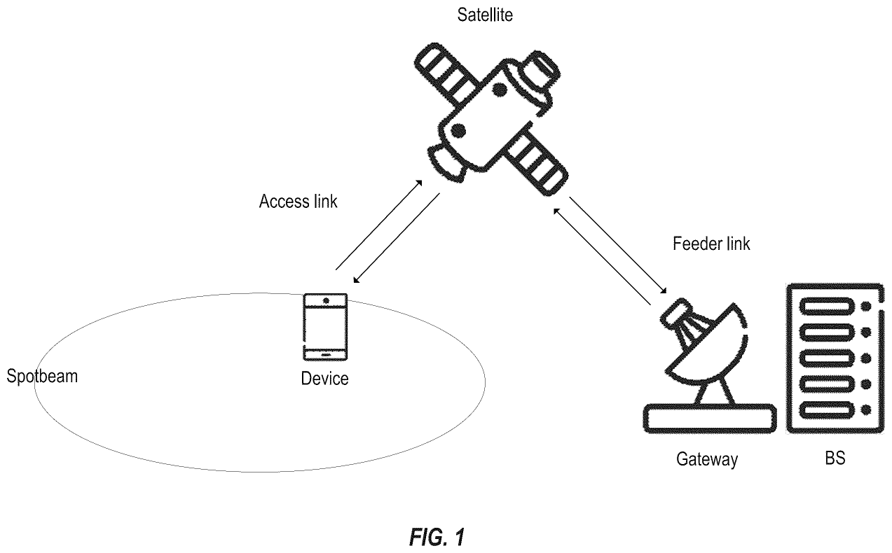

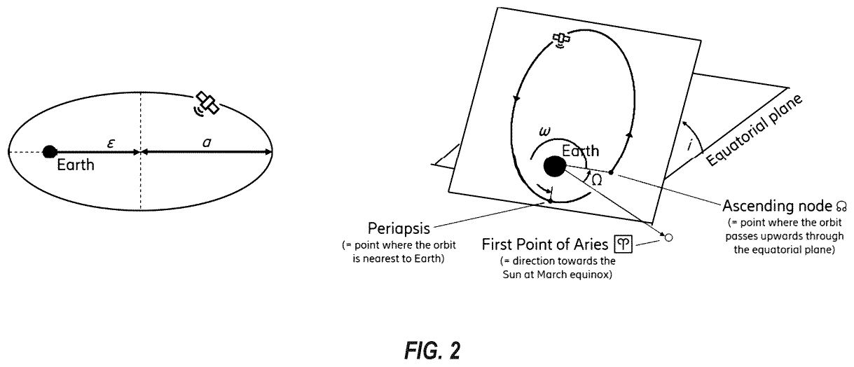

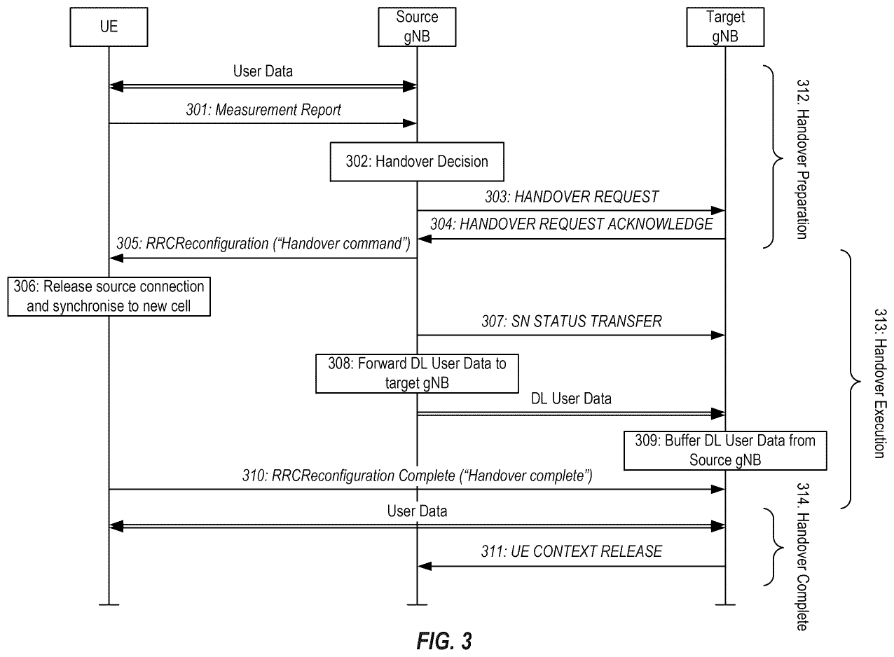

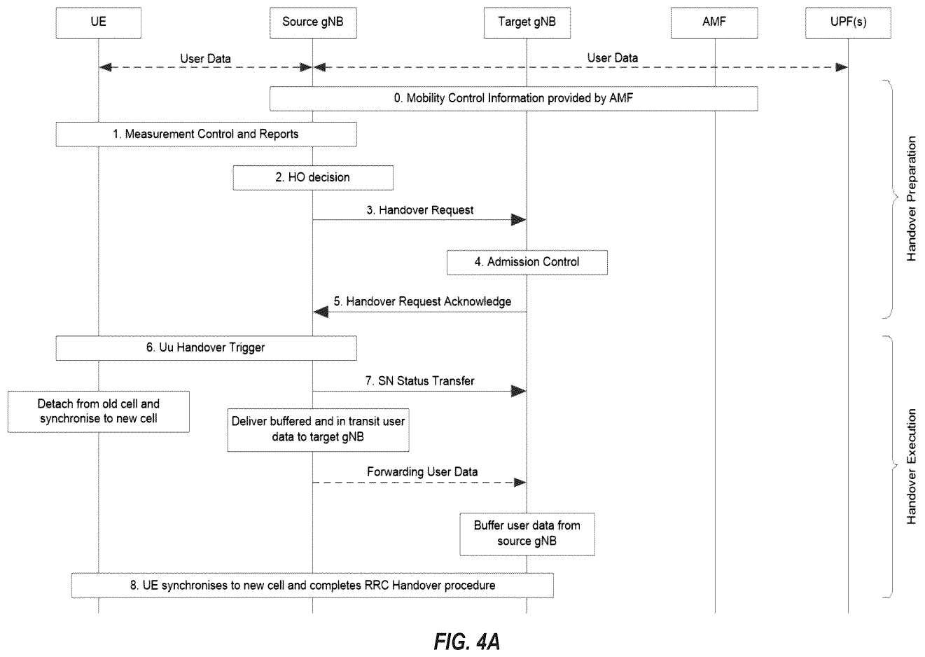

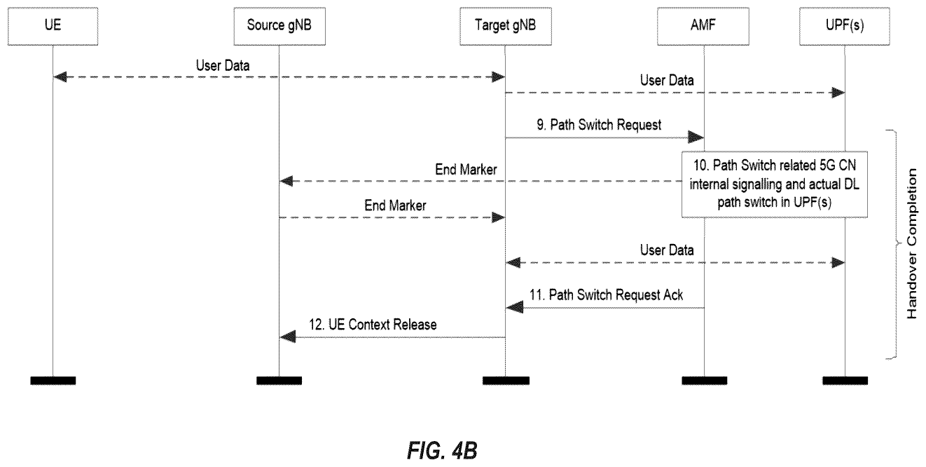

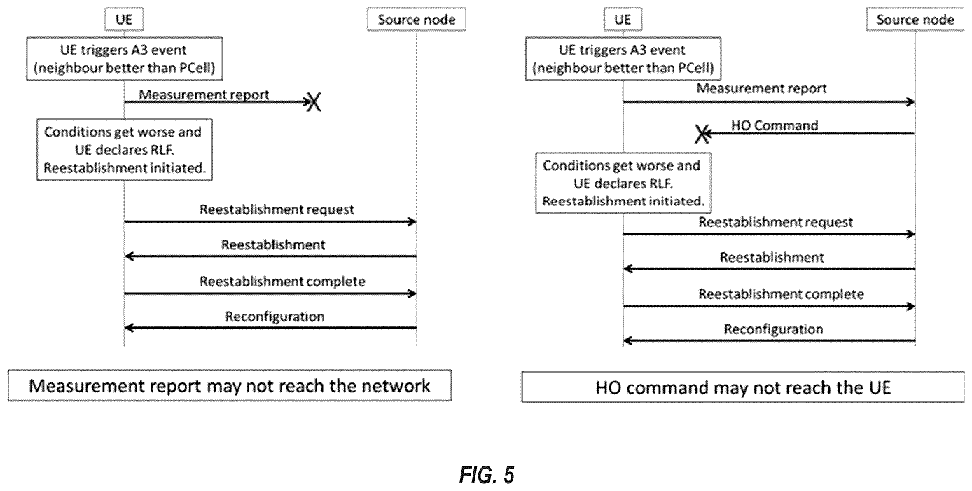

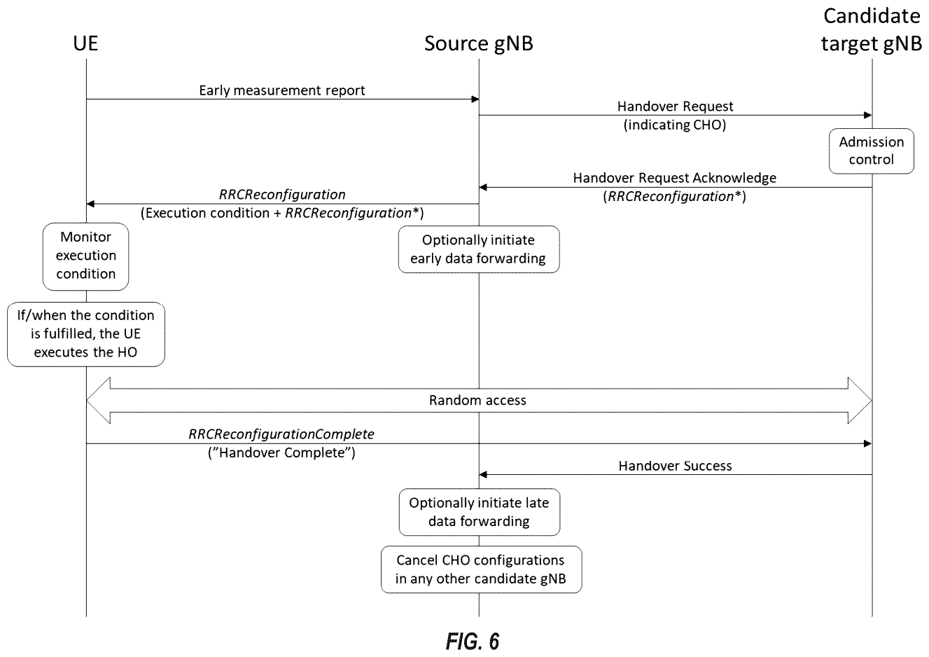

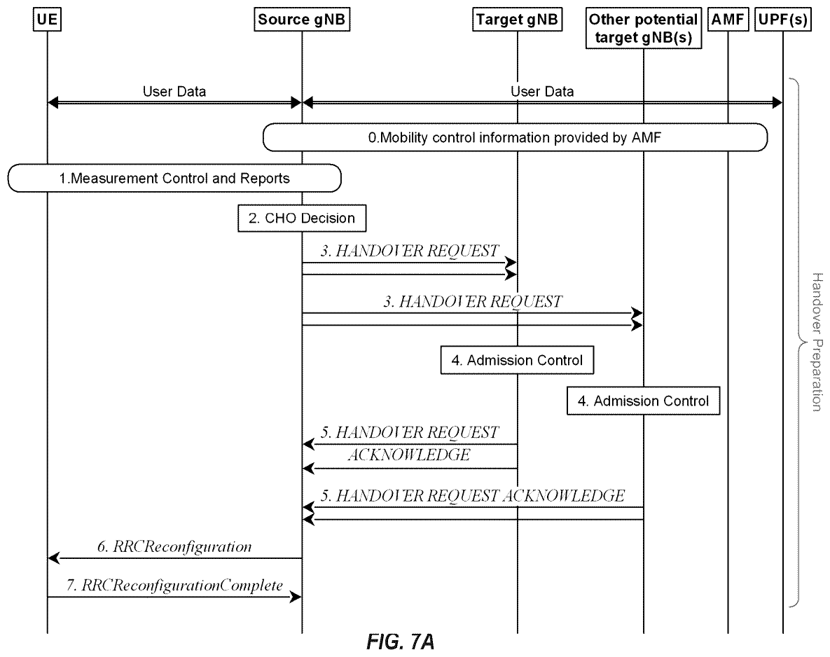

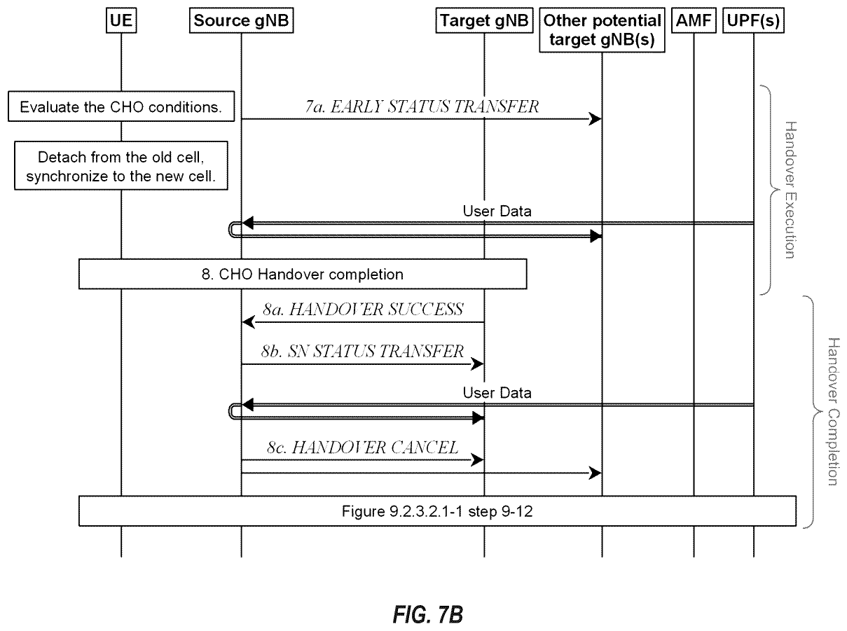

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s) with respect to handovers in a Non-Terrestrial Network (NTN). A problem associated with the dynamic conditions in an NTN is that there will be frequent handovers of many User Equipments (UEs), since all the UEs in a cell are affected when a cell moves or, in the case of quasi-Earth-fixed cells, is replaced by a new cell (i.e., cell switch). The problem is particularly pronounced in the case of quasi-Earth-fixed cells or when a cell switch is caused by a feeder link switch, since all the UEs in the old cell have to be handed over to the new cell during a short overlap period (i.e., during a short period when the old and the new cell coexist), thereby creating a large signaling peak.

The introduction of time-based Conditional Handover (CHO) aims to mitigate this problem in quasi-Earth-fixed cell deployments by allowing the handovers of the UEs to be prepared well in advance before the quasi-Earth-fixed cell is replaced by a new cell, somewhat distributing the signaling in time. However, even though the distribution in time of the CHO preparations reduces the signaling load peak associated with the handover preparations, it does not reduce the total amount of signaling involved. Therefore, means to reduce the total amount of signaling have been sought in the 3^{rd} Generation Partnership Project (3GPP). One means that has been proposed is to prepare CHOs for multiple coming cell switches (i.e., when quasi-Earth-fixed cells sequentially replace each other). However, this will still result in large amounts of data being signaled in total, and the messages used for preparations of multiple sequential CHOs may become prohibitively large, e.g., requiring segmentation of Radio Resource Control (RRC) messages and/or increasing the risk of failure to get the messages successfully transmitted to the UEs. A related problem is that proactive preparation of multiple CHOs to be sequentially applied will include recursive inter-gNodeB (gNB) signaling in multiple steps in case the cell switches involve change of gNBs. For instance, if the gNB that is to provide the multiple CHO configurations to a UE (the source gNB) sends a HANDOVER REQUEST XnAP message to the next gNB in the sequence of CHOs, this gNB in turn may have to send a subsequent HANDOVER REQUEST XnAP message to the next gNB in the sequence of CHOs, and so on until the last gNB in the sequence is reached which then returns a HANDOVER REQUEST ACKNOWLEDGE XnAP message, allowing the preceding gNB to in turn send a HANDOVER REQUEST ACKNOWLEDGE XnAP message, and so on, until the source gNB receives a HANDOVER REQUEST ACKNOWLEDGE message. Such recursive signaling may take prohibitively long time and may e.g., cause timeout in a gNB waiting for a response. Also, in case of a failure e.g., when allocating the necessary resources in one of the candidate target gNBs (in the sequence of CHOs), it might be very complex (and time-consuming) to release the resources that have already been allocated in the other candidate target gNB(s) and that now have become obsolete.

Certain aspects of the disclosure and their embodiments may provide solutions to these or other challenges. Embodiments of the proposed solution leverage (intentional) commonality in the configuration in sequential quasi-Earth-fixed cells. This allows a gNB to a priori be aware of the configuration of a sequence of candidate target cells in a sequence of CHO configurations. Based on the assumption of such a priori knowledge, embodiments of the proposed solution include that a gNB can configure a UE with a sequence of CHO configurations (denoted as a “CHO chain configuration” which configures a chain of CHOs), and this can be done without the need for recursive inter-gNB signaling during the preparation phase.

The CHO chain configuration can be made very compact by leveraging the commonality in the involved cells' configurations and using delta-configurations to reduce the amount of signaled configuration data. In one embodiment, for configuration parameters that inherently differ between consecutive quasi-Earth-fixed cells, such as t-Service-r17 and t1-Threshold-r17 (which are both UTC timestamps), the periodical property of the involved cell switches is leveraged to indicate these parameters in a compact way. In another embodiment, in other cases of changing configuration data such as the carrier frequency, toggling between different configurations, e.g., toggling between two carrier frequencies, may be assumed such that at most two configurations (e.g., carrier frequencies) would have to be indicated for an entire CHO chain configuration.

Two basic principles for the realization/implementation of a CHO chain configuration are proposed: a list of CHO configurations (to be applied sequentially), or recursive CHO configurations. In both cases, the CHO chain configuration would preferably include a part which is generally applicable to all CHO configurations in the CHO chain configuration.

Embodiments of the present disclosure leverage the periodic nature of switches of quasi-Earth-fixed cells and (intentionally achieved) commonality in the configurations of quasi-Earth-fixed cells sequentially covering a certain quasi-Earth-fixed cell area to enable compact configurations of multiple CHOs (in the form of a list of CHO configurations or recursive CHO configurations) to be sequentially applied, without the need for recursive inter-gNB signaling during the preparation phase. Central concepts to achieve this include using delta-configuration, utilizing a periodicity indication to allow determination of time-dependent configuration parameters in subsequent candidate target cells, and cycling through a set of configurations (e.g., toggling between two configurations).

Certain embodiments may provide one or more of the following technical advantage(s). An advantage of the proposed solution is that it provides an efficient and compact (in terms of data and message size) means for preparing multiple sequential time-based CHOs in a UE connected in a quasi-Earth-fixed NTN cell. Furthermore, the proposed solution achieves this without the need for recursive inter-gNB signaling.

### 1 Notes

Note 1: In this solution description, the term Non-Terrestrial Network (NTN) may, depending on the context, refer to either or both of New Radio (NR) NTN and Internet of Things (IoT) NTN, and sometimes the term is used to refer to only NR NTN.

Note 2: The embodiments outlined below are described mainly in terms of NR based NTNs, but they are equally applicable in an NTN based on Long Term Evolution (LTE) technology (and in particular IoT NTN).

Note 3: The term “network” is used in the solution description to refer to a network node, which typically will be a gNB (e.g. in a NR based NTN) or an eNB (e.g. in an LTE based NTN, such as an IoT NTN), but which may also be a base station or an access point in another type of network based on communication via satellites or High Altitude Platform System (HAPS), or any other network node (in a network involving satellites or HAPS) with the ability to directly or indirectly communicate with a UE. Refinements with finer granularity are also conceivable. For instance, a gNB may be an en-gNB, and if a split gNB architecture is applied (dividing the gNB into multiple separate entities or notes), the term “node” may refer to a part of the gNB, such as a gNB-Central Unit (CU) (often referred to as just CU), a gNB-Distributed Unit (DU) (often referred to as just DU), a gNB-CU-Control Plane (CP) or a gNB-CU-User Plane (UP). Similarly, an eNB may be an ng-eNB, and if a split eNB architecture is applied (dividing the gNB into multiple separate entities or notes), the term “network” (and the network node it implies) may refer to a part of the eNB, such as an eNB-CU, an eNB-DU, an eNB-CU-CP or an eNB-CU-UP. Furthermore, the term “network” (and the network node it implies) may also refer to an Integrated Access and Backhaul (IAB)-donor, IAB-donor-CU, IAB-donor-DU, IAB-donor-CU-CP, or an IAB-donor-CU-UP.

Note 4: The term “network” is used in the solution description to refer to a network node, which typically will be an gNB (e.g., in a NR based NTN), but which may also be a eNB (e.g. in a LTE based NTN), or a base station or an access point in another type of network, or any other network node with the ability to directly or indirectly communicate with a UE.

Note 5: The terms “source node”, “target node” and “candidate target node” may be used in the solution description. The “node” in these terms should be understood as typically being a Radio Access Network (RAN) node in an NTN based on NR technology, LTE technology or any other Radio Access Technology (RAT) in which conditional handover or another conditional mobility concept is defined. In an NR based NTN, such a RAN node may be assumed to be a gNB. In an LTE based NTN (including an IoT NTN), such a RAN node may be assumed to be an eNB. Alternatives to, or refinements of, these interpretations are however also conceivable. For instance, a gNB may be an en-gNB, and if a split gNB architecture is applied (dividing the gNB into multiple separate entities or notes), the term “node” may refer to a part of the gNB, such as a gNB-CU (often referred to as just CU), a gNB-DU (often referred to as just DU), a gNB-CU-CP or a gNB-CU-UP. Similarly, an eNB may be an ng-eNB, and if a split eNB architecture is applied (dividing the gNB into multiple separate entities or notes), the term “node” may refer to a part of the eNB, such as an eNB-CU, an eNB-DU, an eNB-CU-CP or an eNB-CU-UP. Furthermore, the “node” in the terms may also refer to an IAB-donor, IAB-donor-CU, IAB-donor-DU, IAB-donor-CU-CP, or an IAB-donor-CU-UP.

Note 6: When CHO is configured for a UE, a cell which the UE potentially can connect to (i.e., if the CHO execution condition is fulfilled for the cell) is denoted as “candidate target cell”. Similarly, a RAN node controlling a candidate target cell is denoted as “candidate target node” or, in NR and NR NTN, “candidate target gNB”. However, once the UE has detected a fulfilled CHO execution condition for a candidate target cell, this terminology becomes a bit blurred. At this point, during the actual execution of the CHO and when the UE has connected to the new cell, the concerned cell may be referred to as either a “candidate target cell” or a “target cell”. Similarly, a RAN node controlling such a cell, may in this situation be referred to as either a “candidate target node” (or “candidate target gNB”) or a “target node” (or a “target gNB”).

Note 7: A condition included in a CHO configuration governing the execution of the conditionally configured procedure may be referred to as a CHO execution condition, a handover (HO) execution condition, a CHO trigger condition, a HO trigger condition or sometimes just a trigger condition. Furthermore, phases of the procedure may be referred to as the Handover Preparation phase, the Handover Execution and/or the Handover Completion phase, or may be referred to as the Conditional Handover Preparation phase (or the (conditional) Handover Preparation phase), the Conditional Handover Execution phase and/or the Conditional Handover Completion phase.

Note 8: The target cell configuration (the RRCReconfiguration for the UE to use in the candidate target cell) and the CHO execution condition for each candidate target cell provided by the network to the UE may collectively be referred to as a CHO configuration, or, alternatively, each combination of candidate target cell, target cell configuration and CHO execution condition may be referred to as a CHO configuration (i.e., the terminology is not consistent).

Note 9: When writing message names of a communication protocol, two equivalent principles are used in this document. The writing principle “<protocol name> <message name> message”, for example “XnAP HANDOVER CANCEL message”, and the writing principle “<message name> <protocol name> message”, for example “HANDOVER CANCEL XnAP message” are equivalent, both referring to a message (i.e., “<message name>”) of a communication protocol (i.e., “<protocol name>”), e.g., the HANDOVER CANCEL message of the communication protocol XnAP. The same writing format equivalence applies to other communication protocols, such as NGAP.

Note 10: When accessing a target cell during a HO or a CHO, the first message the UE sends to the target node in the target cell, after having sent a random access preamble and having received a Random Access Response message, is an RRCReconfigurationComplete message, indicating the successful completion of the HO or CHO. It should be noted that this RRCReconfigurationComplete message is often referred to as a Handover Complete message.

Note 11: According to 3GPP agreements, as well as 3GPP TS 38.331 version 17.2.0, a time-based CHO execution condition will always be combined with a signal strength/quality CHO execution condition (both of which have to be fulfilled to trigger CHO execution). However, all the embodiments in the proposed solution which do not assume that the UE monitors a signal strength/quality condition (i.e., an A3, A4 or A5 event), are equally applicable if the UE is configured only with a time-based CHO execution condition. Note that in embodiments describing lack of trigger of the CHO execution within the time window (i.e., between T1 and T2) assume that a signal strength/quality condition is configured but not fulfilled between T1 and T2.

Note 12: The terms “Handover Command” and “HandoverCommand” are used interchangeably herein. Both terms refer to a UE configuration the target node (of a regular handover) or candidate target node (of a conditional handover), during the (conditional) handover preparation phase, compiles for the UE to be subject to the handover or conditional handover. This UE configuration is compiled in the form of an RRCReconfiguration message which is conveyed to the UE via the source node. The RRCReconfiguration is associated with a certain target cell or candidate target cell and the UE applies the RRCReconfiguration when/if it accesses the concerned (candidate) target cell controlled by the (candidate) target node. Formally, “HandoverCommand” is an RRC inter-node message which is conveyed from a target node or a candidate target node to a source node during the preparation of a handover or a conditional handover. It is carried by the HANDOVER REQUEST ACKNOWLEDGE XnAP in the Target NG-RAN node To Source NG-RAN node Transparent Container IE. The “HandoverCommand” RRC inter-node message contains an RRCReconfiguration the UE should apply when accessing the target cell or candidate target cell. The source node forwards this RRCReconfiguration (i.e., the HandoverCommand) to the UE. In this solution description, the term “HandoverCommand” is also used to denote this RRCReconfiguration when it is stored in a UE as a part of a CHO configuration. This is also called the condRRCReconfig-r16 IE in the CondReconfigToAddMod-r16 IE (which contains the CHO configuration) in the CondReconfigToAddModList-r16 IE in the ConditionalReconfiguration-r16 IE. In the context of CHO, the terms “Conditional Handover Command”, “(Conditional) Handover Command” and “(conditional) Handover Command” may also be used.

Note 13: The solution is described in terms of conditional handover (CHO), but it is equally applicable to other conditional mobility procedures, e.g. conditional Primary Secondary Cell (PSCell) change (e.g., a dual connectivity scenario with the Primary Cell (PCell) in a terrestrial network and PSCell in a Non-Terrestrial Network), or conditional L1/L2 mobility procedures (e.g. time-based L1/L2 mobility procedures).

Note 14: The solution description involves conditional handover procedures which primarily are described as Xn based conditional handovers, i.e. inter-gNB CHOs where a Xn interface is established between the gNBs and the XnAP messages HANDOVER REQUEST and HANDOVER REQUEST ACKNOWLEDGE are used during the preparation of a CHO. However, the solution is also applicable when the CHO is prepared between gNBs which lack an established Xn interface, in which case the CHO preparation signaling is conveyed via the core network using NGAP messages (and possibly a protocol for messaging between two AMFs in the core network). In this case, the HANDOVER REQUEST XnAP message is replaced by the HANDOVER REQUIRED NGAP message and the HANDOVER REQUEST NGAP message, where the HANDOVER REQUIRED NGAP message is sent from the source gNB to the core network and the core network sends the relevant information further to the candidate target gNB in a HANDOVER REQUEST NGAP message. Similarly, the HANDOVER REQUEST ACKNOWLEDGE XnAP message is replaced by the HANDOVER REQUEST ACKNOWLEDGE NGAP message and the HANDOVER COMMAND NGAP message, where the HANDOVER REQUEST ACKNOWLEDGE NGAP message is sent from the candidate target gNB to the core network and the core network sends the relevant information further to the source gNB in a HANDOVER COMMAND NGAP message. When the messaging is passed via the core network, this may involve one or more AMF(s). If the source gNB and the candidate target gNB are connected to the same AMF, this AMF handles all the above described message receptions and transmissions. If the source gNB and the candidate target gNB are connected to different AMFs, these AMFs forward the information between each other using a core network protocol.

Note 15: In this document, the term “CHO configuration” typically refers to a CHO configuration for a single candidate target cell. However, sometimes the term “CHO configuration” refers collectively to all CHO related configuration that a UE has stored, which may include configurations for multiple candidate target cells.

Note 16: The term “delta-configuration” refers to a method of reconfiguration where only the changes from the existing/old configuration are indicated (and applied accordingly by the entity, e.g. a UE, receiving the delta-configuration). Whether the configuration information in an RRC message providing configuration parameters to a UE should be applied as a full configuration, replacing any previous configuration, or a delta-configuration is determined by the presence or absence of the fullConfig IE in the message, where presence of the fullConfig IE means that the provided configuration information should be applied as a full configuration, whereas absence of the fullConfig IE means that the provided configuration information should be applied as delta-configuration. The fullConfig IE may be included in an RRCReconfiguration message used as a Handover Command or a Conditional Handover Command, and in an RRCResume message. Delta-configuration is applied in relation to a reference configuration, which typically is the UE's current configuration, e.g. the UE's source cell configuration when delta-configuration is used to configure the UE for a target cell during a handover execution or a conditional handover execution. “Delta-configuration” may also be referred to as “delta configuration”, “delta-signaling” or “delta signaling”.

Note 17: The terms information element (IE) and field are used more or less interchangeably in this document. Also, the term parameter is sometimes used to denote the same concept.

Note 18: Parameters/IEs/fields used in ASN.1 code as well as in procedural text in the 3GPP RRC specification for 5G/NR, i.e. 3GPP TS 38.331 version 17.2.0, are often named with a suffix indicating the number of the release of the 3GPP standard the parameter/IE/field was introduced in (e.g. the suffix “-r17” for a parameter/IE/field introduced in release 17 of the 3GPP standard). Parameters/IEs/fields following this naming convention are typically referred to both with and without the suffix, where the name including the suffix is used in the ASN.1 code (and thus defines the formal name from the ASN.1 compiler's perspective), while the name without the suffix is used in running text, e.g. in field descriptions and procedural text. Relevant examples in the context of this document include the parameters/IEs/fields t1-Threshold-r17/t1-Threshold and t-Service-r17/t-Service. In this document, both name variants may occur for various parameters/IEs/fields.

Note 19: There are two main deployment principles for NTN: quasi-Earth-fixed cells and Earth-moving cells. These deployment principles are also referred to by other names. The quasi-Earth-fixed cells deployment principle is also referred to as quasi-Earth-fixed beams. The Earth-moving cells deployment principle is also referred to as Earth-moving beams, or shorter, moving or and moving beams.

Note 20: In a time-based CHO configuration for a certain candidate target cell, a time window is defined within which the configured UE may execute the CHO, provided that the signal strength/quality CHO execution condition is fulfilled, and outside which the UE may not execute the CHO. Such a time window is herein sometimes referred to as a CHO execution time window or a CHO execution window. A CHO execution time window is said to last between the times T1 and T2, where T1 is represented by the t1-Threshold-r17 field and T2 is derived from the t1-Threshold-r17 field combined with the duration-r17 field, such that T2=t1-Threshold-r17+duration-r17. Both the t1-Threshold-r17 field and duration-r17 field are included in the condEventT1-r17 IE, which in turn is included in the CondTriggerConfig-r16 IE, which in turn is included in the ReportConfigNR IE. The t1-Threshold-r17 field is a UTC timestamp and the duration-r17 field represents a time period between 100 ms and 600 seconds (in steps of 100 ms).

### 2 Solution

### 2.1 Basic Principles

An important basic principle of embodiments of the proposed solution is to leverage commonality in the configuration in the sequence of candidate target cells in the sequence of CHO configurations to optimize the representation of the CHO configurations using data compression through reuse of the same configuration parameter settings for multiple-preferably all-CHO configurations. To this end, the network operator may ensure that all cells taking turn in serving a certain quasi-Earth-fixed cell area have as much as possible in common in their configurations. This will allow very compact representation of multiple CHO configurations to be sequentially applied. The sequence of CHOs resulting from such configurations is herein referred to as a chain of CHOs or a CHO chain. Similarly, such a set of CHO configurations to be sequentially applied is herein referred to as a chain of CHO configurations or a CHO chain configuration or a CHO configuration chain. Furthermore, the one or more gNBs controlling the candidate target cells in a chain of CHO configurations (where each gNB may control one or more of those candidate target cells) may be referred to as a chain of gNBs or a gNB chain (and note that the same gNB may appear multiple times in a gNB chain).

A CHO chain configuration may be structured in different ways to leverage the above-mentioned commonality, e.g., using nested configurations or a list of configurations, where omitted information in a configuration implies that the corresponding information from the preceding nest-level or list position is reused, or that the corresponding information is reused from the configuration in the source/serving cell where the CHO chain configuration is provided. For instance, omitted information at the first, or highest-level CHO configuration, in the chain implies that the corresponding information is reused from the configuration in the source/serving cell where the CHO configuration chain is provided, while omitted information in subsequent CHO configurations in the chain implies that the corresponding information from the preceding CHO configuration in the chain is reused. Note that a certain piece of information, e.g., a certain IE may be omitted in multiple consecutive CHO configurations in a CHO configuration chain, implying that the same information is reused in all those CHO configurations, where the “source” of the reused information is a preceding CHO configuration in the chain where the information is given explicit value(s), or, if no such preceding CHO configuration exists, the reused information is the corresponding information (e.g. IE value(s)) from the configuration in the cell where the CHO configuration chain is/was provided to the UE.

Different options/embodiments for realization of these principles in ASN.1 code are provided in section 2.11 of the Detailed Description.

Another useful property of embodiments of the proposed solution (to some extent following from the above-mentioned commonality) is that the above-mentioned commonality allows a gNB providing a UE with a chain of CHO configurations to (possibly with some exceptions) a priori be aware of the cell configurations of the candidate target cells in the multiple CHO configurations. This facilitates elimination of the problematic recursive inter-gNB signaling described in section 2.2 of the Detailed Description.

Furthermore, embodiments of the proposed solution also leverage that cell switches in a quasi-Earth-fixed cell deployment, including cell switches caused by feeder link switches and switches of the satellite serving a certain quasi-Earth-fixed cell area, occur periodically and with a high predictability. This periodicity can be leveraged to determine parameters related to future cell switches and thereby streamline the representation of a CHO chain configuration.

### 2.2 Inter/Intra-gNB Preparation Phase

As previously explained in section 2.1 of the Detailed Description, the recursive inter-gNB signaling can be avoided by leveraging a priori knowledge of the configurations of the candidate target cells in a CHO chain configuration. Instead, the CHO preparation signaling may be performed as separate steps between the involved gNBs, wherein the preparation signaling of each step can be concluded without dependence of the subsequent step(s) of preparation signaling. However, a gNB cannot prepare the next gNB in a gNB chain until it has itself been prepared.

Whenever a UE with a CHO chain configuration has connected in a cell where the next candidate target cell in the CHO chain (i.e. the candidate target cell of the next CHO configuration in the chain of CHO configurations) is controlled by another gNB (i.e. if the next CHO in the CHO chain will be an inter-gNB CHO), the gNB controlling the UE's current cell (i.e. the cell the UE is connected to, e.g. as a result of a CHO execution) may prepare the gNB controlling the next cell for the CHO. That is, if the UE connects in a cell in a new gNB, where this cell is the first of multiple consecutive candidate target cells in a CHO chain configuration controlled by the same gNB, the gNB waits until the UE connects in the last of these consecutive candidate target cells controlled by the gNB until it prepares the next gNB in the gNB chain for the CHO. Optionally, a gNB controlling multiple consecutive candidate target cells in a CHO chain configuration may not wait with the preparation of the next gNB in the gNB chain until the UE connects in the last of the chained candidate target cells the gNB controls. In accordance with this option, whenever a UE is connected in a cell, which is part of a CHO chain configuration, the gNB controlling that cell may prepare the next gNB in the gNB chain for the CHO. As a further option, a gNB in a gNB chain may prepare the next gNB in the gNB chain for the CHO as soon as it receives the CHO chain configuration or as soon as it is itself prepared for a CHO in the CHO chain. With this option, a gNB in a gNB chain may prepare the next gNB even before the UE connects to the preparing gNB.

The preparation of a next gNB may involve transfer of the current UE specific configuration (e.g., established bearers, UE capabilities etc.) of the UE that is subject to the CHO chain configuration. This may include transfer of the CHO chain configuration optionally only the part of the CHO chain configuration for which the CHOs have not yet been executed), or, optionally, the identities of the candidate target cells in the CHO chain configuration.

Note that even in cases where more than one gNB is involved, a not unlikely case could be that there are only two involved gNBs (a “source gNB” and a “non-source gNB”). In this case, the preparation of all the CHOs with candidate target cells controlled by the non-source gNB may be prepared using a single exchange of a HANDOVER REQUEST XnAP message and a HANDOVER REQUEST ACKNOWLEDGE XnAP message, or a single exchange of a NGAP HANDOVER REQUIRED, NGAP HANDOVER REQUEST message, a NGAP HANDOVER REQUEST ACKNOWLEDGE message and a NGAP HANDOVER COMMAND message (or possibly with a new set of XnAP and/or NGAP messages dedicated to CHO chain preparation signaling). A typical scenario may be a quasi-Earth-fixed deployment where the cell replacements in a quasi-Earth-fixed coverage area may involve toggling between two gNBs, where the cell-serving satellite's position at any given time governs which of these two gNBs that is connected to the satellite and is in control of the cell covering the quasi-Earth-fixed cell area.

The above opens up for a pragmatic way to avoid the problematic recursive inter-node signaling described in section 2.2 of the Detailed Description by restricting the CHO chain configuration to maximum two involved gNBs. In the context of recursive inter-gNB signaling, this restriction has the obvious advantage that there is only one involved inter-gNB signaling interface.

In one variant of this pragmatic restriction, a CHO chain may contain multiple intra-gNB CHOs, but only one inter-gNB CHO.

In yet another (restricted) variant, the CHO chain may be restricted to involve a single gNB, but allowing a chain of intra-gNB CHOs. Considering that a single gNB will typically cover a large geographical area controlling a large number of satellites/cells, a UE may (in some scenarios) perform several intra-gNB handovers before an inter-gNB handover is triggered.

A more generous variant is to restrict the CHO chain to two involved gNBs, but an unlimited number of both intra-gNB CHOs and inter-gNB CHOs. This targets the above-described scenario where the cell replacements in a quasi-Earth-fixed coverage area may involve toggling between two gNBs, and the scenario when the cell switch is caused by a feeder link switch (thereby changing the ground gateway (GW) and the gNB). Given the above typical scenarios, the limitation to two gNBs may not be a severe limitation of the CHO chain configuration concept, provided that the number of inter-gNB CHOs in the chain are not limited.

In yet another (restricted) variant, the number of candidate target cells a UE may handle in the CHO chain configuration (i.e., how many steps the CHO chain may consist of) is based on UE capability. The UE has to signal its support for the CHO chain configuration concept (together with other UE capability signaling) in order for the network to know (1), whether the UE supports the CHO chain configuration concept and (2), the maximum number of candidate target cells (i.e., the length of the CHO chain, i.e. the maximum number of CHO configurations in the CHO chain configuration) the UE may handle in the CHO chain configuration.

In another embodiment, there is no need for CHO chain related inter-gNB signaling, recursive or one at a time as explained above, assuming that preparation at the target gNB is made once the UE triggers the handover procedure as if the UE is performing RRC connection re-establishment to the target cell. This is assuming that the impact on handover performance would be limited since it would take relatively insignificant time to fetch the context from the source gNB when compared to e.g., Round Trip Times (RTTs) in NTN.

There is an important aspect to consider for this embodiment: how the target gNB would know which gNB to request the related UE context from. A simple approach is to send such requests to all neighbor gNBs. This may generate unnecessary signaling but the problem can be mitigated in NTN since it would be relatively easier to “guess” the source cell, given the predictability of the satellite's movement, and thus the source gNB.

Another aspect to consider for this embodiment is the Cell Radio Network Temporary Identifier (C-RNTI) assignment. A solution can be to have a C-RNTI pool for the UE to choose from when triggering HO to the target cell and if it happens that there is a collision with another UE, the gNB uses the contention resolution mechanism to resolve the conflict. The C-RNTI pool can be a common set in the network or a local set which is shared between the neighbor cells, e.g., via the Automatic Neighbor Relation (ANR) mechanism. Please see also the next regarding the discussion on C-RNTI assignment.

### 2.3 Considerations Regarding C-RNTIs

In regular handovers, the target gNB provides the C-RNTI the UE should use in the target cell in the Handover Command. Similarly, in conditional handovers, the candidate target gNB provides the C-RNTI the UE should use in the target cell in the Conditional Handover

### Command.

The C-RNTI is dynamically assigned and, as such, it is problematic to deal with when signaling is to be reused and in particular recursive inter-gNB signaling is to be avoided, and when low-complexity CHO chain configuration is the goal.

A way to address this problem is to let the source/serving gNB (i.e., the gNB providing the CHO chain configuration to the UE) assign the C-RNTIs to be used in the candidate target cells in the CHO configuration. However, letting the source/serving gNB assign C-RNTIs in cells it does not control opens for the risk of C-RNTI collision, if the gNB controlling one of the concerned candidate target cells assigns a C-RNTI to another UE, and the source/serving gNB assigns the same C-RNTI to be used (by a UE subject to a CHO chain configuration) in the same cell. Note that since a new cell taking over the responsibility to serve a certain quasi-Earth-fixed cell area does not exist until it is turned on at the beginning of the period of overlap between the old and the new cell, such C-RNTI collisions may only occur when the gNB controlling the new cell assigns a colliding C-RNTI to a UE (e.g. a UE entering RRC_CONNECTED state) during the overlap period and before the CHO is executed to the new cell by the UE that has been assigned the same colliding C-RNTI by the source/serving gNB. To reduce (in practice eliminate) the risk of such C-RNTI collisions, the C-RNTIs to be included in a CHO chain configuration could be assigned (sequentially) from one end of the C-RNTI range, while C-RNTIs assigned to be used by UEs in the current cell (which do not enter the cell through execution of a CHO in a CHO chain) would (at least during a period of overlap between an old and a new cell) be assigned (sequentially) from the other end of the C-RNTI range. This principle may be specified in a standard or realized through gNB configuration and/or implementation.

An alternative could be that the C-RNTIs to be included in a CHO chain configuration could be selected from a pool of C-RNTIs reserved for this purpose.

Yet another alternative, or complementing, way to address the C-RNTI problem is to leverage that a CHO chain configuration may be transferred between gNBs during the CHO preparation signaling. To this end, a gNB receiving a CHO chain configuration as a part of a UE context during a CHO preparation phase (e.g. in a HANDOVER REQUEST XnAP message), where this CHO chain configuration includes a C-RNTI to be used in a candidate target cell controlled by the gNB (where this candidate target cell may exist or may not yet exist (but will exist when it replaces a preceding cell in a quasi-Earth-fixed cell area)), can ensure not to assign this C-RNTI to any other UE in the concerned cell (unless the CHO is explicitly or implicitly canceled or the UE, after having executed the CHO, disconnects from the cell).

### 2.4 Considerations Regarding Cell Carrier Frequencies

A likely scenario is that the old and the new cell serving a quasi-Earth-fixed cell area use different carrier frequencies to facilitate the (conditional) handovers during the period of coexistence (and overlap) of the old and the new cell. As one possibility, the carrier frequency used in a candidate target cell can be indicated in the CHO configuration for that candidate target cell in a chain of CHO configurations. To ensure that the serving/source gNB (i.e. the gNB providing a UE with a CHO chain configuration) is aware of each candidate target cell's carrier frequency, each gNB may be configured (e.g. at deployment time) with the carrier frequencies of all cells that may cover a certain quasi-Earth-fixed cell area the gNB is responsible for (possibly on time-sharing basis together with one or more other responsible gNBs). An advantageous way of doing this is to let the carrier frequency toggle between two different carrier frequencies for the cells in the sequence of cells replacing each other in serving the concerned quasi-Earth-fixed cell area. That is, if a first cell uses carrier frequency 1, then the second cell would use carrier frequency 2 and the third cell would use carrier frequency 1 and the fourth cell would use carrier frequency 2 and so on. This principle allows simple configuration, since only the two carrier frequencies need to be configured, together with the standardized or indicated toggling rule.

The gNBs would thus be configured with information about this toggling between two carrier frequencies and would thus be able to determine which carrier frequency each candidate target cell in a CHO chain configuration will use.

A UE could also be configured (e.g., by a new field in the RRCReconfiguration message) or implemented to know that the sequence of cells will toggle between two carrier frequencies and all further information it would need from the network would be the two carrier frequencies. Since the UE inherently knows the carrier frequency of its current cell, and that the sequence of cells will toggle between the two carrier frequencies, the CHO chain configuration would only have to indicate the carrier frequency of the next cell (i.e. the candidate target cell of the first CHO configuration in the CHO chain configuration, to enable the UE to know the carrier frequency of every subsequent candidate target cell in the CHO chain configuration. This way, the need for providing the carrier frequency in each CHO configuration in a chain of CHO configurations would be eliminated.

The toggling between two carrier frequencies may be generalized to cycling through a set of two or more carrier frequencies, where two carrier frequencies would be a special case where the cycling becomes toggling.

### 2.5 Considerations Regarding PRACH Configuration

If two neighbor cells in a terrestrial network use the same carrier frequency and have the same PRACH configuration, this may result in undesirable collisions when UEs simultaneously transmit random access preambles in both cells. A scenario where an old and a new quasi-Earth-fixed NTN cell use the same carrier frequency and have the same PRACH configuration, this could seem like an extreme case since the two cells are not only neighbor cells, but rather fully overlap each other. However, since the UEs will use different TAs in the old and the new quasi-Earth-fixed NTN cell, PRACH collisions are not likely to be a significant problem. Still collisions may occur, because the TAs the UEs use gradually change as the satellite(s) move(s) and at some occasion, random access preamble transmissions may coincide in the old and the new cell.

This is a corner case, which may not hamper performance enough to motivate a countermeasure, but nevertheless, a possible way to mitigate the potential issue could be to let two different PRACH configurations (e.g. with different time-frequency allocations for the PRACH resources) be used in a sequence of cells sequentially assuming the responsibility to cover a certain quasi-Earth-fixed cell area, where every second cell use one of the PRACH configurations and every second cell use the other PRACH configuration. This could be generalized into a set of PRACH configurations which are cycled through as quasi-Earth-fixed cells sequentially takes over the role as the cell covering a certain quasi-Earth-fixed cell area. In addition to changing the PRACH time-frequency resources between consecutive sequential cells, consecutive sequential cells could use different, non-overlapping random access preamble ranges.

If the UE knows from standard specification (or from configuration) that it is supposed to cycle through two or more PRACH configurations, it would suffice to list these PRACH configurations once in a CHO chain configuration, and the UE would then know which

PRACH configuration to apply for each of the CHO configurations in the CHO chain configuration. Note that the PRACH configuration that is used in the cell where the UE receives the CHO chain configuration would not have to be indicated in the CHO chain configuration, since the UE inherently knows this PRACH configuration. The list of PRACH configurations could be optional in the CHO chain configuration, and if it is not present, this could indicate that the same PRACH configuration as in the UE's current cell is used in all candidate target cells in the CHO chain configuration.

### 2.6 Considerations Regarding CHO Execution Conditions and Measurement Objects

A CHO chain configuration is assumed to consist of time-based CHO configurations. The execution condition of a time-based CHO configuration consists of two events/conditions (or CondEvents), where one of the events is a condEventT1 (i.e., the time window) and the other is a condEventA3, a condEventA4 or a condEventA5. The CondEvents refer to a measurement object (MeasObjectNR). Due to the expected commonality of the cells sequentially covering a certain quasi-Earth-fixed cell area, the information in the MeasObjectNR can be made the same for all CHO configurations in a CHO configuration chain. Also the signaling strength/quality thresholds and hysteresis values defined in the CondEvents condEventA3, condEventA4 and condEventA5 (one of them configured together with condEventT1) are expected to be the same for all the candidate target cells in a CHO configuration chain.

However, as described in section 2.4 of the Detailed Description, it may be a better deployment option to let the carrier frequency change during cell switches (because of the geographical overlap). The carrier frequency may thus be an exception to the commonality of the MeasObjectNR information in the CHO configurations. This exception is preferably handled as described in section 2.4 of the Detailed Description, meaning that the carrier frequency can be “broken out” from the MeasObjectNR and indicated as information common to the whole CHO configuration chain. The common carrier frequency information may be, as described in section 2.4 of the Detailed Description, a set of two or more carrier frequencies which are cycled through (and if the set consists of only two carrier frequencies, the cycling becomes toggling between the two carrier frequencies).

The MeasObjectNR also contains cell identity information. In the special case of CHO configurations for quasi-Earth-fixed cell switches, this cell identity information can be very limited, preferably narrowed down to only the physical cell identity (PCI) of the candidate target cell (i.e., the new cell in the cell switch). As will be described in section 2.11 of the Detailed Description, if the carrier frequency changes when a new cell takes over the responsibility of covering a certain quasi-Earth-fixed cell area, the same PCI may be reused for all cells sequentially covering the area, and thus for the candidate target cells of all CHO configurations in a CHO chain configuration. The PCI information may thus be common in the MeasObjectNR for all CHO configurations in a CHO chain configuration, and even omitted, since the UE can know that the candidate target cell of every CHO configuration in a CHO chain configuration will have the same PCI as the source cell. As a less preferred option, the PCI information may be handled as described above for the carrier frequency, i.e. it may be “broken out” from the MeasObjectNR and indicated as information common to the whole CHO configuration chain, e.g. if more than one PCI is used, e.g. a set of two or more PCIs being cycled through.

With the carrier frequency and cell identity information omitted in the MeasObjectNR, the same MeasObjectNR may be (re) used for the CHO execution condition in all the CHO configurations in a CHO chain configuration.

It should be pointed out that both the carrier frequency and the cell identity information are optional in a MeasObjectNR, so omitting them in the MeasObjectNR would not require any changes in the specification of the MeasObjectNR IE.

### 2.7 Update/Modification of a CHO Chain Configuration

When the UE has executed a CHO in the chain of CHOs, it removes the executed CHO configuration from the CHO chain configuration, or, alternatively, keeps the executed CHO configuration in the CHO chain configuration, but regards it as invalid.

Furthermore, the UE may consider its CHO chain configuration invalid when the UE fails to complete the CHO execution to a candidate target cell within the CHO chain configuration, i.e., one of the steps in the CHO chain fails. Similarly, the UE may discard its CHO chain configuration if it completes the handover procedure to a cell which is not included as a candidate target cell the CHO chain configuration.

Optionally, if the UE fails to complete the CHO execution to a candidate target cell within the CHO chain configuration, the UE may use the CHO configuration during a potential RRC re-establishment procedure if the UE happens to select one of the candidate target cells within the CHO chain configuration and the associated time window (configured with the t1-Threshold-r17 and duration-r17 fields) has not expired. Another prerequisite is that the network allows the UE to perform conditional reconfiguration to a candidate target cell by including the attemptCondReconfig field in the ConditionalReconfiguration IE in the time-based CHO configuration.

Optionally (in some embodiments), information may be changed, or information may be added to the CHO chain configuration in any cell (controlled by any gNB) the UE connects in in accordance with the configured CHOs. For instance, the gNB serving the cell may extend the CHO chain configuration with one or more further CHO configuration(s), e.g. making the CHO chain configuration a dynamic configuration that is pruned at its start and prolonged at its end. As a further option, the gNB serving a cell the UE connects in while executing a CHO in the CHO chain may add, delete, or modify information in the already existing CHO configurations in the CHO chain configuration, e.g. by providing delta-configurations.

Another principle for updating a CHO chain configuration is to let the UE execute all the CHOs in the CHO chain configuration and then the UE's current gNB provides the UE with a new CHO chain configuration, e.g. in the cell the UE connects in as a result of executing the last CHO in the CHO chain.

In addition, a gNB may at any time instruct a UE (e.g., using a reconfiguration message, such as an RRCReconfiguration message) to discard a previously configured CHO chain configuration. This may be suitable e.g. if the CHO chain (or the part of the CHO chain that remains to be executed) becomes obsolete, or otherwise suboptimal, e.g. if the UE is handed over to a cell that is not included in the CHO chain configuration or if the UE is handed over to a cell in the terrestrial network.

Optionally, a UE will always discard its CHO chain configuration at reception of an RRCReconfiguration message containing the reconfigurationWithSync field, i.e., when the source gNB requests the UE to perform a handover to any target cell and the RRCReconfiguration message is not sent in purpose to modify the previously configured CHO chain configuration.

In addition, the UE will discard its CHO chain configuration when the RRC connection is released or suspended upon reception of an RRCRelease message, and the UE is switched to RRC_IDLE or to RRC_INACTIVE state.

### 2.8 Considerations Regarding Ephemeris and Common TA Information (and Kmac)

When a cell switch occurs in a quasi-Earth-fixed cell deployment, the satellite and/or the feeder link is changed (see section 2.9 of the Detailed Description for more discussion on feeder link switches), and this means that the UEs in the cell being replaced must acquire new valid ephemeris data and/or Common TA parameters (and Kmac). A pragmatic way to handle provision of valid/up to date ephemeris and Common TA parameters (and Kmac) in conjunction with CHO chains is to let a UE with a CHO chain configuration acquire valid ephemeris data and/or Common TA parameters (and Kmac) from SIB19 in the candidate target cell when the CHO execution is triggered (or before the CHO execution is triggered) for the candidate target cell. As an example, the start of the time window (indicated by the t1-Threshold-r17 field) could serve as a trigger for the UE to acquire SIB19 and the ephemeris data and Common TA parameters in the candidate target cell.

As an alternative, the UE may acquire SIB19 and the ephemeris data and Common TA parameters for the candidate target cell in the serving cell just before or in the beginning of the associated CHO execution time window. The source gNB could then ensure that valid (i.e., up to date) ephemeris data and Common TA parameters are provided in SIB19 for the candidate target cell just before and during the associated CHO execution time window.

As yet another alternative, valid (i.e., up to date) ephemeris data and Common TA parameters may be sent to each UE in a dedicated message in association with the CHO execution time window for the candidate target cell.

Note that if the ephemeris data and Common TA parameters were to be provided in the CHO configurations in the CHO chain configuration, they would anyway—at least for most of the CHOs (e.g., all except the possibly the first CHO)—be outdated and invalid by the time the CHO is executed.

As an alternative, in order to reduce service interruption, the network can provide ephemeris data and Common TA parameters which are valid and accurate at the time when the UE is expected to perform its conditional handover, i.e., during the CHO execution time window provided in the CHO configuration (i.e. between the configured T1 and T2). In an example, for each CHO configuration in the CHO configuration chain, separate ephemeris and Common TA parameters are provided with an epoch time in the future and a validity that matches the CHO execution time window configured in the CHO configuration.

### 2.9 Incorporating Feeder Link Switches

During the time interval when a NGSO satellite serves a quasi-Earth-fixed cell area, it will traverse a significant distance in its orbit, and as a consequence, the satellite may undergo a feeder link switch, or maybe multiple feeder link switches while serving the quasi-Earth-fixed cell area, thereby changing the ground gateway (GW) it is connected to/via. A feeder link switch changes the UE-gNB propagation delay and will require that the UE re-synchronizes with the network. This can be handled in the same way as the satellite switches, i.e. with a time-based CHO. This is facilitated if the satellite keeps both the old and the new feeder link active for an overlap period (i.e., the old feeder link is not released until the new feeder link has been active for a short time period), allowing the connected UEs to execute the CHO with minimal service interruption.

In a typical quasi-Earth-fixed cells deployment, any feeder link switch occurring during the time period when a satellite serves a certain quasi-Earth-fixed cell area, will be triggered at the same (or roughly the same) point in the orbit for each satellite (sequentially) serving the same quasi-Earth-fixed cell area. Differently expressed (or as a consequence thereof), any such feeder link switch will occur at a certain time after the satellite starts to serve the quasi-Earth-fixed cell area and/or at a certain time before the satellite stops serving the quasi-Earth-fixed cell area, and this time interval will be the same for each satellite (sequentially) serving the same quasi-Earth-fixed cell area. Another way to express this is that a certain feeder link switch—i.e. a switch between two certain GWs—will occur at a point in time representing a certain fraction of the time period during which the satellite serves the quasi-Earth-fixed cell area, and this fraction will be the same for the feeder link switch between these two GWs for all satellites (sequentially) serving the quasi-Earth-fixed cell area.

The above-described regularity of the feeder link switches means that feeder link switches between two certain GWs involving satellites serving a certain quasi-Earth-fixed cell area will occur with the same periodicity as the satellite switches (i.e., the periodicity with which the satellites serving the quasi-Earth-fixed cell area switch).

This can be leveraged in the provision of a CHO chain configuration to a UE. For instance, a single periodicity with a known starting point can be provided to the UE, complemented by phase or offset indications for each feeder link and satellite switch event (or their corresponding cell switch events), where such an event may be defined e.g. by the start of the cell coexistence/overlap period or by the end of the cell coexistence/overlap period. Here, the phase or offset indication is meant to indicate a fraction of a period of the periodicity. For instance, if an event occurs in the middle of a period, its associated phase indication will indicate the fraction 0.5, while an offset indication would indicate half a duration of a period. Other ways of expressing this fraction are also conceivable, e.g. in terms of degrees or radians (where a full period would represent 360 degrees or 2π radians). The starting point of the periodicity may, e.g., be the end of the service time of the present satellite, represented by the t-Service-r17 IE associated with the cell disappearing as a result of the satellite switch (which is included in SIB19 which is broadcast in the cell). If this choice of starting point (or another starting point which has a known relation to the end of the service time of the present satellite) is specified, the phase indication for the satellite switches may be omitted (because the periodicity and the starting point are sufficient to unambiguously define when the satellite switches will occur. Other examples of starting points of the periodicity, or of a period, include, e.g., the point in time when a satellite starts serving the quasi-Earth-fixed cell area which is equivalent to the point in time when a cell covering the quasi-Earth-fixed cell area appears. The starting point may be either specified in a standard or configured. If configured, it may be configured either in the system information or in each CHO chain configuration. Alternatively, an optional starting point configuration in the CHO chain configuration may override a specified starting point or a starting point provided in the system information. FIG. 8 illustrates an example timeline with satellite switches and feeder link switches (with the disappearance of a cell as a result of a satellite switch (at the time indicated by t-Service-r17) chosen as the starting point of each period in the periodicity).

With the periodicity and the phase/offset indications included in a CHO chain configuration, the CHO chain configuration will be able to configure time-based CHOs for each sequential cell switch, whether it is caused by a feeder link switch (with unchanged satellite) or a satellite switch (where a satellite switch in principle can be seen as including a feeder link switch since at least one endpoint of the feeder link, i.e. the satellite, changes). Note that only one parameter would be needed for the periodicity, which would apply for the entire CHO chain. In addition, the CHO chain configuration would contain one phase or offset indication for each cell switch event that occurs during a single period of the periodicity. That is, since the cell switches repeat consistently for every period, parameters describing a single period suffice to describe all periods covered by the CHO chain.

2.10 Considerations regarding T1 (t1-Threshold-r17) and t-Service (t-Service-r17)

The t1-Threshold-r17 IE (which represents T1 in the [T1, T2] time window) in a time-based CHO configuration is defined as an INTEGER representing a UTC timestamp. More specifically, the t1-Threshold-r17 IE is defined as an INTEGER with the range 0 to 549755813887 and its field description in 3GPP TS 38.331 version 17.2.0 is: “The field counts the number of UTC seconds in 10 ms units since 00:00:00 on Gregorian calendar date 1 Jan. 1900 (midnight between Sunday, Dec. 31, 1899 and Monday, Jan. 1, 1900).” As such, it will by definition be different for each CHO configuration in a CHO configuration chain configuring sequential CHOs. Having to explicitly define a UTC timestamp in each CHO configuration in a CHO configuration chain counteracts the ambition to keep the CHO configuration chain as compact as possible.

This may be combatted by leveraging the regular periodicity of satellite switches and feeder link switches, and thus the corresponding cell switches, similar to what is described in section 2.9 of the Detailed Description. To this end, T1 may be defined to occur at the same point within a period for each CHO in a CHO chain. Assuming that a starting point of each period in the periodicity is either specified or configured (see section 2.9 of the Detailed Description), the points in time where the multiple T1: s (i.e. starting points of time windows in time-based CHO configurations) occur in a CHO chain may be defined by the periodicity (and its starting point) combined with an offset representing the time difference between a T1 in a period and the starting point of the period. Optionally, the offset may be omitted, if an explicit UTC (e.g., a t1-Threshold-r17 IE) is configured in the first CHO configuration in the CHO chain configuration, in which case the UTCs of the subsequent T1: s in the CHO chain can be calculated using the periodicity. The start of a period in the periodicity may, e.g., be chosen to be the appearance of a new cell or the disappearance of a cell as a result of a satellite switch.

Note that the above describes how T1 of a single CHO within a period may be defined. If a period contains multiple CHOs, motivated by multiple cell switch events within the period (e.g., a feeder link switch and a satellite switch within a period), then each of these multiple cell switches will be repetitive with the same periodicity, and the T1 of each of these multiple CHOs will have its own offset. Hence, if there are N CHOs per period, the T1: s of the CHO configurations in a CHO chain configuration, e.g. covering multiple periods, these T1: s may be fully defined by the periodicity (and its starting point) combined with N offsets (i.e. one offset for each CHO in a period, where each offset e.g. represents the time difference between a T1 in a period and the starting point of the period).

The notion of multiple CHOs per period, each with its own offset, implies that even though all satellite switches and feeder link switches repeat with the same periodicity, the existence of multiple CHOs within a period will typically result in that the time interval between two consecutive CHOs varies between a number of time intervals equal to the number of CHOs per period. For instance, if there are two CHOs within a period, the inter-CHO time interval will toggle between two time intervals, and if there are three CHOs within a period, the inter-CHO time interval will cycle through three time intervals (e.g., interval1, interval2, interval3, interval1, interval2, interval3, interval1 . . . ).

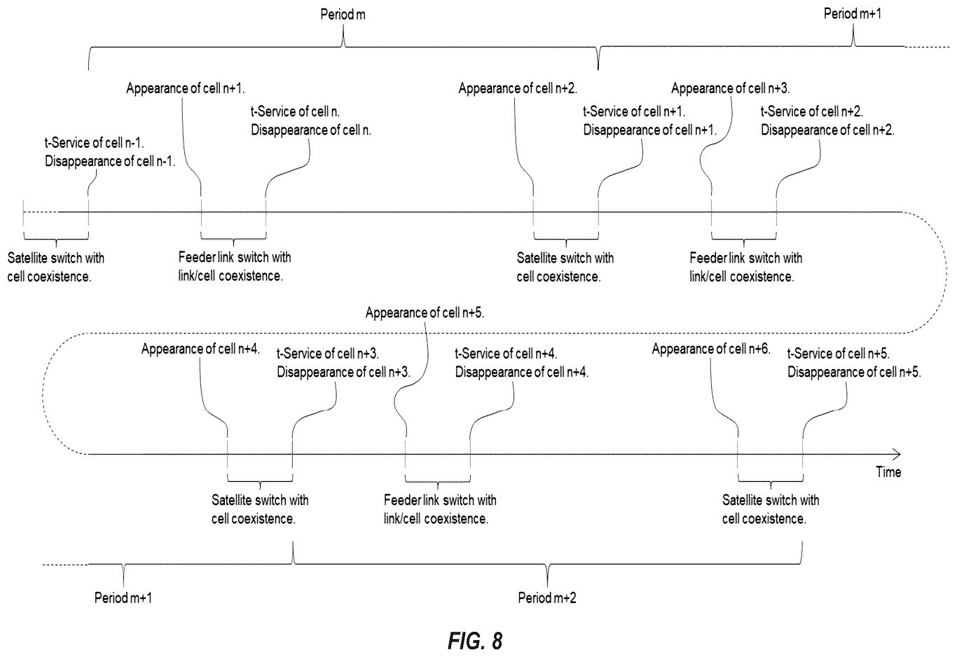

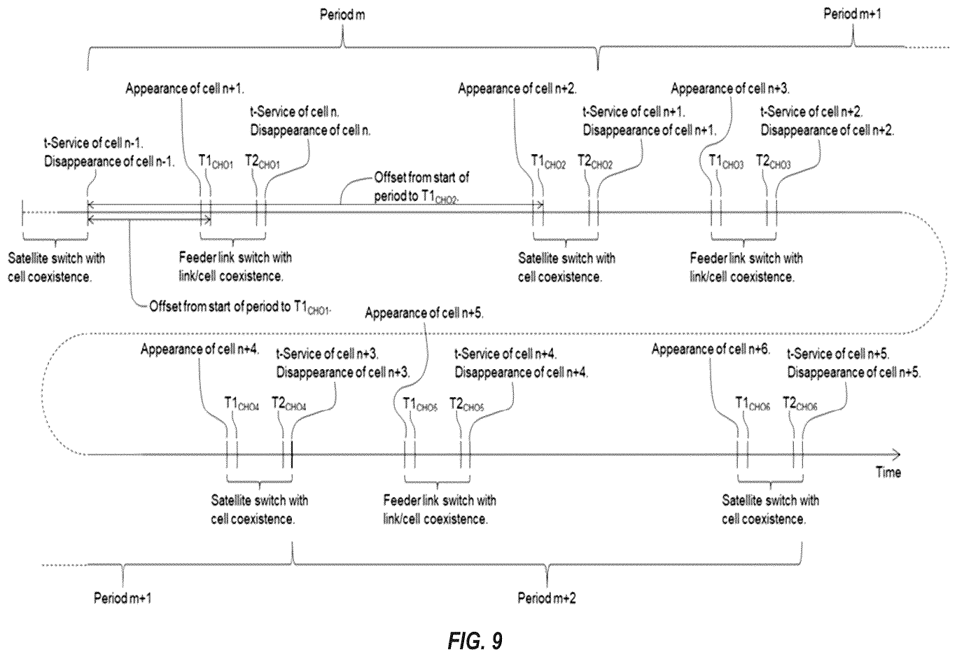

FIG. 9 illustrates an example timeline with satellite switches and feeder link switches, each with an associated time-based CHO time window (with the disappearance of a cell as a result of a satellite switch (at the time indicated by t-Service-r17) chosen as the starting point of each period in the periodicity). The figure is a copy of FIG. 8, augmented with indications of T1 and T2 defining the time windows of time-based CHO configurations.

As an alternative to defining T1 using an offset in relation to the start of a period in a periodicity, T1 may be defined in relation to the t-Service-r17 IE broadcast in SIB19 in the source cell of the CHO chain, e.g. in terms of a time difference or offset to the time as indicated by the t-Service-r17 IE.

Another cell configuration parameter (e.g., in addition to t1-Threshold-r17) which is defined as a UTC timestamp and which hence will be different for each CHO configuration in a CHO configuration chain configuring sequential CHOs is the t-Service-r17 parameter. Similar to t1-Threshold-r17, t-Service-r17 is defined as an INTEGER representing a UTC timestamp. More specifically, the t-Service-r17 IE is defined as an INTEGER with the range 0 to 549755813887 and its field description in 3GPP TS 38.331 version 17.2.0 is:
\Indicates the time information on when a cell provided via NTN quasi-Earth fixed system is going to stop serving the area it is currently covering. The field indicates a time in multiples of 10 ms after 00:00:00 on Gregorian calendar date 1 Jan. 1900 (midnight between Sunday, Dec. 31, 1899 and Monday, Jan. 1, 1900). The exact stop time is between the time indicated by the value of this field minus 1 and the time indicated by the value of this field.

To avoid having to explicitly define a t-Service-r17 UTC timestamp in each CHO configuration in a CHO configuration chain, the same principle of leveraging the periodic property of the cell switches as previously described for T1 may be used for t-Service-r17 too. Hence, to unambiguously define all periodic t-Service-r17 UTC timestamps for all candidate target cells in a CHO chain configuration (e.g., in the Conditional Handover Commands of the candidate target cells) it suffices to provide one t-Service-r17 UTC timestamp (e.g., for the first candidate target cell in the CHO chain configuration) together with the periodicity. Even more compact would be to only provide the periodicity in the CHO chain configuration, leveraging that the cell in which the UE is provided with the CHO chain configuration has a configured t-Service-r17 UTC timestamp, which the UE is inherently aware of and can use as the reference for the periodicity when the UE determines the t-Service-r17 UTC timestamps for the candidate target cells in the CHO chain configuration. Yet another alternative may be to rely on the UE reading t-Service-r17 from SIB19 in every new cell it connects in (which would eliminate the need for any information related to t-Service-r17 in the CHO chain configuration).

### 2.11 Embodiments for Structuring the CHO Chain Configuration Information

### 2.11.1 Type 1 Embodiments: List of (Chained) CHO Configurations

In this embodiment, referred to as embodiment 1a, the CHO chain configuration is represented by a list of CHO configurations. This list is similar to the list of CHO configurations already specified in release 17 of the 3GPP standard in 3GPP TS 38.331 version 17.2.0, i.e., the CondReconfigToAddModList-r16 IE. This list in 3GPP TS 38.331 version 17.2.0 is specified as shown in FIG. 22 in ASN.1 code:

The CHO execution conditions of the CHO configurations in this list (i.e., the condReconfigId-r16 IE of each CondReconfigToAddMod-r16 IE in the CondReconfigToAddModList-r16 IE) are intended to be evaluated in parallel for different candidate target cells, and only one of them may eventually be executed.

A list of CHO configurations constituting a CHO chain configuration would in contrast contain CHO configurations that are intended to be executed sequentially in the order they appear in the list. That is, the UE starts evaluating the execution condition of the (N+1)^{th} CHO configuration in the list only after the CHO configured by the N^{th} CHO configuration has been executed.

A modified version of the CondReconfigToAddModList-r16 IE could be used as the basis, or baseline, for a list of CHO configurations constituting a CHO chain configuration.

When a modified version of the CondReconfigToAddModList-r16 IE is used as the basis, or baseline, for a list of CHO configurations constituting a CHO chain configuration, as in the example above, special consideration is needed for the MeasObjectNR IE(s) linked to the MeasId IE(s) of the condExecutionCond-r16 IE, in particular the ssbFrequency IE and the IEs containing various lists of cells, primarily the cellsToAddModList IE, but also the IEs cellsToAddModListExt-v1710, allowedCellsToAddModList, excludedCellsToAddModList, cellsToRemoveList, allowedCellsToRemoveList, excludedCellsToRemoveList, SSB-PositionQCL-CellsToAddModList-r16 and SSB-PositionQCL-CellsToRemoveList-r16.

If the same carrier frequency is used for all cells sequentially covering a quasi-Earth-fixed cell area, then it would suffice to indicate this single carrier frequency in the MeasObjectNR IE of the first CHO configuration in the CHO chain configuration, while it could be omitted in the MeasObjectNR IE of all the subsequent CHO configurations in the CHO chain configuration. Optionally, depending on the other fields/IEs in the MeasObjectNR IE (see, e.g., below for considerations of the cell lists), the whole MeasObjectNR IE may be omitted in all but the first CHO configuration in the CHO chain configuration. An alternative way of indicating the single carrier frequency may be to include it in a CHO configuration common part of the CHO chain configuration (i.e. a part of the CHO chain configuration that applies in general and/or to all the CHO configurations in the CHO chain configuration), in which case it could be omitted in the MeasObjectNR IE of all the CHO configurations in the CHO chain configuration.

However, using the same carrier frequency for both the old and the new cell during a cell switch in a quasi-Earth-fixed cell area would be problematic from an interference perspective during the time period when the old and the new cell co-exist. More likely is that the new cell taking over the responsibility to cover a certain quasi-Earth-fixed cell area during a cell switch will have a different carrier frequency than the old cell. An attractive deployment option could be to let the cells sequentially covering a certain quasi-Earth-fixed cell area toggle between two carrier frequency, or possibly cycle through a set of possibly more than two carrier frequencies. Two carrier frequencies to be toggled between, or a set of carrier frequencies to be cycled through, may be indicated in a CHO configuration common part of the CHO chain configuration (i.e., a part of the CHO chain configuration that applies in general and/or to all the CHO configurations in the CHO chain configuration). The toggling or cycling rule would preferably be specified in the standard.

In a less attractive deployment scenario, each new cell sequentially taking over the responsibility to cover a certain quasi-Earth-fixed cell area uses a different carrier frequency than the preceding cell, but the carrier frequencies used by sequential cells do not follow any rule, or at least not any easily formulated rule, or at least not any specified rule. In such a scenario, the carrier frequency would have to be explicitly indicated in the MeasObjectNR IE of every CHO configuration in a CHO chain configuration.

Of the above-mentioned cell lists, it is likely that only the information in the cellsToAddModList IE and the cellsToAddModListExt-v1710 IE is needed. Furthermore, since there is only one relevant candidate target cell for each CHO configuration in the CHO chain configuration, each of these lists would have only one entry. These single-entry cell lists may be the only IEs needed in the MeasObjectNR IE for every CHO configuration in the CHO chain configuration, while other IEs would only have to be included in the MeasObjectNR IE of the first CHO configuration in the CHO chain configuration and could be reused, and thus omitted, in the MeasObjectNR IE of the subsequent CHO configurations in the CHO chain configuration. Optionally, only the entire MeasConfigNR IE may be omitted in all but the first CHO configuration in the CHO chain configuration. However, even further optimizations of these lists may be achieved.
One optimization option is to use only two PCIs for a certain quasi-Earth-fixed cell area, letting the PCI toggle for each cell switch. With this optimization, the two PCIs could be indicated in a CHO configuration common part of the CHO chain configuration (i.e., a part of the CHO chain configuration that applies in general and/or to all the CHO configurations in the CHO chain configuration), with the specified rule that the UE should toggle between the two PCIs when determining the candidate target cell PCI for each consecutive CHO configuration in the CHO chain configuration. This would eliminate the need for the cellsToAddModList IE in the MeasObjectNR IE in all the CHO configurations in the CHO chain configuration. A similar optimization may be applied to the cellsToAddModListExt-v1710 IE.
If different carrier frequencies are used in the old and the new cell in a cell switch in a quasi-Earth-fixed cell area (e.g. if carrier frequencies are toggled for each cell switch or more than two carrier frequencies are cycled through in consecutive cell switches), the same PCI may be used for each cell covering the quasi-Earth-fixed cell area (i.e. the same PCI would be used for the single candidate target cell in every CHO configuration in the CHO chain configuration). With this optimization, it could suffice to indicate only a single candidate target cell PCI. This indication could be in the single entry in cellsToAddModList IE in the first CHO configuration in the CHO chain configuration, while it would not be needed in the remaining CHO configurations in the CHO chain configuration. An alternative way to indicate the single PCI could be to indicate it in a CHO configuration common part of the CHO chain configuration (i.e., a part of the CHO chain configuration that applies in general and/or to all the CHO configurations in the CHO chain configuration), which would eliminate the need for the cellsToAddModList IE in the MeasObjectNR IE in all the CHO configurations in the CHO chain configuration. Yet another alternative would be to not indicate the PCI at all in the CHO chain configuration, but instead rely on the UE's inherent knowledge of the PCI in its serving cell. A rule could be specified that a UE with a CHO chain configuration should assume that for all CHO configurations in the CHO chain configuration, the PCI of the candidate target cell is the same as the PCI of the source cell (where the source cell is the UE's current serving cell at the time when the UE evaluates the CHO execution condition for a certain CHO configuration in the CHO chain configuration). One possibility would be to let the PCI indication in the CHO chain configuration (in the CHO configuration common part or in the first of the sequential CHO configurations) be optional, and when omitted, the UE assumes that the PCI of the candidate target is the same as the PCI of the source cell. Similar optimizations may be applied to the cellsToAddModListExt-v1710 IE.

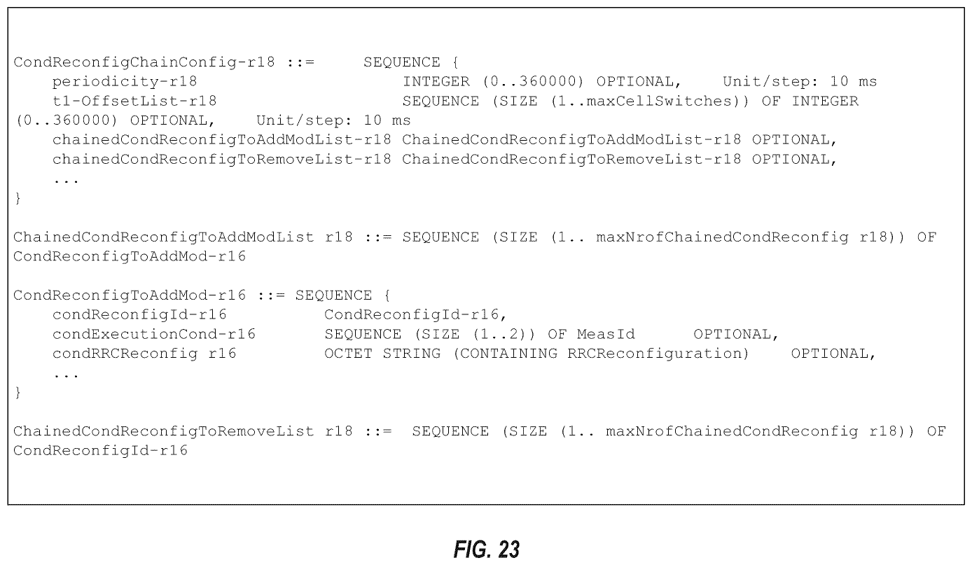

The ASN.1 code of FIG. 23 an example realization of a CHO chain configuration list, using a modified version of the CondReconfigToAddModList-r16 IE as the basis, or baseline, including some of the options described in previous sections. This example CHO chain configuration also includes a CHO configuration common part, i.e. a part of the CHO chain configuration that applies in general and/or to all the CHO configurations in the CHO chain configuration. On the highest level, the example consists of a new IE, denoted as CondReconfigChainConfig-r18, which is to be included in an RRCReconfiguration message.

In the ASN.1 code example of FIG. 23, the periodicity-r18 field and the t1-OffsdetList-r18 field constitute the common part of the CHO chain configuration.

The periodicity-r18 field configures the periodicity of a periodically recurring set of one or more cell switches, assumedly caused by one satellite switch (i.e., service link switch) and zero or more feeder link switches.

The t1-OffsetList-r18 field defines the offsets of the t1-Threshold-r17 fields (i.e., the T1:s) of the CHO configurations associated with the cell switches within one period of the periodicity configured by the periodicity-r18 field, wherein each offset is defined in relation to the start of the period. (The start of a period in the periodicity may e.g., be t-Serivce-r17 of one of the cells in the set of periodic cell switches.)

The reason that the periodicity-r18 and t1-OffsetList-r18 fields are optional in the above ASN.1 code example is that it should be possible to add, modify or remove conditional configurations (e.g., CHO configurations) without providing or changing the periodicity or an offset in the list of offsets. The UE stores the configured chained conditional reconfigurations (e.g., chained CHO configurations), e.g. in a UE variable which, e.g., could be denoted as VarChainedReconfig.

The UE considers the stored chained conditional reconfigurations sequentially. That is, assuming that these chained conditional reconfigurations are CHO configurations, the UE monitors the execution condition and executes the CHO in accordance with one CHO configuration at a time in the list.

The RRCReconfiguration in the OCTET STRING constituting the condRRCReconfig-r16 IE preferably includes a delta configuration, where the reference RRC configuration for the delta-configuration in the first item in the list is the RRC configuration in the source cell of the first CHO configuration, while the reference RRC configuration for each subsequent delta-configuration is the RRCReconfiguration of the preceding list item. Alternatively, the reference RRC configuration for each delta-configuration in the list is the source cell of the CHO configuration of that list item.

To make efficient use of delta-configuration, inclusion of the fullConfig IE in a CHO configuration (e.g. in the RRCReconfiguration in the condRRCReconfig-r16 IE) should be avoided when possible, and care should be used when associating need codes—in particular the “need M” and “need R” codes—to IEs/fields in the CHO configurations (see section 1.2 of the Detailed Description and annex section A.6 in 3GPP TS 38.331 version 17.2.0 for information on need codes).

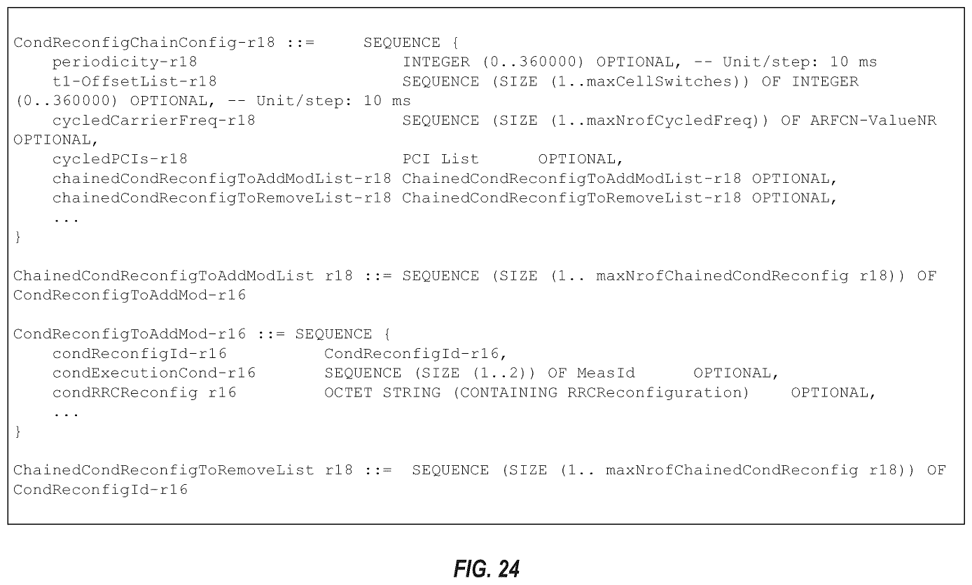

In another ASN.1 code example (embodiment 1b) shown in FIG. 24, the carrier frequency information as well as the PCI information is broken out and put in a common part of the CHO chain configuration, in accordance with the optimization possibilities described above.

In the ASN.1 code example of FIG. 24, the cycledCarrierFreq-r18 field and the cycledPCIs-r18 field are added in the common part of the CHO chain configuration. Both these fields are optional. If the cycledCarrierFreq-r18 field is absent, the UE assumes that the carrier frequency of the source cell is used in the candidate target cell too (and that this applies to all the CHO configurations in the CHO chain configuration). If the cycledPCIs-r18 field is absent, the UE assumes that the PCI of the source cell is used in the candidate target cell too (and that this applies to all the CHO configurations in the CHO chain configuration).

Further variants of embodiment 1a and 1b can be created if the CHO execution condition configuration, i.e. the condExecutionCond-r16 IE, is also broken out to the common part of the CHO chain configuration.

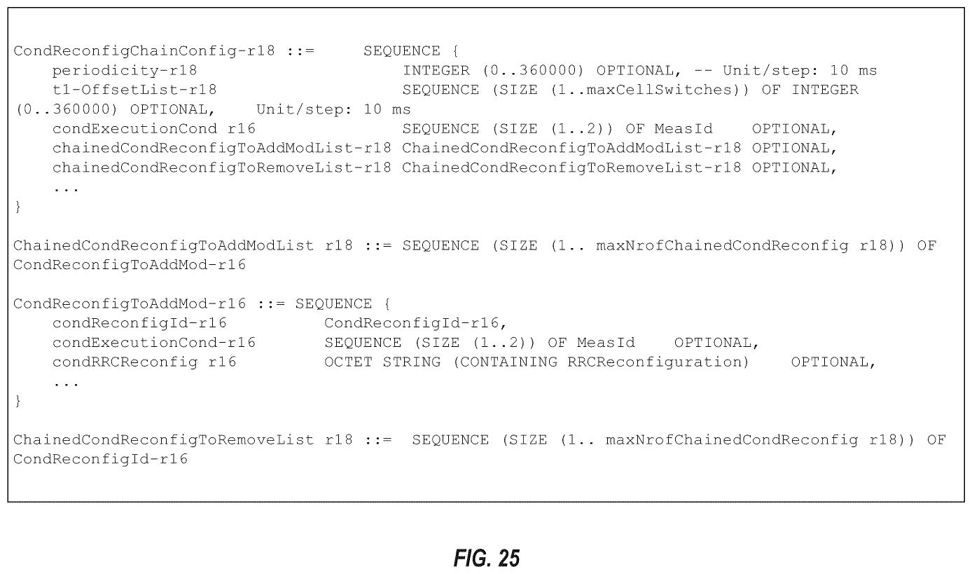

Modifying embodiment 1a in this way results in embodiment 1c, with the example ASN.1 code of FIG. 25. In the above, the optional condExecutionCond-r16 IE in the CondReconfigToAddMod-r16 IE should be omitted.

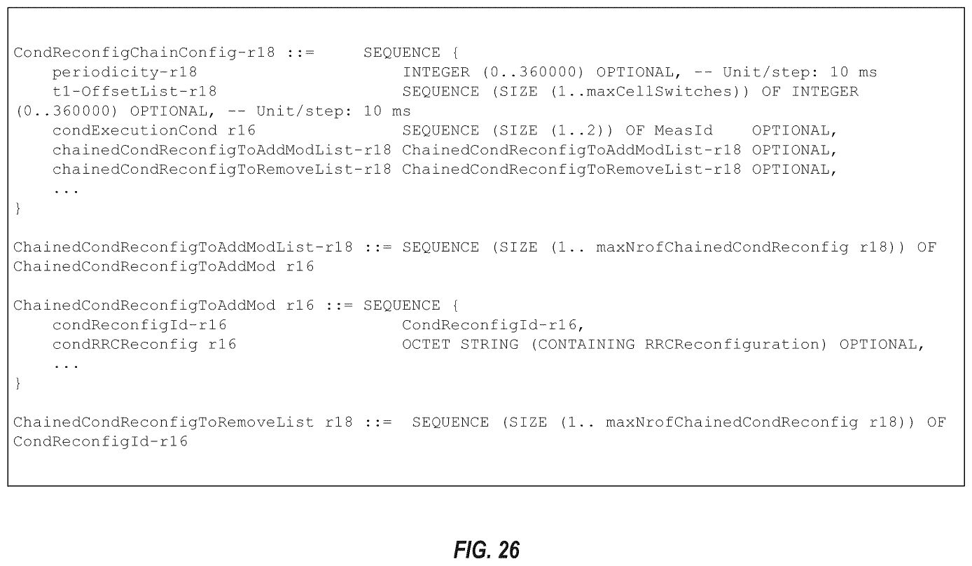

In a slightly different variant, denoted as embodiment 1d, the CondReconfigToAddMod-r16 IE is replaced by a corresponding IE tailored for the CHO chain configuration and where the condExecutionCond-r16 is not included. The example ASN.1 code for embodiment 1d is shown in FIG. 26.

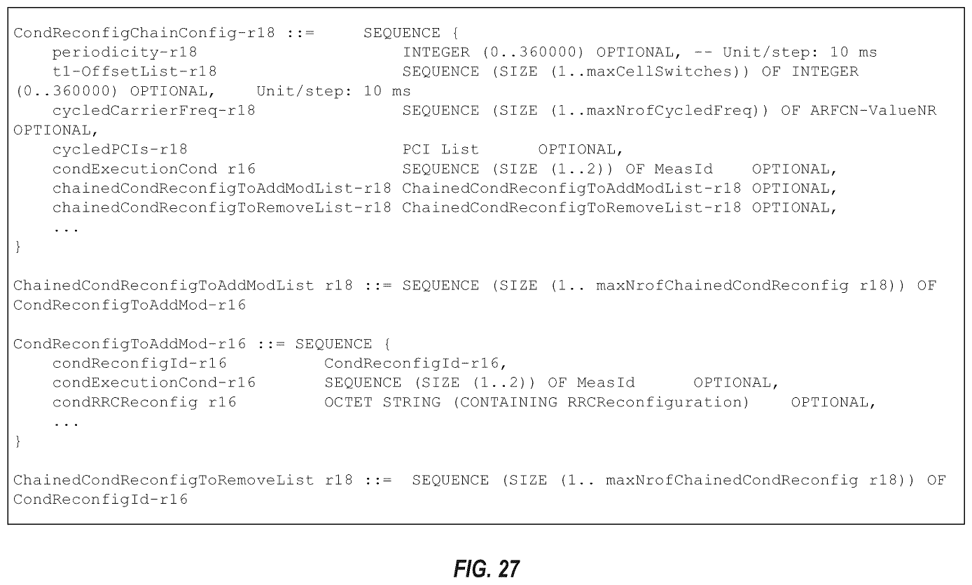

Modifying embodiment 1b by breaking out the condExecutionCond-r16 IE to the common part results in embodiment 1e, with the example ASN.1 code of FIG. 27. In the example of FIG. 27, the optional condExecutionCond-r16 IE in the CondReconfigToAddMod-r16 IE should be omitted.

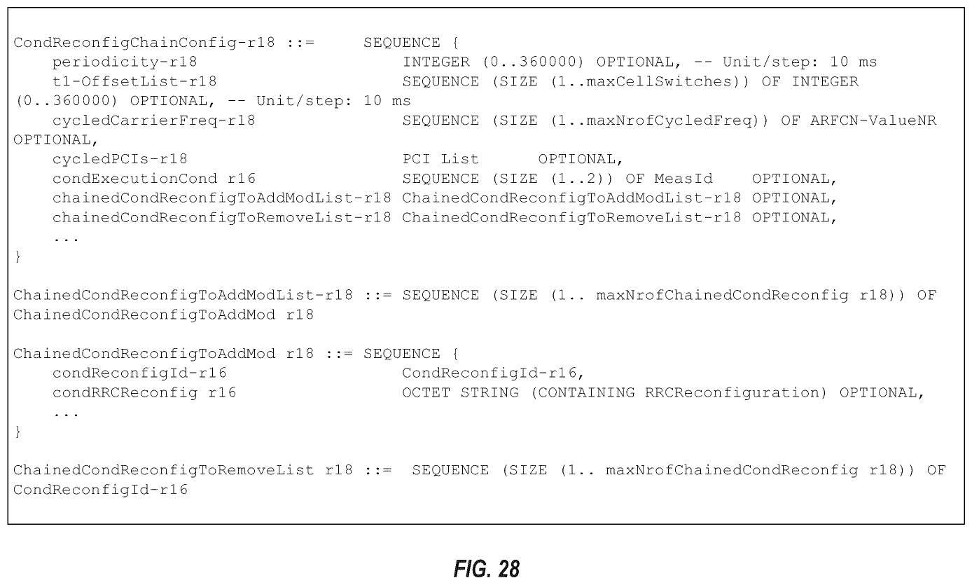

In a slightly different variant, denoted as embodiment 1e, the CondReconfigToAddMod-r16 IE is replaced by a corresponding IE tailored for the CHO chain configuration and where the condExecutionCond-r16 is not included. The example ASN.1 code for embodiment 1e is shown in FIG. 28.

### 2.11.2 Type 2 Embodiments: Recursive (Chained) CHO Configurations

In contrast to the type 1 embodiments described in section 2.11.1 of the Detailed Description, which rely on a list of CHO configurations to create a CHO chain configuration, the type 2 embodiments use recursive (nested) CHO configurations to create a CHO chain configuration.

As recursive CHO configurations are prohibited according to 3GPP TS 38.331 version 17.2.0 (see section 4.2 of the Background), a modification of the current 3GPP standard would be needed if the already specified CHO configuration IEs are to be reused for the recursive configuration. In particular, in an embodiment referred to as embodiment 2a, the field description for the conditionalReconfiguration-r16 field in the RRCReconfiguration message, as specified in 3GPP TS 38.331 version 17.2.0 (see section 4.2 of the Background), may be amended as follows:

conditionalReconfiguration

Configuration of candidate target SpCell(s) and execution condition(s) for conditional handover,
conditional PSCell addition or conditional PSCell change. The field is absent if any DAPS bearer is
configured [symbol] [symbol] or if the sl-L2RemoteUE-
Config or sl-L2RelayUE-Config is configured. For conditional PSCell change, the field is absent if
the secondaryCellGroup includes ReconfigurationWithSync. The RRCReconfiguration message
contained in DLInformationTransferMRDC cannot contain the field conditionalReconfiguration
for conditional PSCell change or for conditional PSCell addition.

However, such a change of the rules for how the ConditionalReconfiguration-r16 IE may be used may create backwards compatibility problems when legacy UEs (i.e., UEs implementing a previous version of the standard) are involved. A way to avoid this potential backwards compatibility problem could be to use recursive CHO configurations to configure a CHO chain only for UEs which support a version of the standard where this possibility has been included. To support such selective usage based on the support in the UE, the support for recursive CHO configurations could be made a UE capability which the UE has to signal support for (together with other UE capability signaling) in order to enable the network to know whether recursive CHO configuration may be used for the UE. A variant of such UE capability support signaling may be to let the UE indicate which version of the standard it implements, and if it indicates support for a standard version that includes the recursive CHO configuration feature, the UE is mandated to support the feature.

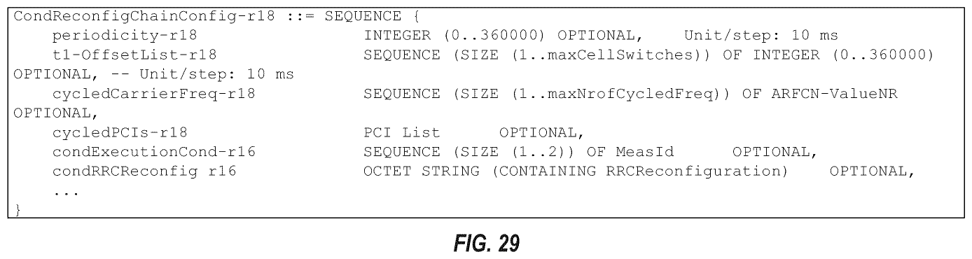

Another way to implement/specify the recursive CHO configuration possibility, without making potentially backwards incompatible changes in old specification text, could be to introduce new IEs for the recursive CHO configuration (i.e., the CHO chain configuration) instead of only reusing existing (legacy) IEs. To this end, in an embodiment referred to as embodiment 2b, a CondReconfigChainConfig-r18 IE could be introduced, to be (optionally) included in an RRCReconfiguration message (irrespective of any presence of a Reconfiguration WithSync IE in the same RRCReconfiguration message). FIG. 29 is an ASN.1 code example.

To make the above example recursive, the RRCReconfiguration contained in the condRRCReconfig-r16 IE should contain a CondReconfigChainConfig-r18 IE. Multiple recursive levels may be configured that way until a condRRCReconfig-r16 IE contains an RRCReconfiguration which does not include a CondReconfigChainConfig-r18 IE. Note that to reduce the amount of signaled data (by reducing redundant information) the fields/IEs periodicity-r18, t1-OffsetList-r18, cycledCarrierFreq-r18 and cycledPCIs-r18 should preferably only be present at the highest level in the recursive hierarchy (and optionally, e.g., the cycledPCIs-r18 field/IE may be omitted if the PCI of the source cell is to be reused in the candidate target cell of each configured CHO). In accordance with what is described in section 2.5 of the Detailed Description, also the condExecutionCond-r16 IE could be omitted at all but the highest recursive level.

In a variation of the above example embodiment (where the variant is referred to as embodiment 2c), the CondReconfigChainConfig-r18 IE is only included at the highest recursive level, i.e. in the RRCReconfiguration message conveying the CHO chain configuration to the UE. At the other recursive levels, only a condRRCReconfig-r16 IE is included in the RRCReconfiguration message, e.g. in the Reconfiguration WithSync IE. This could be realized with the following example ASN.1 code, consisting of an RRCReconfiguration message extended with the CondReconfigChainConfig-r18 IE and a Reconfiguration WithSync IE (which is included in the CellGroupConfig IE contained in the masterCellGroup IE) extended with a condRRCReconfig-r16 IE.

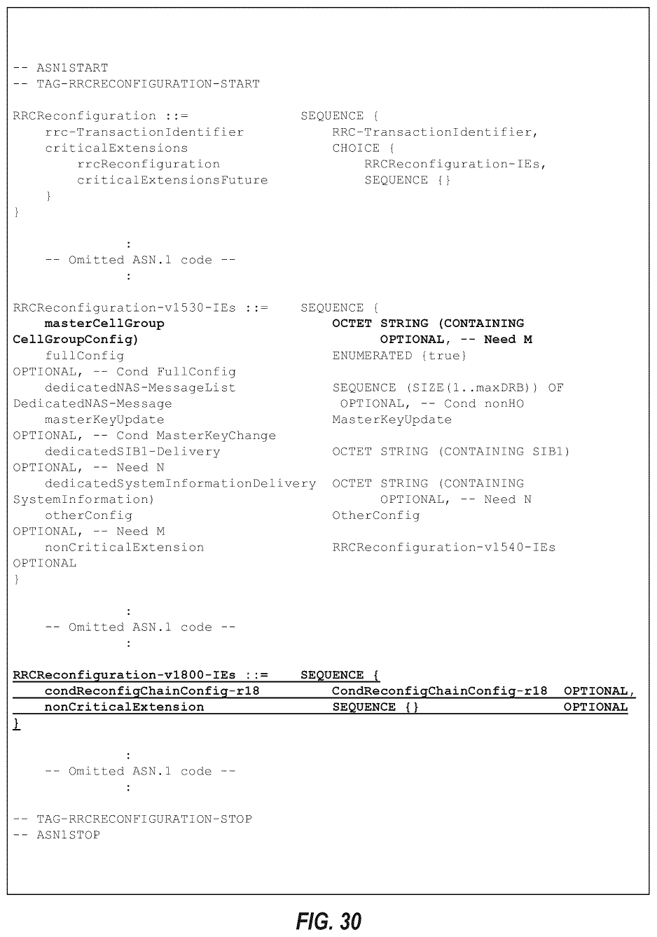

The extended RRCReconfiguration message is as shown in FIG. 30.

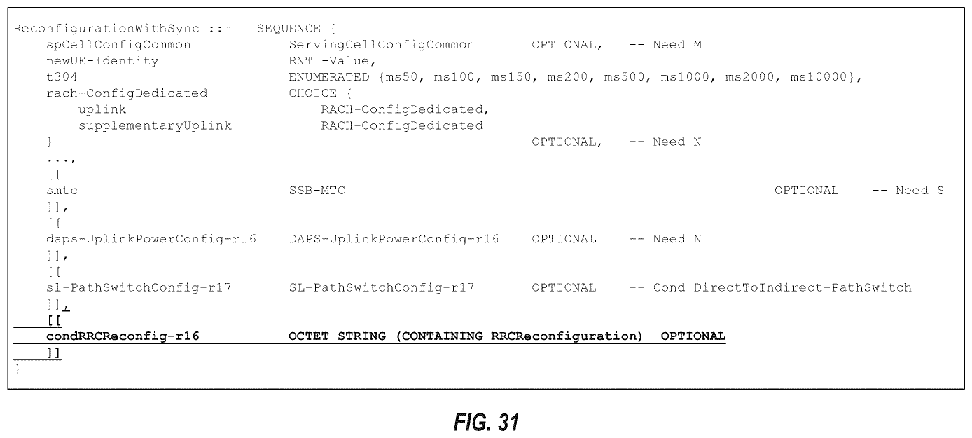

The extended Reconfiguration WithSync IE is shown in FIG. 31.

In the above, the condRRCReconfig-r16 IE would be included in the Reconfiguration WithSync IE only when recursive CHOs are configured to form a CHO chain configuration.

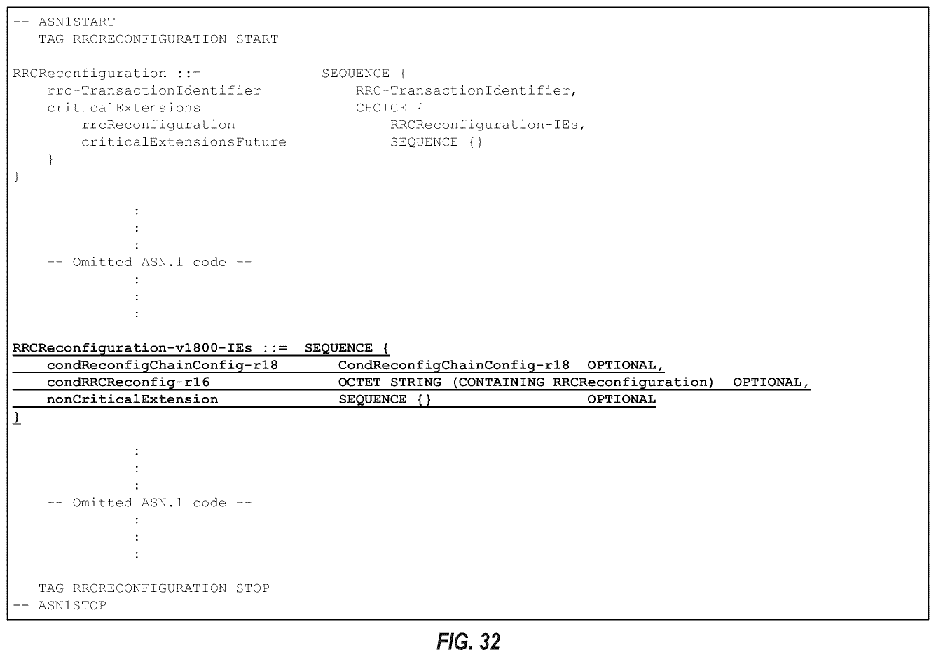

In a similar variant (referred to as embodiment 2d), just like in variant 2c above, the CondReconfigChainConfig-r18 IE is included at the top level in the recursive configuration, while only the condRRCReconfig-r16 IE is included in the RRCReconfiguration on subsequent recursive levels, but in contrast to the variant above, the condRRCReconfig-r16 IE is not included in the ReconfigurationWithSync IE, but in the same IE group as the CondReconfigChainConfig-r18 IE. This is illustrated by the ASN.1 code example of FIG. 32.

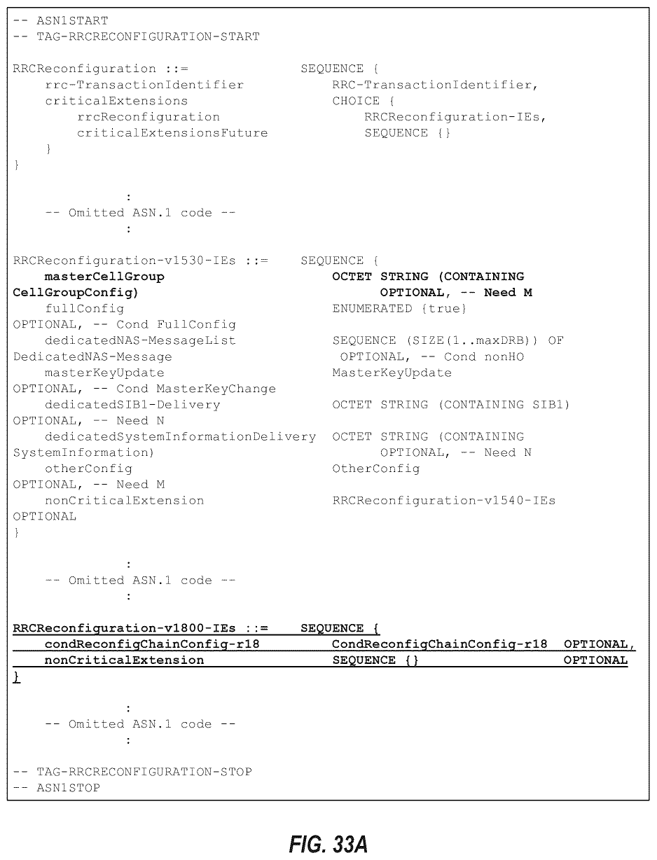

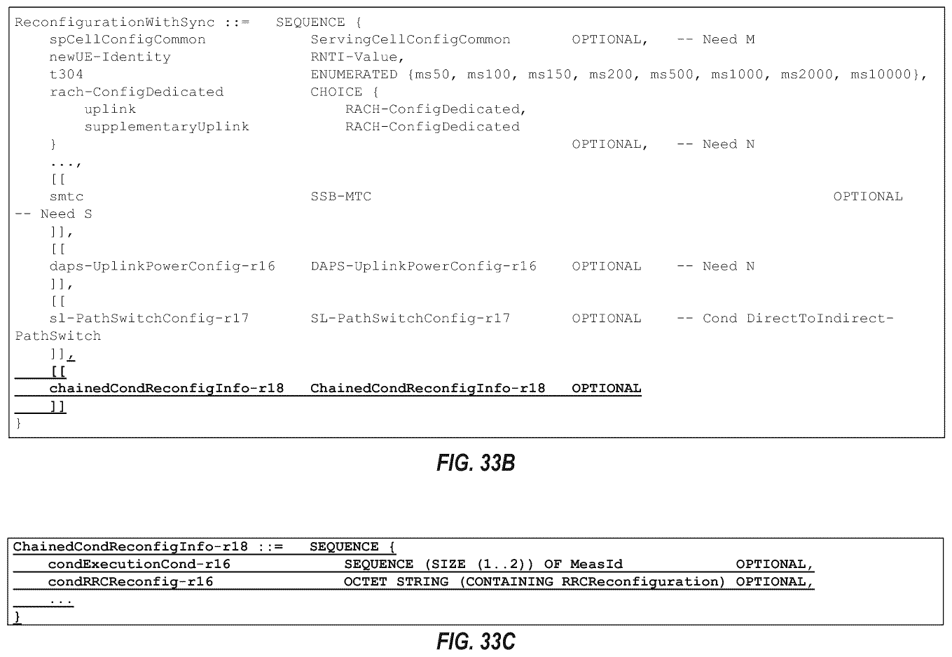

Two further variants reuse the principle of the above two variants where more comprehensive CHO chain configuration information is included at the top recursive level, while leaner information is included on subsequent recursive levels. The difference is that the condRRCReconfig-r16 IE is replaced by an IE that may be seen as a modified version of a CondReconfigToAddMod-r16 IE, which here is denoted as ChainedCondReconfigInfo-r18. ASN.1 code for the first of the two further variants (embodiment 2e) is shown in FIGS. 33A, 33B, and 33C.

The extended RRCReconfiguration message is shown in FIG. 33A.

The extended Reconfiguration WithSync IE is shown in FIG. 33B.

The ChainedCondReconfigInfo-r18 IE is shown in FIG. 33C.

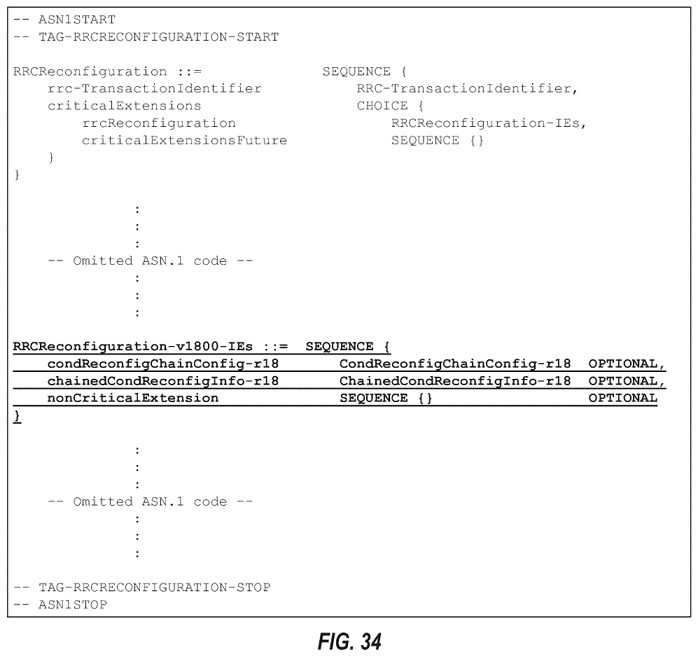

ASN.1 code for the second of the two further variants (embodiment 2f) is shown in FIG. 34.

The ChainedCondReconfigInfo-r18 IE is the same as in variant 2e.

### 2.12 Further Considerations Regarding Earth-Moving Cells

The embodiments of the proposed solution described above target the quasi-Earth-fixed cells scenario, where NTN cells are fixed to a certain geographical location and the satellite leverages beamforming to dynamically steer its beams in the correct direction, i.e., adjusted to the satellite's movements, in order to keep the cell coverage fixed on the Earth surface. In contrast, an Earth-moving cell has a fixed spatial relation to its serving satellite, created by a beam with a fixed direction from the satellite towards the ground, making the cell sweep a certain region at a time as the satellite moves (i.e., the cell moves with the satellite). It is feasible that a network operator managing a deployment of Earth-moving cells may ensure that subsequent cells covering a certain geographical area have as much as possible commonalities within their configuration. This would allow the CHO chain concept to be partially applied.

With the exception of cell switches caused by feeder link switches, the applicability of time-based CHO in Earth-moving cells is rather limited. In contrast to quasi-Earth-fixed cells, there is not a unique stop serving time for all UEs in a cell. The serving time will be a function of the location of a UE within the cell with respect to the projection on ground of the satellite's trajectory. Therefore, CHO in Earth-moving cells may often use location-based event triggers. The only exception would be feeder switch links, where the embodiments already considered in section 2.9 of the Detailed Description would perfectly apply.

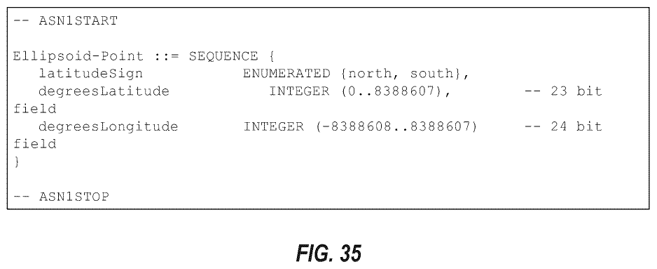

A CHO location-based event trigger (CondEventD1) presently includes the configuration of two distance thresholds: Thresh1, which defines a distance threshold from the serving cell's reference location (referenceLocation1), and Thresh2, which defines a distance threshold from the candidate target cell's reference location (referenceLocation2). The reference location format is the same as the Ellipsoid-Point IE defined in TS 37.355 V17.3.0 with a size of 48 bits; it's ASN.1 structure is presented in FIG. 35.

Regarding message optimization in a CHO chain based on location-based event triggered CHOs, the most straightforward parameters to leverage commonality of are the distance thresholds. A reasonable assumption is that subsequent satellites may have the same coverage radius. Hence, Thresh1 and Thresh2 could be equal, and a single distance threshold value would be required for the whole CHO chain configuration.

Providing the reference location of the candidate target cell of each CHO configuration in a CHO configuration chain may cause a considerable amount of overhead. In an Earth-moving cell, the reference location is clearly not static, and it may be provided to a UE from an original value at a certain epoch time, i.e., a snapshot at a specific point in time. Then, the UE, knowing the satellite's trajectory from ephemeris data, can propagate the original value to its present value (at any given time) using simple arithmetic. A more compact signaling approach, inspired from the principles explained in section 2.10 of the Detailed Description, could be achieved by only transmitting a distance offset between reference locations, assuming that it is likely that subsequent satellites might operate in the same orbital plane in relation to the rotating Earth surface (e.g., a Walker Star constellation). The orbital plane can be inferred from the satellite ephemeris of the serving NTN cell, which is known to the UE being a pre-requisite to establish a connection in the cell. In more general terms, as previously defined in section 2.10 of the Detailed Description, the periodicity of regular satellite switches can be leveraged. Hence, subsequent reference locations (of subsequent candidate target cells in the CHO configuration chain) can be calculated from an offset between an initial reference location (provided in the serving cell that configures the CHO configuration chain) and a constant representing the position of the CHO configuration within the CHO configuration chain. This method assumes that subsequent satellites have similar technological characteristics, i.e., they have similar cell footprint radius. Thus, an uncertainty factor could be also added if this condition does not hold.

### 3 Further Description

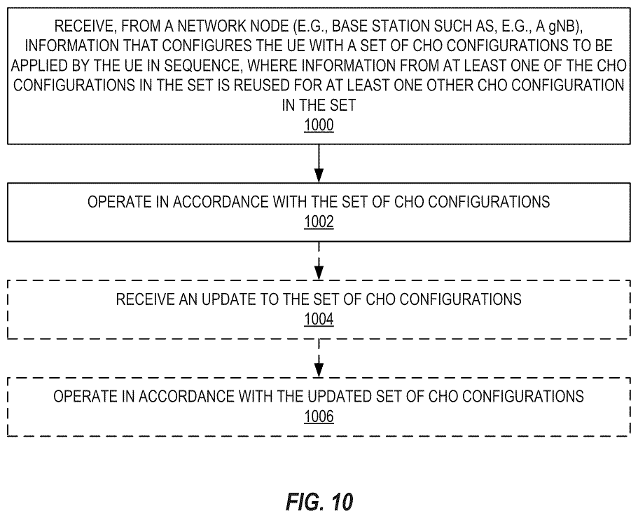

FIG. 10 is a flow chart that illustrates the operation of a User Equipment (UE) in accordance with at least some of the embodiments described above. Optional steps are represented by dashed lines/boxes. As illustrated, the UE receives, from a network node, information that configures the UE with a set of conditional handover configurations (step 1000). The set of conditional handover configurations includes two or more conditional handover configurations. Information from at least one conditional handover configuration from the set of conditional handover configurations is reused for at least one other conditional handover configuration from the set of conditional handover configurations. Note that all of the details described herein regarding the set of CHO configurations or a CHO configuration chain are equally applicable here to step 1000. The UE operates in accordance with the set of conditional handover configuration (step 1002).

In one embodiment, the set of conditional handover configurations is to be applied by the UE in sequence. In one embodiment, omitted information in one of the conditional handover configurations implies that corresponding information from a preceding conditional handover configuration in the sequence is to be reused.

In one embodiment, omitted information in one of the conditional handover configurations implies that corresponding information from one of the conditional handover configurations for a source or serving cell where the set of conditional handover configurations was configured is to be reused.

In one embodiment, for a particular configuration parameter (e.g., t-Service-r17 and/or t1-Threshold-r17), a value for the particular configuration parameter for at least one conditional handover configuration from the set of conditional handover configurations is implied by a value for the particular configuration parameter for another conditional handover configuration from the set of conditional handover configurations and a known (e.g., predefined or configured) periodicity.

In one embodiment, for a particular configuration parameter, a value for the particular configuration parameter for at least one conditional handover configuration from the set of conditional handover configurations is implied by a value for the particular configuration parameter for another conditional handover configuration from the set of conditional handover configurations and a known (e.g., predefined or configured) offset.

In one embodiment, for a particular configuration parameter (e.g., carrier frequency; PRACH configuration), values for the particular configuration parameter for the set of conditional handover configurations is implied by a toggling or stepping through a predefined or configured set of values for the particular configuration.

In one embodiment, the set of conditional handover configurations is restricted to a maximum of two involved network nodes (e.g., maximum of two involved base stations (e.g., gNBs)).

In one embodiment, the set of conditional handover configurations comprises multiple intra-base station (e.g., intra-gNB) conditional handover configurations but only one inter-base station e.g., inter-gNB) conditional handover configurations.

In one embodiment, the set of conditional handover configurations comprises multiple intra-base station (e.g., intra-gNB) conditional handover configurations for a single base station (e.g., single gNB).

In one embodiment, the set of conditional handover configurations is restricted to a maximum of two involved network nodes (e.g., maximum of two involved base stations (e.g., gNBs)) but an unlimited number of intra-base station and inter-base station conditional handover configurations involving the maximum of two involved network nodes.

In one embodiment, a number of candidate target cells that the UE can handle in the set of conditional handover configurations is based on one or more capabilities of the UE.

In one embodiment, C-RNTIs indicated in the set of conditional handover configurations are assigned by the network node.

In one embodiment, C-RNTIs for the set of conditional handover configurations are assigned in such a manner as to mitigate a risk of C-RNTI collisions.

In one embodiment, C-RNTIs for the set of conditional handover configurations are assigned from a reserved pool of C-RNTIs.

In one embodiment, information comprised in a measurement object in one of the conditional handover configurations in the set of conditional handover configurations is reused for all other conditional handover configurations in the set of conditional handover configurations. In one embodiment, carrier frequency information for the set of conditional handover configurations is indicated separately from the measurement object.

In one embodiment, the UE receives an update for the set of conditional handover configurations (step 1004) and operates (1006) in accordance with the updated set of conditional handover configurations.

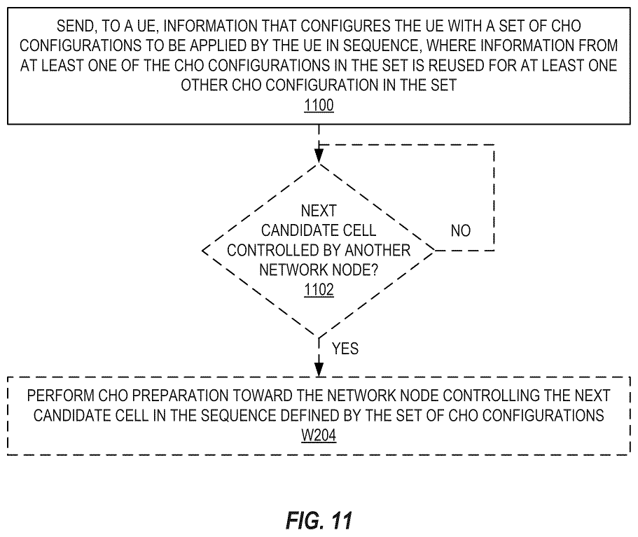

FIG. 11 is a flow chart that illustrates the operation of a network node (e.g., a base station such as, e.g., a gNB) in accordance with at least some of the embodiments described above. Optional steps are represented by dashed lines/boxes. As illustrated, the network node sends, to a UE, information that configures the UE with a set of conditional handover configurations (step 1100). The set of conditional handover configurations includes two or more conditional handover configurations. Information from at least one conditional handover configuration from the set of conditional handover configurations is reused for at least one other conditional handover configuration from the set of conditional handover configurations. Note that all of the details described herein regarding the set of CHO configurations or a CHO configuration chain are equally applicable here to step 1100.

In one embodiment, the network node determines whether a cell for a next CHO configuration in the set or chain of CHO configurations is controlled by another (i.e., a second) network node (step 1102). If not, the network node continues to wait. Otherwise, if the cell for the next CHO configuration in the set or chain of CHO configurations is controlled by another (i.e., a second) network node, the network node performs a HO or CHO preparation procedure towards the other (i.e., the second) network node (step 1104). Note that, in yet another embodiment, step 1102 is not performed, and the network node performs HO or CHO preparation towards the other (i.e., the second) network node possibly before the cell for the next CHO configuration is controlled by the other network node.

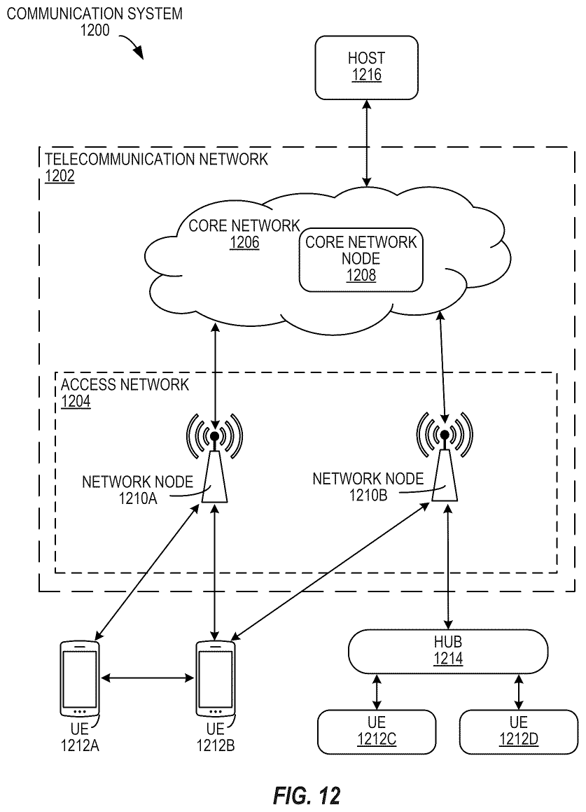

FIG. 12 shows an example of a communication system 1200 in accordance with some embodiments.

In the example, the communication system 1200 includes a telecommunication network 1202 that includes an access network 1204, such as a Radio Access Network (RAN), and a core network 1206, which includes one or more core network nodes 1208. The access network 1204 includes one or more access network nodes, such as network nodes 1210A and 1210B (one or more of which may be generally referred to as network nodes 1210), or any other similar Third Generation Partnership Project (3GPP) access node or non-3GPP Access Point (AP). The network nodes 1210 facilitate direct or indirect connection of User Equipment (UE), such as by connecting UEs 1212A, 1212B, 1212C, and 1212D (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system 1200 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1202 is a cellular network that implements 3GPP standardized features. Accordingly, the telecommunication network 1202 may support network slicing to provide different logical networks to different devices that are connected to the telecommunication network 1202. For example, the telecommunication network 1202 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1214 communicates with the access network 1204 to facilitate indirect communication between one or more UEs (e.g., UE 1212C and/or 1212D) and network nodes (e.g., network node 1210B). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a Virtual Reality (VR) headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210B. The hub 1214 may also allow for a different communication scheme and/or schedule between the hub 1214 and UEs (e.g., UE 1212C and/or 1212D), and between the hub 1214 and the core network 1206. In other examples, the hub 1214 is connected to the core network 1206 and/or one or more UEs via a wired connection. Moreover, the hub 1214 may be configured to connect to a Machine-to-Machine (M2M) service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210B. In other embodiments, the hub 1214 may be a non-dedicated hub—that is, a device which is capable of operating to route communications between the UEs and the network node 1210B, but which is additionally capable of operating as a communication start and/or end point for certain data channels.

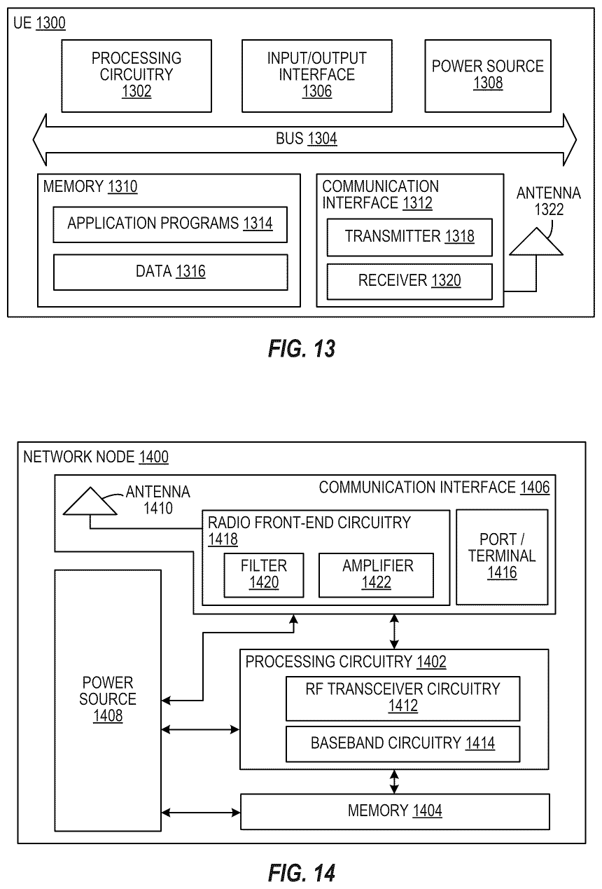

FIG. 13 shows a UE 1300 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1302 may include multiple Central Processing Units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging the power source 1308. Power circuitry may perform any formatting, converting, or other modification to the power from the power source 1308 to make the power suitable for the respective components of the UE 1300 to which power is supplied.

The memory 1310 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1310 may allow the UE 1300 to access instructions, application programs, and the like stored on transitory or non-transitory memory media, to off-load data, or to upload data. An article of manufacture, such as one utilizing a communication system, may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., the antenna 1322) and may share circuit components, software, or firmware, or alternatively be implemented separately.

In the illustrated embodiment, communication functions of the communication interface 1312 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1312, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 14 shows a network node 1400 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes processing circuitry 1402, memory 1404, a communication interface 1406, and a power source 1408. The network node 1400 may be composed of multiple physically separate components (e.g., a Node B component and an RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1400 may be configured to support multiple RATs. In such embodiments, some components may be duplicated (e.g., separate memory 1404 for different RATs) and some components may be reused (e.g., an antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1400.

The processing circuitry 1402 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1400 components, such as the memory 1404, to provide network node 1400 functionality.

In some embodiments, the processing circuitry 1402 includes a System on a Chip (SOC). In some embodiments, the processing circuitry 1402 includes one or more of Radio Frequency (RF) transceiver circuitry 1412 and baseband processing circuitry 1414. In some embodiments, the RF transceiver circuitry 1412 and the baseband processing circuitry 1414 may be on separate chips (or sets of chips), boards, or units, such as radio units and digital units. In alternative embodiments, part or all of the RF transceiver circuitry 1412 and the baseband processing circuitry 1414 may be on the same chip or set of chips, boards, or units.

The memory 1404 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and the memory 1404 are integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. The radio front-end circuitry 1418 comprises filters 1420 and amplifiers 1422. The radio front-end circuitry 1418 may be connected to the antenna 1410 and the processing circuitry 1402. The radio front-end circuitry 1418 may be configured to condition signals communicated between the antenna 1410 and the processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of the filters 1420 and/or the amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface 1406 may comprise different components and/or different combinations of components.

In certain alternative embodiments, the network node 1400 does not include separate radio front-end circuitry 1418; instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes the one or more ports or terminals 1416, the radio front-end circuitry 1418, and the RF transceiver circuitry 1412 as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, the communication interface 1406, and/or the processing circuitry 1402 may be configured to perform any receiving operations and/or certain obtaining operations described herein as being performed by the network node 1400. Any information, data, and/or signals may be received from a UE, another network node, and/or any other network equipment. Similarly, the antenna 1410, the communication interface 1406, and/or the processing circuitry 1402 may be configured to perform any transmitting operations described herein as being performed by the network node 1400. Any information, data, and/or signals may be transmitted to a UE, another network node, and/or any other network equipment.

The power source 1408 provides power to the various components of the network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid or an electricity outlet) via input circuitry or an interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

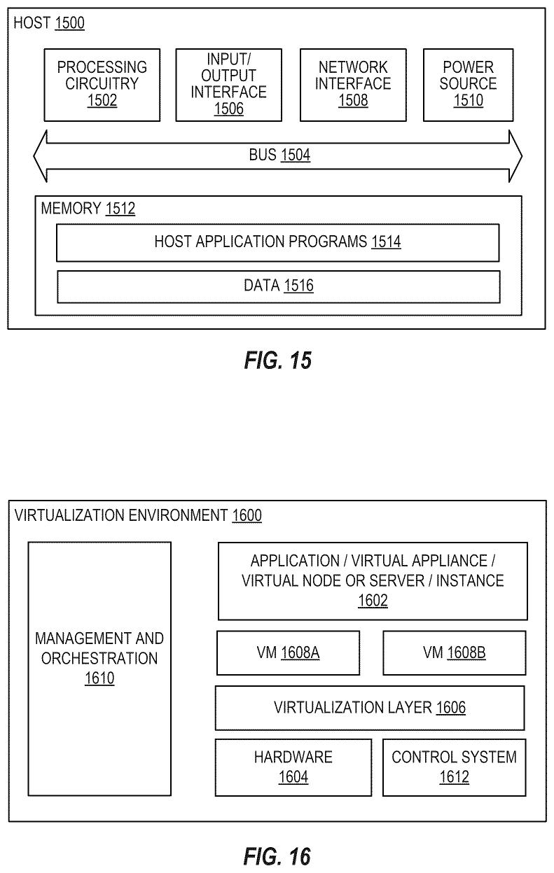

FIG. 15 is a block diagram of a host 1500, which may be an embodiment of the host 1216 of FIG. 12, in accordance with various aspects described herein. As used herein, the host 1500 may be or comprise various combinations of hardware and/or software including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and memory 1512. Other components may be included in other embodiments. Features of these components may be substantially similar to those described with respect to the devices of previous figures, such as FIGS. 13 and 14, such that the descriptions thereof are generally applicable to the corresponding components of the host 1500.

The memory 1512 may include one or more computer programs including one or more host application programs 1514 and data 1516, which may include user data, e.g. data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for Over-The-Top (OTT) services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or VM Monitors (VMMs)), provide VMs 1608A and 1608B (one or more of which may be generally referred to as VMs 1608), and/or perform any of the functions, features, and/or benefits described in relation with some embodiments described herein. The virtualization layer 1606 may present a virtual operating platform that appears like networking hardware to the VMs 1608.

The VMs 1608 comprise virtual processing, virtual memory, virtual networking, or interface and virtual storage, and may be run by a corresponding virtualization layer 1606. Different embodiments of the instance of a virtual appliance 1602 may be implemented on one or more of the VMs 1608, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1608 may be a software implementation of a physical machine that runs programs as if they were executing on a physical, non-virtualized machine. Each of the VMs 1608, and that part of the hardware 1604 that executes that VM, be it hardware dedicated to that VM and/or hardware shared by that VM with others of the VMs 1608, forms separate virtual network elements. Still in the context of NFV, a virtual network function is responsible for handling specific network functions that run in one or more VMs 1608 on top of the hardware 1604 and corresponds to the application 1602.

The hardware 1604 may be implemented in a standalone network node with generic or specific components. The hardware 1604 may implement some functions via virtualization. Alternatively, the hardware 1604 may be part of a larger cluster of hardware (e.g., such as in a data center or CPE) where many hardware nodes work together and are managed via management and orchestration 1610, which, among others, oversees lifecycle management of the applications 1602. In some embodiments, the hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1612 which may alternatively be used for communication between hardware nodes and radio units.

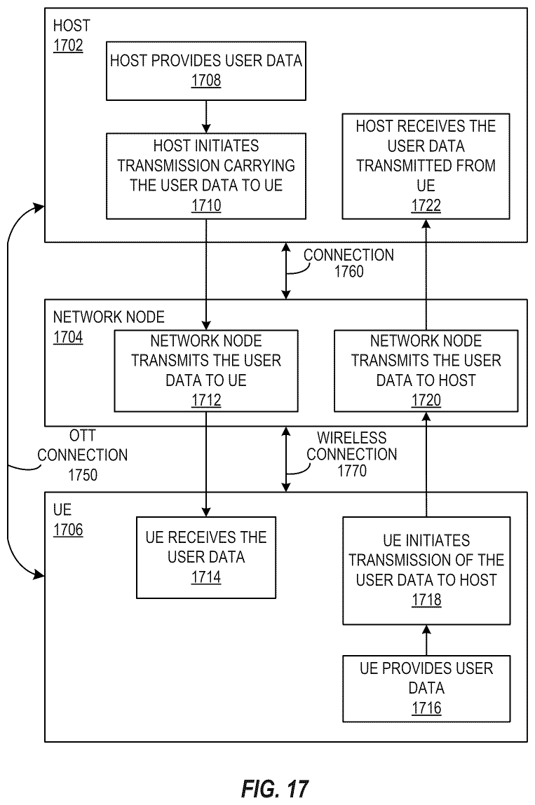

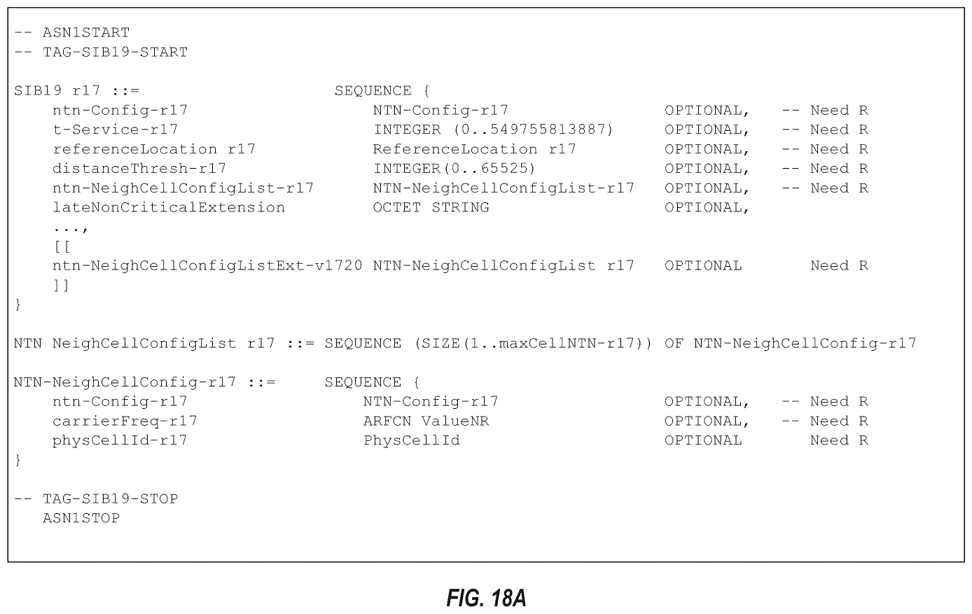

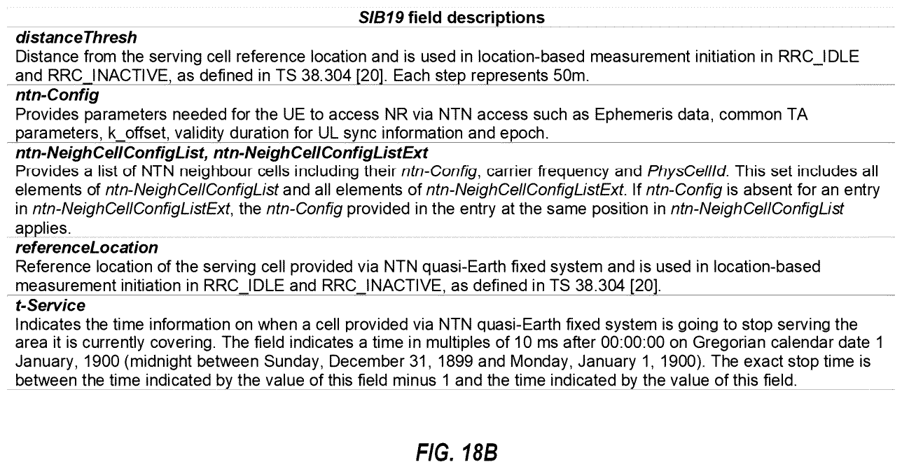

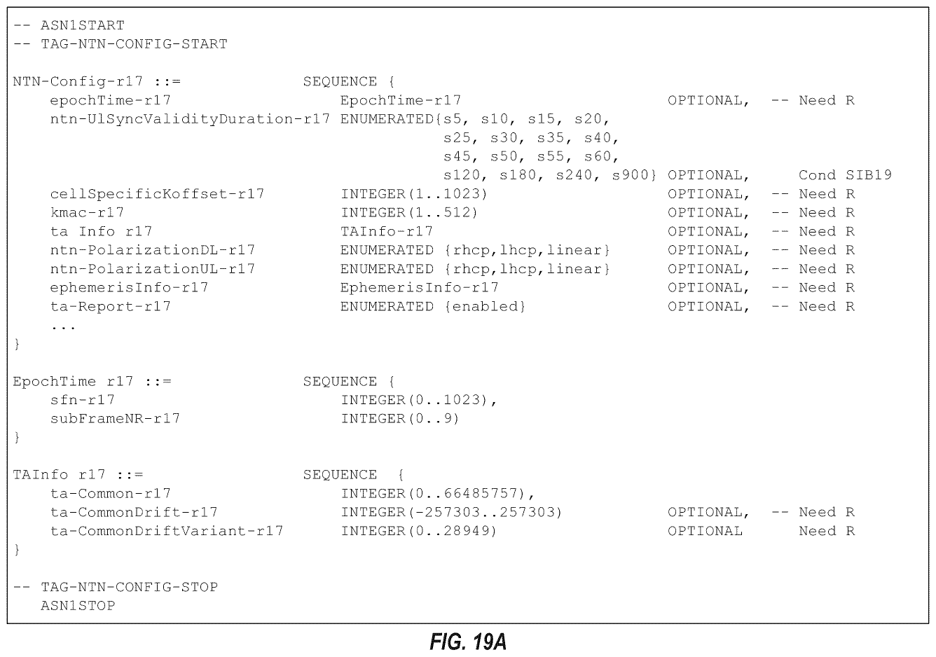

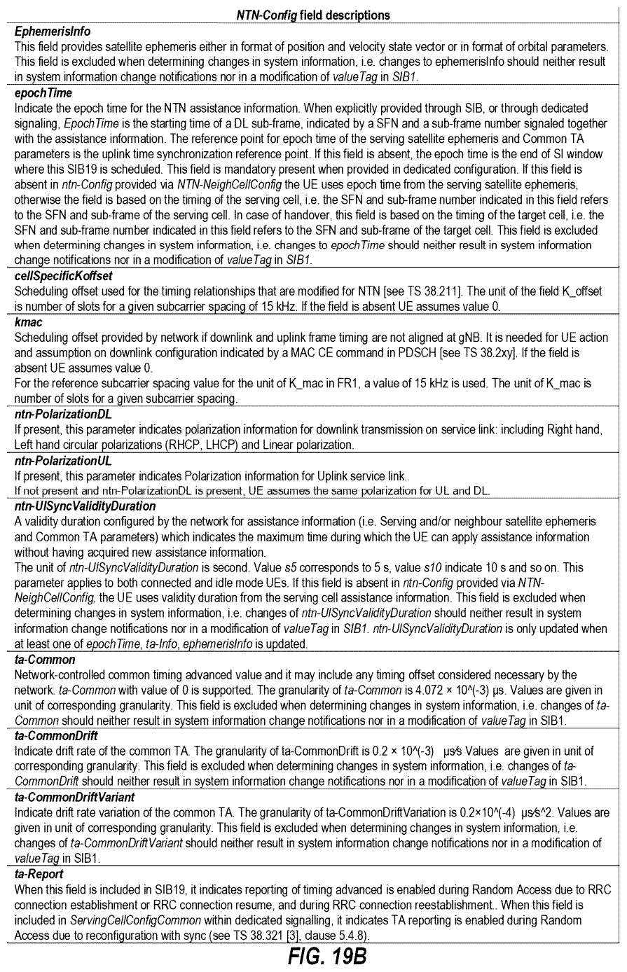

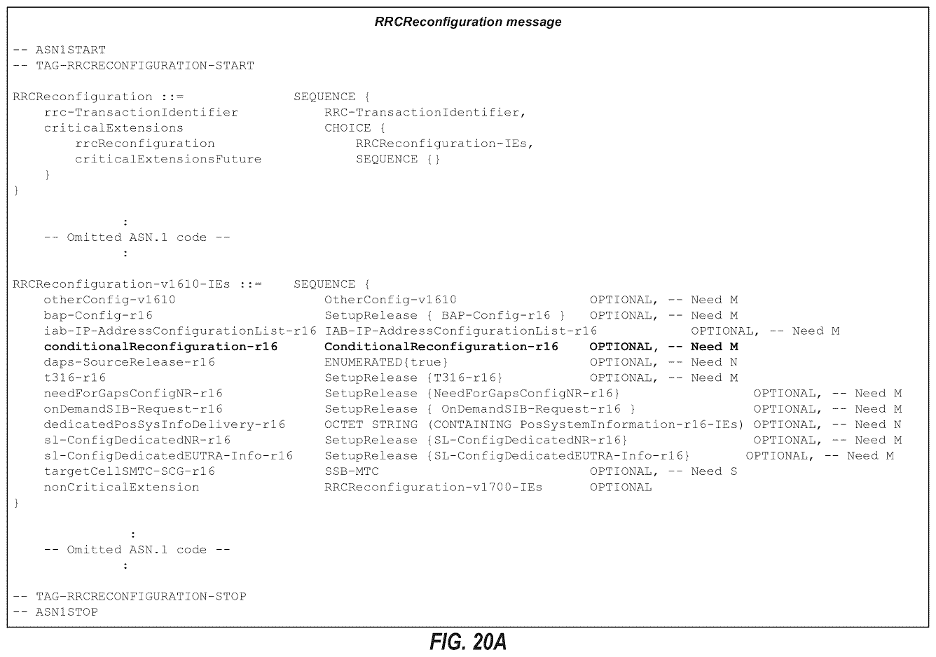

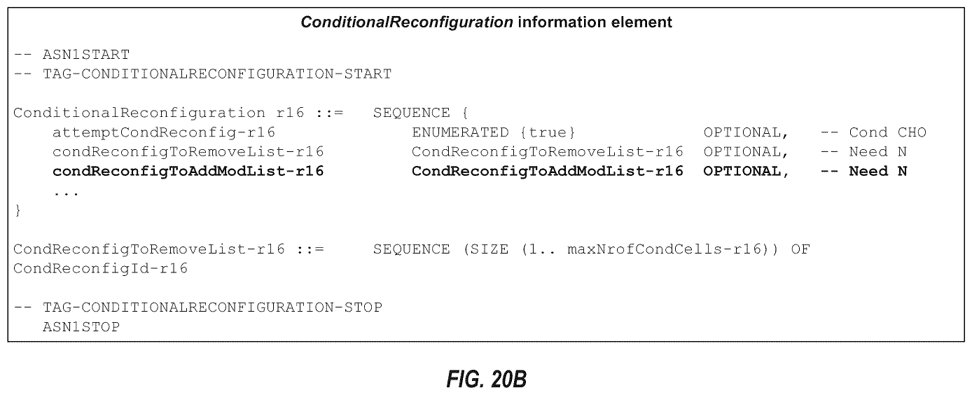

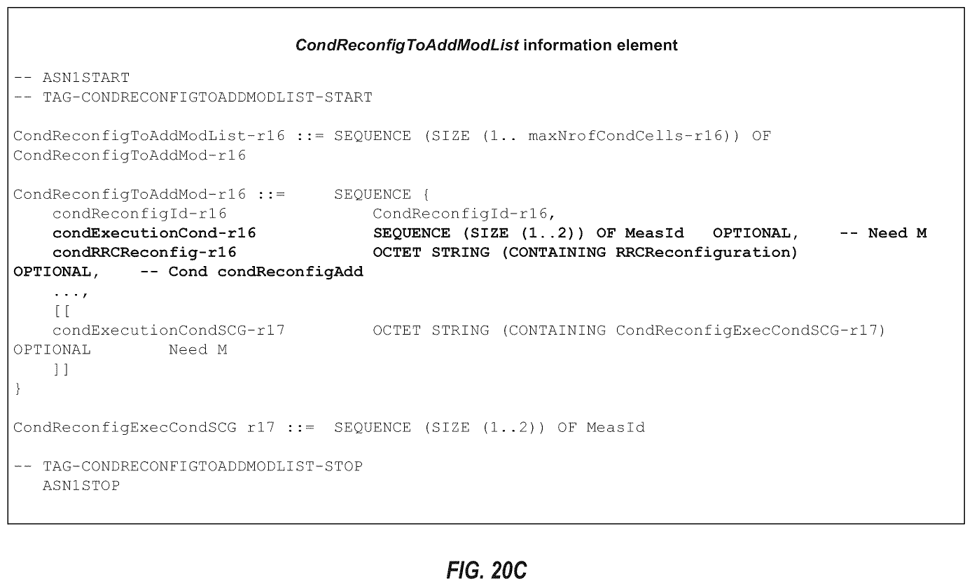

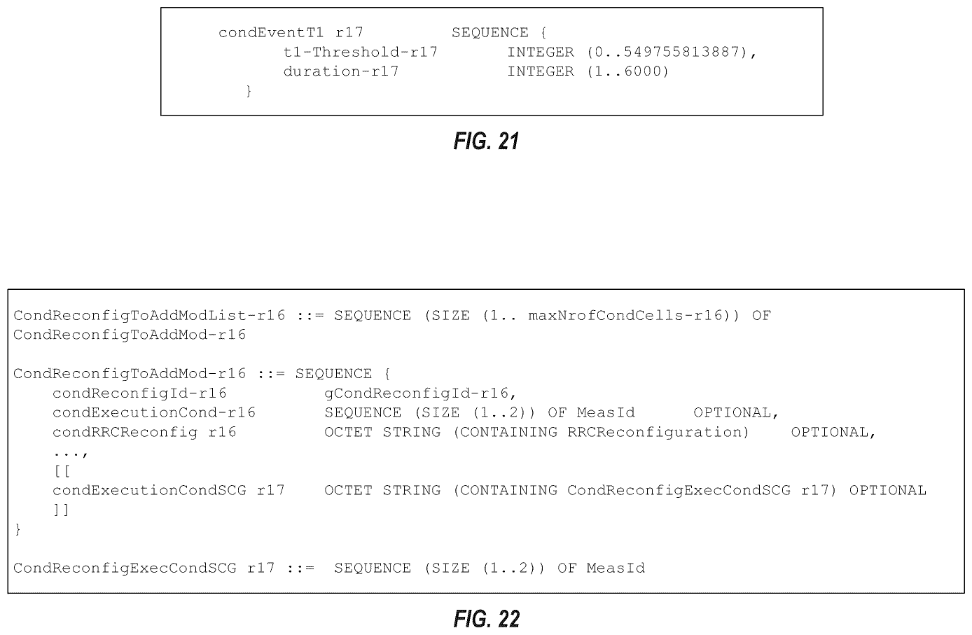

FIG. 17 shows a communication diagram of a host 1702 communicating via a network node 1704 with a UE 1706 over a partially wireless connection in accordance with some embodiments. Example implementations, in accordance with various embodiments, of the UE (such as the UE 1212A of FIG. 12 and/or the UE 1300 of FIG. 13), the network node (such as the network node 1210A of FIG. 12 and/or the network node 1400 of FIG. 14), and the host (such as the host 1216 of FIG. 12 and/or the host 1500 of FIG. 15) discussed in the preceding paragraphs will now be described with reference to FIG. 17.

Like the host 1500, embodiments of the host 1702 include hardware, such as a communication interface, processing circuitry, and memory. The host 1702 also includes software, which is stored in or is accessible by the host 1702 and executable by the processing circuitry. The software includes a host application that may be operable to provide a service to a remote user, such as the UE 1706 connecting via an OTT connection 1750 extending between the UE 1706 and the host 1702. In providing the service to the remote user, a host application may provide user data which is transmitted using the OTT connection 1750.

The network node 1704 includes hardware enabling it to communicate with the host 1702 and the UE 1706 via a connection 1760. The connection 1760 may be direct or pass through a core network (like the core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by the UE 1706 and executable by the UE's processing circuitry. The software includes a client application, such as a web browser or operator-specific “app” that may be operable to provide a service to a human or non-human user via the UE 1706 with the support of the host 1702. In the host 1702, an executing host application may communicate with the executing client application via the OTT connection 1750 terminating at the UE 1706 and the host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via the connection 1760 between the host 1702 and the network node 1704 and via a wireless connection 1770 between the network node 1704 and the UE 1706 to provide the connection between the host 1702 and the UE 1706. The connection 1760 and the wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704 in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR, or AR which it can broadcast, multicast, or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1750 between the host 1702 and the UE 1706 in response to variations in the measurement results. The measurement procedure and/or the network functionality for reconfiguring the OTT connection 1750 may be implemented in software and hardware of the host 1702 and/or the UE 1706. In some embodiments, sensors (not shown) may be deployed in or in association with other devices through which the OTT connection 1750 passes; the sensors may participate in the measurement procedure by supplying values of the monitored quantities exemplified above, or by supplying values of other physical quantities from which software may compute or estimate the monitored quantities. The reconfiguring of the OTT connection 1750 may include message format, retransmission settings, preferred routing, etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency, and the like by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, for conditional handover, the method comprising: receiving (1000), from a network node, information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations; and operating (1002) in accordance with the set of conditional handover configurations.

Embodiment 2: The method of embodiment 1 wherein the set of conditional handover configurations is to be applied by the UE in sequence.

Embodiment 3: The method of embodiment 2 wherein omitted information in one of the conditional handover configurations implies that corresponding information from a preceding conditional handover configuration in the sequence is to be reused.

Embodiment 4: The method of embodiment 1 or 2 wherein omitted information in one of the conditional handover configurations implies that corresponding information from one of the conditional handover configurations for a source or serving cell where the set of conditional handover configurations was configured is to be reused.

Embodiment 5: The method of any of embodiments 1 to 4 wherein, for a particular configuration parameter (e.g., t-Service-r17 and/or t1-Threshold-r17), a value for the particular configuration parameter for at least one conditional handover configuration from the set of conditional handover configurations is implied by a value for the particular configuration parameter for another conditional handover configuration from the set of conditional handover configurations and a known (e.g., predefined or configured) periodicity.

Embodiment 6: The method of any of embodiments 1 to 5 wherein, for a particular configuration parameter, a value for the particular configuration parameter for at least one conditional handover configuration from the set of conditional handover configurations is implied by a value for the particular configuration parameter for another conditional handover configuration from the set of conditional handover configurations and a known (e.g., predefined or configured) offset.

Embodiment 7: The method of any of embodiments 1 to 6 wherein, for a particular configuration parameter (e.g., carrier frequency; PRACH configuration), values for the particular configuration parameter for the set of conditional handover configurations is implied by a toggling or stepping through a predefined or configured set of values for the particular configuration.

Embodiment 8: The method of any of embodiments 1 to 7 wherein the set of conditional handover configurations is restricted to a maximum of two involved network nodes (e.g., maximum of two involved base stations (e.g., gNBs)).

Embodiment 9: The method of any of embodiments 1 to 7 wherein the set of conditional handover configurations comprises multiple intra-base station (e.g., intra-gNB) conditional handover configurations but only one inter-base station e.g., inter-gNB) conditional handover configurations.

Embodiment 10: The method of any of embodiments 1 to 7 wherein the set of conditional handover configurations comprises multiple intra-base station (e.g., intra-gNB) conditional handover configurations for a single base station (e.g., single gNB).

Embodiment 11: The method of any of embodiments 1 to 7 wherein the set of conditional handover configurations is restricted to a maximum of two involved network nodes (e.g., maximum of two involved base stations (e.g., gNBs)) but an unlimited number of intra-base station and inter-base station conditional handover configurations involving the maximum of two involved network nodes.

Embodiment 12: The method of any of embodiments 1 to 7 wherein a number of candidate target cells that the UE can handle in the set of conditional handover configurations is based on one or more capabilities of the UE.

Embodiment 13: The method of any of embodiments 1 to 12 wherein C-RNTIs indicated in the set of conditional handover configurations are assigned by the network node.

Embodiment 14: The method of any of embodiments 1 to 12 wherein C-RNTIs for the set of conditional handover configurations are assigned in such a manner as to mitigate a risk of C-RNTI collisions.

Embodiment 15: The method of any of embodiments 1 to 12 wherein C-RNTIs for the set of conditional handover configurations are assigned from a reserved pool of C-RNTIs.

Embodiment 16: The method of any of embodiments 1 to 15 wherein information comprised in a measurement object in one of the conditional handover configurations in the set of conditional handover configurations is reused for all other conditional handover configurations in the set of conditional handover configurations.

Embodiment 17: The method of embodiment 16 wherein carrier frequency information for the set of conditional handover configurations is indicated separately from the measurement object.

Embodiment 18: The method of any of embodiments 1 to 17 further comprises: receiving (1004) an update for the set of conditional handover configurations; and operating (1006) in accordance with the updated set of conditional handover configurations.

Embodiment 19: The method of any of the previous embodiments, further comprising: providing user data; and forwarding the user data to a host via the transmission to the network node.

### Group B Embodiments

Embodiment 20: A method performed by a network node comprising: sending (1100), to a UE, information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations.

Embodiment 21: The method of embodiment 20 wherein the set of conditional handover configurations is to be applied by the UE in sequence.

Embodiment 22: The method of embodiment 21 wherein omitted information in one of the conditional handover configurations implies that corresponding information from a preceding conditional handover configuration in the sequence is to be reused.

Embodiment 23: The method of embodiment 20 or 21 wherein omitted information in one of the conditional handover configurations implies that corresponding information from one of the conditional handover configurations for a source or serving cell where the set of conditional handover configurations was configured is to be reused.

Embodiment 24: The method of any of embodiments 20 to 23 wherein, for a particular configuration parameter (e.g., t-Service-r17 and/or t1-Threshold-r17), a value for the particular configuration parameter for at least one conditional handover configuration from the set of conditional handover configurations is implied by a value for the particular configuration parameter for another conditional handover configuration from the set of conditional handover configurations and a known (e.g., predefined or configured) periodicity.

Embodiment 25: the method of any of embodiments 20 to 24 wherein, for a particular configuration parameter, a value for the particular configuration parameter for at least one conditional handover configuration from the set of conditional handover configurations is implied by a value for the particular configuration parameter for another conditional handover configuration from the set of conditional handover configurations and a known (e.g., predefined or configured) offset.

Embodiment 26: The method of any of embodiments 20 to 25 wherein, for a particular configuration parameter (e.g., carrier frequency; PRACH configuration), values for the particular configuration parameter for the set of conditional handover configurations is implied by a toggling or stepping through a predefined or configured set of values for the particular configuration.

Embodiment 27: The method of any of embodiments 20 to 26 wherein the set of conditional handover configurations is restricted to a maximum of two involved network nodes (e.g., maximum of two involved base stations (e.g., gNBs)).

Embodiment 28: The method of any of embodiments 20 to 26 wherein the set of conditional handover configurations comprises multiple intra-base station (e.g., intra-gNB) conditional handover configurations but only one inter-base station e.g., inter-gNB) conditional handover configurations.

Embodiment 29: The method of any of embodiments 20 to 26 wherein the set of conditional handover configurations comprises multiple intra-base station (e.g., intra-gNB) conditional handover configurations for a single base station (e.g., single gNB).

Embodiment 30: The method of any of embodiments 20 to 26 wherein the set of conditional handover configurations is restricted to a maximum of two involved network nodes (e.g., maximum of two involved base stations (e.g., gNBs)) but an unlimited number of intra-base station and inter-base station conditional handover configurations involving the maximum of two involved network nodes.

Embodiment 31: The method of any of embodiments 20 to 26 wherein a number of candidate target cells that the UE can handle in the set of conditional handover configurations is based on one or more capabilities of the UE.

Embodiment 32: The method of any of embodiments 20 to 31 wherein C-RNTIs indicated in the set of conditional handover configurations are assigned by the network node.

Embodiment 33: The method of any of embodiments 20 to 31 wherein C-RNTIs for the set of conditional handover configurations are assigned in such a manner as to mitigate a risk of C-RNTI collisions.

Embodiment 34: The method of any of embodiments 20 to 31 wherein C-RNTIs for the set of conditional handover configurations are assigned from a reserved pool of C-RNTIs.

Embodiment 35: The method of any of embodiments 20 to 34 wherein information comprised in a measurement object in one of the conditional handover configurations in the set of conditional handover configurations is reused for all other conditional handover configurations in the set of conditional handover configurations.

Embodiment 36: The method of embodiment 35 wherein carrier frequency information for the set of conditional handover configurations is indicated separately from the measurement object.

Embodiment 37: The method of any of embodiments 20 to 36 further comprising performing (1104) a conditional handover preparation towards a second network node that controls another cell for one of the conditional handover configurations in the set.

Embodiment 38: The method of any of embodiments 20 to 36 further comprising: determining (1102, YES) that a cell for conditional handover for a next conditional handover configuration in the set of conditional handover configurations is controlled by a second network node; and responsive thereto, performing (1104) a conditional handover preparation towards the second network node that controls the cell for conditional handover for a next conditional handover configuration in the set of conditional handover configurations.

Embodiment 39: The method of any of the previous embodiments, further comprising: obtaining user data; and forwarding the user data to a host or a user equipment.

### Group C Embodiments

Embodiment 40: A user equipment comprising: processing circuitry configured to perform any of the steps of any of the Group A embodiments; and power supply circuitry configured to supply power to the processing circuitry.

Embodiment 41: A network node comprising: processing circuitry configured to perform any of the steps of any of the Group B embodiments; and power supply circuitry configured to supply power to the processing circuitry.

Embodiment 42: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 43: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 44: The host of the previous embodiment, wherein the cellular network further includes a network node configured to communicate with the UE to transmit the user data to the UE from the host.

Embodiment 45: The host of the previous 2 embodiments, wherein: the processing circuitry of the host is configured to execute a host application, thereby providing the user data; and the host application is configured to interact with a client application executing on the UE, the client application being associated with the host application.

Embodiment 46: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 47: The method of the previous embodiment, further comprising: at the host, executing a host application associated with a client application executing on the UE to receive the user data from the UE.

Embodiment 48: The method of the previous embodiment, further comprising: at the host, transmitting input data to the client application executing on the UE, the input data being provided by executing the host application, wherein the user data is provided by the client application in response to the input data from the host application.

Embodiment 49: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 50: The host of the previous embodiment, wherein the cellular network further includes a network node configured to communicate with the UE to transmit the user data from the UE to the host.

Embodiment 51: The host of the previous 2 embodiments, wherein: the processing circuitry of the host is configured to execute a host application, thereby providing the user data; and the host application is configured to interact with a client application executing on the UE, the client application being associated with the host application.

Embodiment 52: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 53: The method of the previous embodiment, further comprising: at the host, executing a host application associated with a client application executing on the UE to receive the user data from the UE.

Embodiment 54: The method of the previous embodiment, further comprising: at the host, transmitting input data to the client application executing on the UE, the input data being provided by executing the host application, wherein the user data is provided by the client application in response to the input data from the host application.

Embodiment 55: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 56: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 57: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 58: The method of the previous embodiment, further comprising, at the network node, transmitting the user data provided by the host for the UE.

Embodiment 59: The method of any of the previous 2 embodiments, wherein the user data is provided at the host by executing a host application that interacts with a client application executing on the UE, the client application being associated with the host application.

Embodiment 60: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 61: The communication system of the previous embodiment, further comprising: the network node; and/or the user equipment.

Embodiment 62: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 63: The host of the previous 2 embodiments, wherein: the processing circuitry of the host is configured to execute a host application, thereby providing the user data; and the host application is configured to interact with a client application executing on the UE, the client application being associated with the host application.

Embodiment 64: The host of the any of the previous 2 embodiments, wherein the initiating receipt of the user data comprises requesting the user data.

Embodiment 65: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 66: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment, UE, for conditional handover, the method comprising:
receiving, from a network node, information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations; and
operating in accordance with the set of conditional handover configurations.

2. The method of claim 1 wherein the set of conditional handover configurations is to be applied by the UE in sequence.

3. The method of claim 2 wherein omitted information in one of the conditional handover configurations implies that corresponding information from a preceding conditional handover configuration in the set is to be reused.

4. The method of claim 1 wherein omitted information in one of the conditional handover configurations implies that corresponding information from one of the conditional handover configurations for a source or serving cell where the set of conditional handover configurations was configured is to be reused.

5. The method of claim 1 wherein, for a particular configuration parameter, a value for the particular configuration parameter for at least one conditional handover configuration from the set of conditional handover configurations is implied by a value for the particular configuration parameter for another conditional handover configuration from the set of conditional handover configurations and a known periodicity.

6. The method of claim 1 wherein, for a particular configuration parameter, a value for the particular configuration parameter for at least one conditional handover configuration from the set of conditional handover configurations is implied by a value for the particular configuration parameter for another conditional handover configuration from the set of conditional handover configurations and a known offset.

7. The method of claim 1 wherein, for a particular configuration parameter, values for the particular configuration parameter for the set of conditional handover configurations is implied by a toggling or stepping through a predefined or configured set of values for the particular configuration.

8. (canceled)

9. The method of claim 1 wherein the set of conditional handover configurations comprises multiple intra-base station conditional handover configurations but only one inter-base station conditional handover configuration.

10. The method of claim 1 wherein the set of conditional handover configurations comprises multiple intra-base station conditional handover configurations for a single base station.

11. The method of claim 1 wherein the set of conditional handover configurations is restricted to a maximum of two involved network nodes but an unlimited number of intra-base station and inter-base station conditional handover configurations involving the maximum of two involved network nodes.

12.-14. (canceled)

15. The method of claim 1 wherein Cell Radio Network Temporary Identifiers, C-RNTIs, for the set of conditional handover configurations are assigned from a reserved pool of C-RNTIs.

16. The method of claim 1 wherein information comprised in a measurement object in one of the conditional handover configurations in the set of conditional handover configurations is reused for all other conditional handover configurations in the set of conditional handover configurations.

17. The method of claim 16 wherein carrier frequency information for the set of conditional handover configurations is indicated separately from the measurement object.

18.-20. (canceled)

21. A User Equipment, UE, comprising:
a communication interface comprising a transmitter and a receiver; and
processing circuitry associated with the communication interface, the processing circuitry configured to cause the UE to:
receive, from a network node, information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations; and
operate in accordance with the set of conditional handover configurations.

22. (canceled)

23. A method performed by a network node in a Radio Access Network, RAN, of a cellular communications system, the method comprising:
sending, to a UE, information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations.

24.-29. (canceled)

30. The method of claim 23 wherein the set of conditional handover configurations is restricted to a maximum of two involved network nodes.

31. The method of claim 23 wherein the set of conditional handover configurations comprises multiple intra-base station conditional handover configurations but only one inter-base station conditional handover configuration.

32. The method of claim 23 wherein the set of conditional handover configurations comprises multiple intra-base station conditional handover configurations for a single base station.

33. (canceled)

34. The method of claim 23 wherein a number of candidate target cells that the UE can handle in the set of conditional handover configurations is based on one or more capabilities of the UE.

35.-38. (canceled)

39. The method of claim 23 wherein carrier frequency information for the set of conditional handover configurations is indicated separately from the measurement object.

40. (canceled)

41. The method of claim 23 further comprising:
determining that a cell for conditional handover for a next conditional handover configuration in the set of conditional handover configurations is controlled by a second network node; and
responsive thereto, performing a conditional handover preparation towards the second network node that controls the cell for conditional handover for a next conditional handover configuration in the set of conditional handover configurations.

42.-43. (canceled)

44. A network node for a Radio Access Network, RAN, of a cellular communications system, the network node comprising:
a communication interface; and
processing circuitry associated with the communication interface, the processing circuitry configured to cause the network node to:
send to a User Equipment, UE, information that configures the UE with a set of conditional handover configurations comprising two or more conditional handover configurations, wherein information from at least one conditional handover configuration from the set of conditional handover configurations is reused for at least one other conditional handover configuration from the set of conditional handover configurations.

45. (canceled)
